(19) United States
(12) Patent Application Publication
(10) Pub. No.: US 2017/0210986 A1
(43) Pub. Date: Jul. 27, 2017

(54) LIQUID CRYSTAL DISPLAY ELEMENT

(71) Applicant: DIC Corporation, Tokyo (JP)

(72) Inventors: Shinji Ogawa, Kita-adachi-gun (JP); Yoshinori Iwashita, Kita-adachi-gun (JP); Makoto Negishi, Kita-adachi-gun (JP); Hiromitsu Kishi, Kita-adachi-gun (JP)

(73) Assignee: DIC Corporation, Tokyo (JP)

(21) Appl. No.: 15/329,444

(22) PCT Filed: Jul. 27, 2015
(86) PCT No.: PCT/JP2015/071212

§ 371 Date: Jan. 26, 2017

(30) Foreign Application Priority Data
Jul. 28, 2014 (JP) 2014-152876

(51) Int. Cl. C09K 19/30; G02F 1/1343; G02F 1/1362; G02F 1/1368; G02F 1/1337

(52) U.S. Cl. CPC C09K 19/3003; G02F 1/1368; G02F 1/1337; G02F 1/136286; G02F 1/134309; G02F 1/13439; C09K 2019/3004; C09K 2019/301; C09K 2019/3018; C09K 2019/0466

(57) ABSTRACT

An object of the present invention is to provide a liquid crystal display element which is provided with a photo-alignment film, and does not deteriorate various properties, as a liquid crystal display element, such as dielectric anisotropy, viscosity, a nematic phase upper limit temperature, nematic phase stability at low temperature, and γ₁, and burn-in characteristics of the display element. The present invention provides a liquid crystal display element which is excellent in stability at low temperature while maintaining high-speed responsiveness of the liquid crystal composition by using a liquid crystal composition containing a compound represented by General Formula (I) and a compound represented by General Formula (II). Provided is an FFS mode liquid crystal display element using a p-type liquid crystal composition.

### TECHNICAL FIELD

The present invention relates to a liquid crystal display element using a nematic liquid crystal composition having positive dielectric anisotropy (Δ∈), which is useful as a liquid crystal material.

### BACKGROUND ART

From the fact that display quality is excellent, active matrix type liquid crystal display elements have been put on the market for portable terminals, liquid crystal televisions, projectors, computers and the like. In the active matrix type elements, thin film transistors (TFT), metal-insulator-metals (MIM), or the like are used for each pixel, and it is important that the liquid crystal compound or the liquid crystal composition used in this type has a high voltage holding ratio. In addition, a reflection-type liquid crystal display element which includes a vertical alignment (VA) mode, an in-plane switching (IPS) mode, and an optically compensated bend, optically compensated birefringence (OCB) mode in combination is proposed in order to obtain wider viewing angle characteristics, and an electrically controlled birefringence (ECB) mode reflective liquid crystal display element is proposed in order to obtain a brighter display. To comply with such liquid crystal display elements, new liquid crystal compounds or liquid crystal compositions are currently being proposed.

At present, as the liquid crystal display for smartphones, a fringe field switching mode liquid crystal display device (FFS mode liquid crystal display device) having high quality and excellent visual characteristics, which is one type of an IPS mode liquid crystal display element, is widely used (refer to PTLs 1 and 2). The FFS mode is a mode introduced for improving the low opening ratio and transmittance of the IPS mode, and as the liquid crystal composition used, a material using a p-type liquid crystal composition having positive dielectric anisotropy is widely used from the viewpoint of easily lowering a voltage. In addition, since most applications of the FFS mode are for portable terminals, there is a strong demand for more power saving, and liquid crystal element manufacturers are continuing to carry out active development in this regard, such as adoption of arrays using IGZO.

### CITATION LIST

### Patent Literature

PTL 1: JP-A-11-202356
PTL 2: JP-A-2003-233083

### SUMMARY OF INVENTION

### Technical Problem

Liquid crystal display elements have been widely used and the market thereof has been expanded in recent years. With this, there have been major changes in methods of using and manufacturing the liquid crystal display element, and not only a method of driving the liquid crystal display element (for example, a TN mode, an STN mode, a VA mode, an IPS mode, and an FFS mode) but also a method of injecting of a liquid crystal composition to a substrate have been also changed in accordance with practical use of display elements having a super-large size of 50 inches or more. Instead of a vacuum injection method in the related art, a one drop fill (ODF) method in which droplets of the liquid crystal composition are added dropwise on a surface of a substrate, and the surface is bonded to another substrate has been mainly used. In addition, when comparing a vertical electric field mode such as the VA mode with a horizontal electric field mode such as the IPS mode and the FFS mode, the two types are greatly different from each other in all the points of an electrode structure, the alignment direction, the orientation of the electric field, and the required optical properties.

For this reason, as disclosed in PTL 1 and PTL 2, from the aspect that the electrodes of the IPS mode and FFS mode have a structure in which a plurality of rectangular electrodes formed on the surface of one substrate are arranged in parallel, and the entire surface of the substrate is covered with an alignment film, countless irregularities are present on the surface of the aforementioned one substrate, and thus when the liquid crystal composition is added dropwise to the surface of the substrate, a drip mark is formed on the substrate, and thus a problem that the drip mark causes deterioration in display quality has been concerned.

Further, in a manufacturing step of not only a vertical electric field mode (such as the VA mode) liquid crystal display element, but also the horizontal electric field mode (such as the IPS mode and the FFS mode) liquid crystal display element, it is necessary that an optimum injection amount of liquid crystal is added dropwise in accordance with the size of the liquid crystal display element by using an ODF method. For this reason, when the deviation of the injection amount increases from the optimum value, the balance of a refractive index and a driving electric field, which are set in advance, of the liquid crystal display element is collapsed, and thereby display defects such as uneven spots and poor contrast are generated. Particularly, a compact-size liquid crystal display element which is widely used for smartphones which are recently in fashion has small optimum injection amount of liquid crystal, and thus it is difficult even to control the deviation from the optimum value in a certain range. Accordingly, in order to keep the high yield of the liquid crystal display element, for example, required is performance of not being affected by sudden pressure changes or impacts generated when dripping the liquid crystal in the dripping apparatus, and making it possible to continue stably dripping the liquid crystal over a long period.

As described above, the liquid crystal composition used for an active matrix driving liquid crystal display element which is driven by using a TFT element or the like has been required to be developed in consideration of a method of manufacturing a liquid crystal display element, in addition to the properties of having a high specific resistance value or a high voltage holding ratio and being stable against external stimuli such as light and heat which have been emphasized in the related art while maintaining properties and performance required as the liquid crystal display element such as high speed response performance.

In addition, since an FFS mode liquid crystal display element using a p-type liquid crystal composition has a configuration in which electrode substrates such as a TFT are typically concentrated on only one side, and the p-type liquid crystal composition has a feature that a longitudinal direction of liquid crystal molecules is oriented along an electric flux line, liquid crystal molecules which are not involved in switching are present in a boundary region of the substrate facing the electrode substrate and a boundary region of the electric field, and thus alignment unevenness may be caused.

In this regard, an object of the present invention is to solve the above-described problem, and to provide a horizontal electric field mode (IPS, FFS) liquid crystal display element which is excellent in various properties, as a liquid crystal display element, such as dielectric anisotropy (Δ∈), viscosity (η), a transition temperature of a nematic phase-isotropic liquid (T_{NI}), nematic phase stability at low temperature, and rotational viscosity (γ1), and uses a p-type liquid crystal composition which is capable of realizing excellent display properties by using a liquid crystal display element.

### Solution to Problem

The inventors of the present application have been conducted intensive researches in order to solve the problems described above, and as a result of researching of a configuration of a liquid crystal display element and a configuration of various liquid crystal compositions which are most suitable for the liquid crystal display element, the invention of the present application has been completed.

### Advantageous Effects of Invention

In the horizontal electric field mode liquid crystal display element according to the present invention, the change in the specific resistance value and voltage holding ratio due to heat and light is extremely small, and thus a product has high practicality, thereby achieving high-speed responsiveness.

In a step of manufacturing the horizontal electric field mode liquid crystal display element of the present invention, since the stable performance can be exhibited, display defects caused during the step is prevented, and thus it is very advantageous in manufacturing with high yield.

The liquid crystal display element according to the present invention can use the horizontal electric field mode liquid crystal display element containing the p-type liquid crystal composition which is excellent in the stability at low temperature and the high-speed responsiveness.

The liquid crystal display element according to the present invention can decrease the alignment unevenness of the p-type liquid crystal composition, and thus transmittance is improved.

### BRIEF DESCRIPTION OF DRAWINGS

FIG. 1 is a diagram schematically showing an example of a configuration of a liquid crystal display element of the present invention.

FIG. 2 is an enlarged planar diagram of a region surrounded by a line II of an electrode layer 3 formed on a substrate 2 in FIG. 1.

FIG. 3 is a cross-sectional view of the liquid crystal display element shown in FIG. 1 taken along the line III-III in FIG. 2.

FIG. 4 is an enlarged planar diagram illustrating another example of a region surrounded by a line II of an electrode layer 3 formed on a substrate 2 in FIG. 1.

FIG. 5 is a cross-sectional view of another example of the liquid crystal display element shown in FIG. 1 taken along line III-III in FIG. 2.

FIG. 6 is a cross-sectional view of another example in which the liquid crystal display element shown in FIG. 1 taken along line III-III in FIG. 2.

FIG. 7 is a cross-sectional view of another example in which the liquid crystal display element shown in FIG. 1 taken along line III-III in FIG. 2.

FIG. 8 is a cross-sectional view of another example in which the liquid crystal display element shown in FIG. 1 taken along line III-III in FIG. 2.

### DESCRIPTION OF EMBODIMENTS

According to a first aspect of the present invention, there is a provided a liquid crystal display element which includes a first substrate and a second substrate, which are disposed so as to face each other; a liquid crystal layer containing a liquid crystal composition, which is interposed between the first substrate and the second substrate; an electrode layer that is provided on the first substrate and includes, for each pixel, a plurality of gate bus lines and data bus lines disposed in a matrix shape on the first substrate, a thin film transistor which is provided in an intersection between the gate bus line and the data bus line, and a pixel electrode which includes a transparent conductive material and is driven by the thin film transistor; a common electrode that includes a transparent conductive material and is formed on the first substrate or the second substrate; and alignment film layers that are formed between the liquid crystal layer and the first substrate and between the liquid crystal layer and the second substrate.

The liquid crystal composition has positive dielectric anisotropy and a transition temperature of a nematic phase-isotropic liquid of 60° C. or more, and contains at least one compound selected from the compound group represented by General Formula (I) and at least one compound selected from the compound group represented by the following General Formula (II):

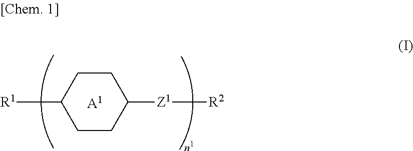

(in General Formula (I), R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively;
A¹ each independently represents a 1,4-cyclohexylene cyclohexylene group, a 1,4-phenylene group or a tetrahydropyran-2,5-diyl group, and in a case where A¹ represents a 1,4-phenylene group, one hydrogen atom in the 1,4-phenylene group may be substituted with a fluorine atom;
Z¹ each independently represent a single bond, —OCH₂—, —OCF₂—, —CH₂O—, or CF₂O—; and
n¹ represents 1, 2, 3, or 4)

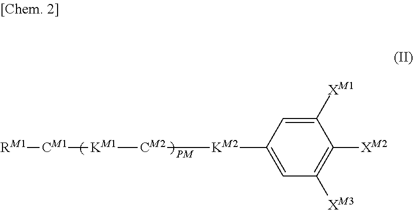

(in the formula, R^{M1} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and one or two or more non-adjacent —CH₂— in the alkyl group, the alkenyl group, the alkoxy group, and the alkenyloxy group may be independently substituted with —CH═CH—, —C≡C—, —O—, —CO—, —COO—, or —OCO—;
PM represents 0, 1, 2, 3, or 4;
C^{M1} and C^{M2} each independently represent a group selected from the group consisting of (d) a 1,4-cyclohexylene group (one —CH₂— or two or more non-adjacent —CH₂— present in this group may be substituted with —O— or —S—) and (e) a 1,4-phenylene group (one —CH═ or two or more non-adjacent —CH═ present in this group may be substituted with —N═), and the group (d) and the group (e) may be independently substituted with a cyano group, a fluorine atom, or a chlorine atom;
K^{M1} and K^{M2} each independently represent a single bond, —CH₂CH₂—, —(CH₂)₄—, —OCH₂—, —CH₂O—, —OCF₂—, —CF₂O—, —COO—, —OCO—, or —C≡C—;
in a case where PM is 2, 3, or 4 and plural K^{M1}'s are present, these may be the same as or different from each other, and in a case where PM is 2, 3, or 4, and plural C^{M2}'s are present, these may be the same as or different from each other;
X^{M1} and X^{M3} each independently represent a hydrogen atom, a chlorine atom, or a fluorine atom; and
X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group).

Accordingly, as components of the liquid crystal display element according to the present invention, a pair of substrates, an electrode layer, a liquid crystal layer, and a photo-alignment film layer are essentially included. Hereinafter, the respective components will be described in detail.

(Liquid Crystal Layer)

An embodiment of the liquid crystal composition in the present invention will be described below. The liquid crystal composition of the present invention is preferably applied to an FFS mode liquid crystal display element.

The liquid crystal composition in the present invention is preferably a liquid crystal composition having positive dielectric anisotropy, which contains one or more compounds from the compound group represented by General Formula (I), as a first component and one or more compounds from the compound group represented by General Formula (M), as a second component:

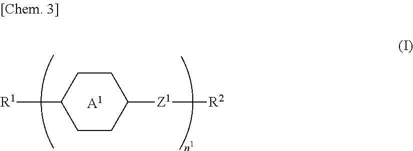

in General Formula (I),
R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively;
A¹ each independently represents a 1,4-cyclohexylene cyclohexylene group, a 1,4-phenylene group, or a tetrahydropyran-2,5-diyl group, and in a case where A¹ represents a 1,4-phenylene group, one hydrogen atom in the 1,4-phenylene group may be substituted with a fluorine atom;
Z¹ each independently represents a single bond, —OCH₂—, —OCF₂—, —CH₂O—, or CF₂O—; and
n¹ represents 1, 2, 3, or 4:

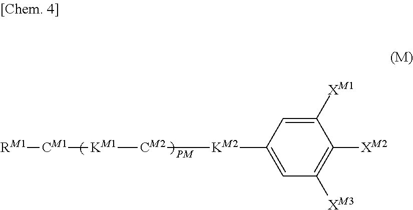

in the formula,
R^{M1} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and one or two or more non-adjacent —CH₂— in the alkyl group, the alkenyl group, the alkoxy group, and the alkenyloxy group may be independently substituted with —CH═CH—, —C≡C—, —O—, —CO—, —COO—, or —OCO—;
PM represents 0, 1, 2, 3, or 4;
C^{M1} and C^{M2} each independently represent a group selected from the group consisting of (d) 1,4-cyclohexylene group (one —CH₂— or two or more non-adjacent —CH₂— present in this group may be substituted with —O— or —S—) and (e) 1,4-phenylene group (one —CH═ or two or more non-adjacent —CH═ present in this group may be substituted with —N═), and the group (d) and the group (e) may be independently substituted with a cyano group, a fluorine atom, or a chlorine atom;
K^{M1} and K^{M2} each independently represent a single bond, —CH₂CH₂—, —(CH₂)₄—, —OCH₂—, —CH₂O—, —OCF₂—, —CF₂O—, —COO—, —OCO—, or —C≡C—;
in a case where PM is 2, 3, or 4 and plural K^{M1}'s are present, these may be the same as or different from each other, and in a case where PM is 2, 3, or 4 and plural C^{M2}'s are present, these may be the same as or different from each other;
X^{M1} and X^{M3} each independently represent a hydrogen atom, a chlorine atom, or a fluorine atom; and
X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group,
with the proviso that the compounds represented by General Formula (I) are excluded.

When the total content of the compound represented by General Formula (I) of the first component is equal to or greater than 85% by mass in the liquid crystal composition according to the present invention, it sufficiently contains the components having low polarity, that is, the components having high viscosity decreasing effect, and thus it is possible to secure the high-speed responsiveness. In addition, in the liquid crystal composition according to the present invention, the total content of the compound represented by General Formula (I) of the first component is preferably in a range of 1% by mass to 99% by mass, is further preferably in a range of 10% by mass to 90% by mass, is still further preferably in a range of 12% by mass to 80% by mass, is still further preferably in a range of 13% by mass to 75% by mass, is still further preferably in a range of 14% by mass to 50% by mass, and is particularly preferably in a range of 15% by mass to 40% by mass.

As preferred physical property values of the liquid crystal composition according to the present invention, Δ∈ is preferably in a range of 1.5 to 3.5, and Δn is preferably in a range of 0.08 to 0.20.

The liquid crystal composition according to the present invention contains at least one first component represented by General Formula (I) and at least one second component represented by General Formula (M) as essential components. Hereinafter, the respective components (the first component, the second component, and other optional components) contained in the liquid crystal composition according to the present invention will be described below.

The liquid crystal composition according to the present invention preferably contains one or more compounds represented by General Formula (I), as the first component, and the content thereof is preferably in a range of 5 to 20 times with respect to the compound represented by General Formula (M) of the second component:

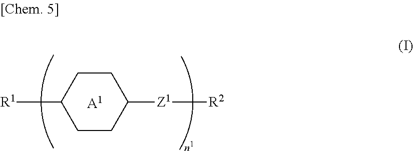

in General Formula (I),
R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively;
A¹ each independently represents a 1,4-cyclohexylene cyclohexylene group, 1,4-phenylene group, or a tetrahydropyran-2,5-diyl group, and in a case where A1 represents a 1,4-phenylene group, one hydrogen atom in the 1,4-phenylene group may be substituted with a fluorine atom;
Z¹ each independently represents a single bond, —OCH₂—, —OCF₂—, —CH₂O—, or CF₂O—; and
n¹ represents 1, 2, 3, or 4.

The compound represented by General Formula (I) as the first component exhibits an effect such as the high-speed responsiveness. In addition, the liquid crystal composition according to the present invention can contain one or more compounds represented by General Formula (I). The compounds that can be combined are not particularly limited; however, the compounds are used in appropriate combination in accordance with the desired performance such as the solubility at low temperature, the viscosity, the transition temperature, the electrical reliability, and the birefringence. Here, the compound represented by General Formula (I) preferably contains a compound exhibiting an effect decreasing the viscosity. In addition, the number of the types of the compounds to be used as the compound represented by General Formula (I) which is the first component is, for example, one in one embodiment of the present invention. The number of the types thereof is two in another embodiment of the present invention. Further, the number of the types thereof is three in another embodiment of the present invention. Further, the number of the types thereof is four in another embodiment of the present invention. Further, the number of the types thereof is five in another embodiment of the present invention. Further, the number of the types thereof is six in another embodiment of the present invention. Further, the number of the types thereof is seven in another embodiment of the present invention. Further, the number of the types thereof is eight in another embodiment of the present invention. Further, the number of the types thereof is nine in another embodiment of the present invention. Further, the number of the types thereof is ten or more in another embodiment of the present invention.

In the liquid crystal composition of the present invention, the content of the compound represented by General Formula (I) is required to be appropriately adjusted in accordance with desired performance such as the solubility at low temperature, the transition temperature, the electrical reliability, the birefringence, the process adaptability, the drip mark, the burn-in, and the dielectric anisotropy.

In addition, an alkyl group, an alkenyl group, and an alkoxy group according to the present invention are preferably linear or branched chain. In addition, examples of the “alkyl group” according to the present invention include a methyl group, an ethyl group, a propyl group, a butyl group, an isopropyl group, an isobutyl group, a t-butyl group, a 3-pentyl group, an isopentyl group, a neopentyl group, a pentyl group, a hexyl group, a heptyl group, and an octyl group. Note that, the examples of the alkyl group are common in the present specification, and the alkyl group is appropriately selected from the above-described examples depending on the number of carbon atoms for each of alkyl groups.

In addition, examples of the “alkenyl group” according to the present invention include a vinyl group, an allyl group, a 1-propenyl group, an isopropenyl group, a 2-butenyl group, a 3-butenyl group, a 1,3-butadienyl group, a 2-pentenyl group, a 3-pentenyl group, and a 2-hexenyl group. In addition, examples of further preferred alkenyl group according to the present invention are represented by the following formula (i) (a vinyl group), formula (ii) (a 1-propenyl group), formula (iii) (a 3-butenyl group), formula (iv) (a 3-pentenyl group), formula (v) (a 2-pentenyl group), and formula (vi) (a 4-pentenyl group):

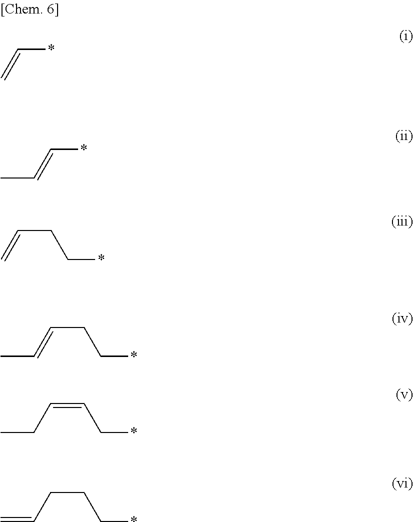

In the above-described formulas (i) to (iv), * represents a bonding site with respect to a ring structure.

Note that, examples of the alkenyl group are common in the present specification, and the alkenyl group is appropriately selected from the above-described examples depending on the number of carbon atoms for each of alkyl groups.

Preferred examples of the “alkoxy group” according to the present invention include a group obtained by directly bonding an oxygen atom to an alkyl group according to the present invention, and a methoxy group, an ethoxy group, a propoxy group (a n-propoxy group and an i-propoxy group), a butoxy group, a pentyloxy group, and an octyloxy group are more preferably used. Note that, examples of the alkoxy group are common in the present specification, and the alkoxy group is appropriately selected from the above-described examples depending on the number of carbon atoms for each of alkoxy group.

The liquid crystal composition in the present invention preferably contains one or two or more compounds represented by the following General Formula (L).

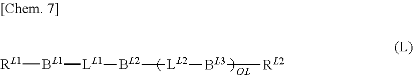

In General Formula (L),
R^{L1} and R^{L2} each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, one or two or more non-adjacent —CH₂— in the alkyl group, the alkenyl group, the alkoxy group, and the alkenyloxy group may independently substituted with —CH═CH—, —C≡C—, —O—, —CO—, —COO—, or —OCO—;
OL represents 0, 1, 2, or 3;
B^{L1}, B^{L2} and B^{L3} each independently represent a group selected from the group consisting of (a) 1,4-cyclohexylene group (one —CH₂— or two or more non-adjacent —CH₂— present in this group may be substituted with —O—) and (b) 1,4-phenylene group (one —CH═ or two or more non-adjacent —CH═ present in this group may be substituted with —N═), and the group (a) and the group (b) may be independently substituted with a cyano group, a fluorine atom, or a chlorine atom;
L^{L1} and L^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF— or —C≡C—; and
in a case where OL is 2 or 3 and plural L^{L2}'s are present, these may be the same as or different from each other, and in a case where OL is 2 or 3 and plural B^{L3}'s are present, these may be the same as or different from each other;
with the proviso that the compounds represented by General Formula (I) are excluded.

The liquid crystal composition according to the present invention can also include one or more compounds represented by General Formula (L). The compounds that can be combined are not particularly limited; however, the compounds are used in appropriate combination in accordance with the desired performance such as the solubility at low temperature, the viscosity, the transition temperature, the electrical reliability, and the birefringence. The number of types of the compounds to be used is, for example, one in one embodiment of the present invention. The number of the types thereof is two in another embodiment of the present invention. Further, the number of the types thereof is three in another embodiment of the present invention. Further, the number of the types thereof is four in another embodiment of the present invention. Further, the number of the types thereof is five in another embodiment of the present invention. Further, the number of the types thereof is six in another embodiment of the present invention. Further, the number of the types thereof is seven in another embodiment of the present invention. Further, the number of the types thereof is eight in another embodiment of the present invention. Further, the number of the types thereof is nine in another embodiment of the present invention. Further, the number of the types thereof is ten or more in another embodiment of the present invention.

In the liquid crystal composition of the present invention, the content of the compound represented by General Formula (L) is required to be appropriately adjusted in accordance with desired performance such as ‘the solubility at low temperature, the transition temperature, the electrical reliability, the birefringence, the process adaptability, the drip mark, the burn-in, and the dielectric anisotropy.

With respect to the total content of the liquid crystal composition of the present invention, the content of the compound represented by General Formula (L) in one embodiment of the present invention is, for example, in a range of 10 to 90% by mass. Further, the above-described content in another embodiment of the present invention is in a range of 15 to 85% by mass. Further, the above-described content in another embodiment of the present invention is in a range of 20 to 80% by mass. Further, the above-described content in another embodiment of the present invention is in a range of 22 to 75% by mass. Further, the above-described content in another embodiment of the present invention is in a range of 30 to 70% by mass. Further, the above-described content in another embodiment of the present invention is in a range of 31 to 60% by mass. Further, the above-described content in another embodiment of the present invention is in a range of 33 to 55% by mass. Further, the above-described content in another embodiment of the present invention is in a range of 35 to 50% by mass. Further, the above-described content in another embodiment of the present invention is in a range of 36 to 45% by mass. Further, the above-described content in another embodiment of the present invention is in a range of 37 to 80% by mass. Further, the above-described content in another embodiment of the present invention is in a range of 39 to 80% by mass. Further, the above-described content in another embodiment of the present invention is in a range of 40 to 80% by mass. Further, the above-described content in another embodiment of the present invention is in a range of 41 to 80% by mass. Further, the above-described content in another embodiment of the present invention is in a range of 42 to 80% by mass. Further, the above-described content in another embodiment of the present invention is in a range of 43 to 80% by mass. Further, the above-described content in another embodiment of the present invention is in a range of 45 to 80% by mass. Further, the above-described content in another embodiment of the present invention is in a range of 46 to 80% by mass. Further, the above-described content in another embodiment of the present invention is in a range of 47 to 80% by mass. Further, the above-described content in another embodiment of the present invention is in a range of 49 to 80% embodiment of the present invention is in a range of 50 to 80% by mass. Further, the above-described content in another embodiment of the present invention is in a range of 51 to 80% by mass. Further, the above-described content in another embodiment of the present invention is in a range of 58 to 80% by mass. Further, the above-described content in another embodiment of the present invention is in a range of 59 to 80% by mass. Further, the above-described content in another embodiment of the present invention is in a range of 70 to 57% by mass. Further, the above-described content in another embodiment of the present invention is in a range of 20 to 76% by mass. Further, the above-described content in another embodiment of the present invention is in a range of 20 to 70% by mass. Further, the above-described content in another embodiment of the present invention is in a range of 20 to 59% by mass. Further, the above-described content in another embodiment of the present invention is in a range of 20 to 58% by mass. Further, the above-described content in another embodiment of the present invention is in a range of 20 to 56% by mass. Further, the above-described content in another embodiment of the present invention is in a range of 20 to 55% by mass. Further, the above-described content in another embodiment of the present invention is in a range of 20 to 53% by mass. Further, the above-described content in another embodiment of the present invention is in a range of 20 to 52% by mass. Further, the above-described content in another embodiment of the present invention is in a range of 20 to 51% by mass. Further, the above-described content in another embodiment of the present invention is in a range of 20 to 49% by mass. Further, the above-described content in another embodiment of the present invention is in a range of 20 to 48% by mass. Further, the above-described content in another embodiment of the present invention is in a range of 20 to 47% by mass. Further, the above-described content in another embodiment of the present invention is in a range of 20 to 45% by mass. Further, the above-described content in another embodiment of the present invention is in a range of 20 to 43% by mass. Further, the above-described content in another embodiment of the present invention is in a range of 20 to 41% by mass. Further, the above-described content in another embodiment of the present invention is in a range of 20 to 40% by mass. Further, the above-described content in another embodiment of the present invention is in a range of 20 to 37% by mass. Further, the above-described content in another embodiment of the present invention is in a range of 20 to 35% by mass. Further, the above-described content in another embodiment of the present invention is in a range of 20 to 33% by mass. Further, the above-described content in another embodiment of the present invention is in a range of 20 to 31% embodiment of the present invention is in a range of 20 to 30% by mass. Further, the above-described content in another embodiment of the present invention is in a range of 35 to 37% by mass. Further, the above-described content in another embodiment of the present invention is in a range of 37 to 48% by mass. Further, the above-described content in another embodiment of the present invention is in a range of 36 to 45% by mass. Further, the above-described content in another embodiment of the present invention is in a range of 39 to 43% by mass. Further, the above-described content in another embodiment of the present invention is in a range of 40 to 76% by mass. Further, the above-described content in another embodiment of the present invention is in a range of 42 to 56% by mass. Further, the above-described content in another embodiment of the present invention is in a range of 45 to 56% by mass. Further, the above-described content in another embodiment of the present invention is in a range of 47 to 55% by mass. Further, the above-described content in another embodiment of the present invention is in a range of 49 to 55% by mass. Further, the above-described content in another embodiment of the present invention is in a range of 50 to 53% by mass. Further, the above-described content in another embodiment of the present invention is in a range of 43 to 49% by mass. Further, the above-described content in another embodiment of the present invention is in a range of 46 to 52% by mass. Further, the above-described content in another embodiment of the present invention is in a range of 51 to 56% by mass.

In a case where a liquid crystal composition having a fast response speed is required while keeping the viscosity of the liquid crystal composition of the present invention to be low, it is preferable that the lower limit value is high and the upper limit value is high. Further, in a case where the liquid crystal composition having good temperature stability is required while keeping the T_{NI} of the liquid crystal composition of the present invention to be high, it is preferable that the lower limit value is high and the upper limit value is high. Further, when the dielectric anisotropy is to be large in order to keep the driving voltage to be low, it is preferable that the lower limit value is low and the upper limit value is low.

In a case where the ring structure to which R^{L1} and R^{L2} are bonded is a phenyl group (aromatic group), a linear alkyl group having 1 to 5 carbon atoms, a linear alkoxy group having 1 to 4 (or more) carbon atoms, and an alkenyl group having 4 to 5 carbon atoms are preferable, and in a case where the ring structure to which R^{L1} and R^{L2} are bonded is saturated, such as cyclohexane, pyran, and dioxane, a linear alkyl group having 1 to 5 carbon atoms, a linear alkoxy group having 1 to 4 (or more) carbon atoms, and a linear alkenyl group having 2 to 5 carbon atoms are preferable.

In a case where chemical stability of the liquid crystal composition is required. The compound represented by General Formula (I) according to the present invention is preferable not to have a chlorine atom in the molecule.

The compound represented by General Formula (I) according to the present invention is preferably, for example, a compound selected from the compound group represented by General Formula (I-A).

[Chem. 8]

R¹¹-A¹¹-A¹²-R¹² (I-A)

In General Formula (I-A), R¹¹ and R¹² each independently represent an alkyl group having 1 to 8 carbon atoms, an alkoxy group having 1 to 8 carbon atoms, or an alkenyl group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively, A¹¹ and A¹² each independently represent a 1,4-cyclohexylene group, a 1,4-phenylene group, a 2-fluoro-1,4-phenylene group, or a 3-fluoro-1,4-phenylene group.

The types of the compounds that can be combined are in the compound group represented by General Formula (I-A) are not particularly limited; however, the compounds are used in appropriate combination in accordance with the desired performance such as ‘the solubility at low temperature, the viscosity, the transition temperature, the electrical reliability, and the birefringence. The number of the types of the compounds to be used is, for example, one in one embodiment of the present invention. The number of the types thereof is two in another embodiment of the present invention. Further, the number of the types thereof is three in another embodiment of the present invention. Further, the number of the types thereof is four in another embodiment of the present invention. Further, the number of the types thereof is five in another embodiment of the present invention. Further, the number of the types thereof is six or more in another embodiment of the present invention.

The content of a so-called bicyclic compound represented by General Formula (I) in the liquid crystal composition of the present invention is required to be appropriately adjusted in accordance with desired performance such as the solubility at low temperature, the viscosity, the transition temperature, the electrical reliability, the birefringence, the process adaptability, the drip mark, the burn-in, and the dielectric anisotropy.

With respect to the total content of the liquid crystal composition of the present invention, the content of the compound represented by General Formula (I) in one embodiment of the present invention is, for example, in a range of 10 to 75% by mass. Or the above-described content in another embodiment of the present invention is in a range of 10 to 70% by mass. Further, the above-described content in another embodiment of the present invention is in a range of 10 to 65% by mass. Further, the above-described content in another embodiment of the present invention is in a range of 10 to 60% by mass. Further, the above-described content in another embodiment of the present invention is in a range of 15 to 60% by mass. Further, the above-described content in another embodiment of the present invention is in a range of 15 to 59% by mass. Further, the above-described content in another embodiment of the present invention is in a range of 15 to 56% embodiment of the present invention is in a range of 15 to 52% by mass. Further, the above-described content in another embodiment of the present invention is in a range of 15 to 51% by mass. Further, the above-described content in another embodiment of the present invention is in a range of 15 to 49% by mass. Further, the above-described content in another embodiment of the present invention is in a range of 15 to 48% by mass. Further, the above-described content in another embodiment of the present invention is in a range of 15 to 47% by mass. Further, the above-described content in another embodiment of the present invention is in a range of 15 to 45% by mass. Further, the above-described content in another embodiment of the present invention is in a range of 15 to 44% by mass. Further, the above-described content in another embodiment of the present invention is in a range of 15 to 43% by mass. Further, the above-described content in another embodiment of the present invention is in a range of 15 to 41% by mass. Further, the above-described content in another embodiment of the present invention is in a range of 15 to 39% by mass. Further, the above-described content in another embodiment of the present invention is in a range of 15 to 38% by mass. Further, the above-described content in another embodiment of the present invention is in a range of 15 to 35% by mass. Further, the above-described content in another embodiment of the present invention is in a range of 15 to 33% by mass. Further, the above-described content in another embodiment of the present invention is in a range of 15 to 31% by mass. Further, the above-described content in another embodiment of the present invention is in a range of 15 to 30% by mass. Further, the above-described content in another embodiment of the present invention is in a range of 15 to 29% by mass. Further, the above-described content in another embodiment of the present invention is in a range of 15 to 28% by mass. Further, the above-described content in another embodiment of the present invention is in a range of 15 to 20% by mass. Further, the above-described content in another embodiment of the present invention is in a range of 17 to 60% by mass. Further, the above-described content in another embodiment of the present invention is in a range of 20 to 60% by mass. Further, the above-described content in another embodiment of the present invention is in a range of 27 to 60% by mass. Further, the above-described content in another embodiment of the present invention is in a range of 28 to 60% by mass. Further, the above-described content in another embodiment of the present invention is in a range of 30 to 60% by mass. Further, the above-described content in another embodiment of the present invention is in a range of 31 to 60% by mass. Further, the above-described content in another embodiment of the present invention is in a range of 32 to 60% embodiment of the present invention is in a range of 33 to 60% by mass. Further, the above-described content in another embodiment of the present invention is in a range of 34 to 60% by mass. Further, the above-described content in another embodiment of the present invention is in a range of 35 to 60% by mass. Further, the above-described content in another embodiment of the present invention is in a range of 36 to 60% by mass. Further, the above-described content in another embodiment of the present invention is in a range of 37 to 60% by mass. Further, the above-described content in another embodiment of the present invention is in a range of 39 to 60% by mass. Further, the above-described content in another embodiment of the present invention is in a range of 41 to 60% by mass. Further, the above-described content in another embodiment of the present invention is in a range of 42 to 60% by mass. Further, the above-described content in another embodiment of the present invention is in a range of 43 to 60% by mass. Further, the above-described content in another embodiment of the present invention is in a range of 44 to 60% by mass. Further, the above-described content in another embodiment of the present invention is in a range of 46 to 60% by mass. Further, the above-described content in another embodiment of the present invention is in a range of 47 to 60% by mass. Further, the above-described content in another embodiment of the present invention is in a range of 48 to 60% by mass. Further, the above-described content in another embodiment of the present invention is in a range of 49 to 60% by mass. Further, the above-described content in another embodiment of the present invention is in a range of 51 to 60% by mass. Further, the above-described content in another embodiment of the present invention is in a range of 17 to 45% by mass. Further, the above-described content in another embodiment of the present invention is in a range of 27 to 29% by mass. Further, the above-described content in another embodiment of the present invention is in a range of 32 to 43% by mass. Further, the above-described content in another embodiment of the present invention is in a range of 34 to 38% by mass. Further, the above-described content in another embodiment of the present invention is in a range of 36 to 45% by mass. Further, the above-described content in another embodiment of the present invention is in a range of 37 to 48% by mass. Further, the above-described content in another embodiment of the present invention is in a range of 42 to 56% by mass. Further, the above-described content in another embodiment of the present invention is in a range of 43 to 52% by mass. Further, the above-described content in another embodiment of the present invention is in a range of 43 to 49% by mass. Further, the above-described content in another embodiment of the present invention is in a range of 43 to 44% embodiment of the present invention is in a range of 44 to 48% by mass. Further, the above-described content in another embodiment of the present invention is in a range of 47 to 51% by mass.

In the liquid crystal composition according to the present invention, from the aspect that it is possible to provide a liquid crystal composition having a fast response speed while keeping the viscosity to be low, it is particularly preferable to contain the compound group represented by General Formula (I).

In a case where the liquid crystal composition having the fast response speed while keeping the viscosity of the liquid crystal composition of the present invention to be low is required, it is preferable that the lower limit value of the content of the compound (group) represented by General Formula (I) is high and the upper limit value thereof is high.

Further, the compound represented by General Formula (I) is preferably a compound selected from the compound group represented by General Formula (I-1).

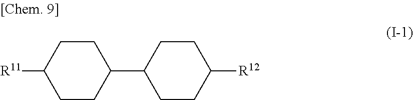

In General Formula (I-1), R¹¹ and R¹² represent the same meaning as being in General Formula (I).

As the compound represented by General Formula (I-1), 1 to 10 types of compounds, 1 to 9 types of compounds, 1 to 8 types of compounds, 1 to 7 types of compounds, 1 to 6 types of compounds, 2 to 9 types of compounds, 2 to 8 types of compounds, 2 to 6 types of compounds, 3 to 9 types of compounds, 3 to 7 types of compounds, 3 to 6 types of compounds, or 4 to 6 types of compounds are preferably mixed to be contained in the liquid crystal composition of the present invention.

In the liquid crystal composition according to the present invention, from the aspect that it is possible to provide a liquid crystal composition having a fast response speed while keeping the viscosity to be low is required, it is particularly preferable to contain the compound group represented by General Formula (I-1).

With respect to the total content of the liquid crystal composition of the present invention, the content of the compound represented by General Formula (I-1) in one embodiment of the present invention is for example, in a range of 10 to 70% by mass. Or the above-described content in another embodiment of the present invention is in a range of 10 to 60% by mass. Further, the above-described content in another embodiment of the present invention is in a range of 15 to 60% by mass. Further, the above-described content in another embodiment of the present invention is in a range of 15 to 59% by mass. Further, the above-described content in another embodiment of the present invention is in a range of 15 to 56% by mass. Further, the above-described content in another embodiment of the present invention is in a range of 15 to 52% by mass. Further, the above-described content in another embodiment of the present invention is in a range of 15 to 50% by mass. Further, the above-described content in another embodiment of the present invention is in a range of 15 to 49% by mass. Further, the above-described content in another embodiment of the present invention is in a range of 15 to 48% by mass. Further, the above-described content in another embodiment of the present invention is in a range of 15 to 47% by mass. Further, the above-described content in another embodiment of the present invention is in a range of 15 to 46% by mass. Further, the above-described content in another embodiment of the present invention is in a range of 15 to 45% by mass. Further, the above-described content in another embodiment of the present invention is in a range of 15 to 39% by mass. Further, the above-described content in another embodiment of the present invention is in a range of 15 to 38% by mass. Further, the above-described content in another embodiment of the present invention is in a range of 15 to 35% by mass. Further, the above-described content in another embodiment of the present invention is in a range of 15 to 33% by mass. Further, the above-described content in another embodiment of the present invention is in a range of 15 to 30% by mass. Further, the above-described content in another embodiment of the present invention is in a range of 15 to 28% by mass. Further, the above-described content in another embodiment of the present invention is in a range of 15 to 26% by mass. Further, the above-described content in another embodiment of the present invention is in a range of 15 to 20% by mass. Further, the above-described content in another embodiment of the present invention is in a range of 17 to 60% by mass. Further, the above-described content in another embodiment of the present invention is in a range of 20 to 60% by mass. Further, the above-described content in another embodiment of the present invention is in a range of 21 to 60% by mass. Further, the above-described content in another embodiment of the present invention is in a range of 23 to 60% by mass. Further, the above-described content in another embodiment of the present invention is in a range of 26 to 60% embodiment of the present invention is in a range of 27 to 60% by mass. Further, the above-described content in another embodiment of the present invention is in a range of 2 to 60% by mass. Further, the above-described content in another embodiment of the present invention is in a range of 30 to 60% by mass. Further, the above-described content in another embodiment of the present invention is in a range of 33 to 60% by mass. Further, the above-described content in another embodiment of the present invention is in a range of 34 to 60% by mass. Further, the above-described content in another embodiment of the present invention is in a range of 35 to 60% by mass. Further, the above-described content in another embodiment of the present invention is in a range of 36 to 60% by mass. Further, the above-described content in another embodiment of the present invention is in a range of 37 to 60% by mass. Further, the above-described content in another embodiment of the present invention is in a range of 38 to 60% by mass. Further, the above-described content in another embodiment of the present invention is in a range of 39 to 60% by mass. Further, the above-described content in another embodiment of the present invention is in a range of 42 to 60% by mass. Further, the above-described content in another embodiment of the present invention is in a range of 43 to 60% by mass. Further, the above-described content in another embodiment of the present invention is in a range of 46 to 60% by mass. Further, the above-described content in another embodiment of the present invention is in a range of 47 to 60% by mass. Further, the above-described content in another embodiment of the present invention is in a range of 49 to 60% by mass. Further, the above-described content in another embodiment of the present invention is in a range of 50 to 60% by mass. Further, the above-described content in another embodiment of the present invention is in a range of 17 to 45% by mass. Further, the above-described content in another embodiment of the present invention is in a range of 21 to 24% by mass. Further, the above-described content in another embodiment of the present invention is in a range of 27 to 38% by mass. Further, the above-described content in another embodiment of the present invention is in a range of 28 to 29% by mass. Further, the above-described content in another embodiment of the present invention is in a range of 23 to 46% by mass. Further, the above-described content in another embodiment of the present invention is in a range of 34 to 38% by mass. Further, the above-described content in another embodiment of the present invention is in a range of 36 to 45% by mass. Further, the above-described content in another embodiment of the present invention is in a range of 37 to 48% by mass. Further, the above-described content in another embodiment of the present invention is in a range of 42 to 48% embodiment of the present invention is in a range of 38 to 49% by mass. Further, the above-described content in another embodiment of the present invention is in a range of 42 to 56% by mass. Further, the above-described content in another embodiment of the present invention is in a range of 42 to 50% by mass. Further, the above-described content in another embodiment of the present invention is in a range of 43 to 52% by mass. Further, the above-described content in another embodiment of the present invention is in a range of 46 to 47% by mass.

In a case where a liquid crystal composition having a fast response speed while keeping the viscosity of the liquid crystal composition of the present invention to be low is required, it is preferable that the lower limit value is high and the upper limit value is high.

Further, the compound represented by General Formula (I-1) is preferably a compound selected from the compound group represented by General Formula (I-1-1).

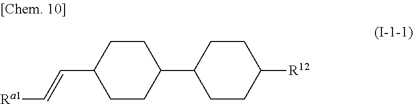

In General Formula (I-1-1), R¹² represents the same meaning as being in General Formula (I), R^{a1} is a hydrogen atom or an alkyl group having 1 to 3 carbon atoms.

In the liquid crystal composition according to the present invention, from the aspect that it is possible to provide a liquid crystal composition having a fast response speed while keeping the viscosity to be low is required, it is particularly preferable to contain the compound group represented by General Formula (I-1-1).

With respect to the total content of the liquid crystal composition of the present invention, the content of the compound represented by General Formula (I-1-1) in one embodiment of the present invention is for example, in a range of 1 to 45% by mass. Further, the above-described content in one embodiment of the present invention is in a range of 1 to 35% by mass. Or the above-described content in another embodiment of the present invention is in a range of 1 to 30% by mass. Further, the above-described content in another embodiment of the present invention is in a range of 1 to 26% by mass. Further, the above-described content in another embodiment of the present invention is in a range of 1 to 21% by mass. Further, the above-described content in another embodiment of the present invention is in a range of 1 to 16% embodiment of the present invention is in a range of 1 to 15% by mass. Further, the above-described content in another embodiment of the present invention is in a range of 1 to 13% by mass. Further, the above-described content in another embodiment of the present invention is in a range of 1 to 12% by mass. Further, the above-described content in another embodiment of the present invention is in a range of 1 to 11% by mass. Further, the above-described content in another embodiment of the present invention is in a range of 1 to 10% by mass. Further, the above-described content in another embodiment of the present invention is in a range of 1 to 8% by mass. Further, the above-described content in another embodiment of the present invention is in a range of 1 to 7% by mass. Further, the above-described content in another embodiment of the present invention is in a range of 1 to 5% by mass. Further, the above-described content in another embodiment of the present invention is in a range of 1 to 4% by mass. Further, the above-described content in another embodiment of the present invention is in a range of 3 to 30% by mass. Further, the above-described content in another embodiment of the present invention is in a range of 4 to 30% by mass. Further, the above-described content in another embodiment of the present invention is in a range of 5 to 30% by mass. Further, the above-described content in another embodiment of the present invention is in a range of 6 to 30% by mass. Further, the above-described content in another embodiment of the present invention is in a range of 7 to 30% by mass. Further, the above-described content in another embodiment of the present invention is in a range of 8 to 30% by mass. Further, the above-described content in another embodiment of the present invention is in a range of 9 to 30% by mass. Further, the above-described content in another embodiment of the present invention is in a range of 10 to 30% by mass. Further, the above-described content in another embodiment of the present invention is in a range of 11 to 30% by mass. Further, the above-described content in another embodiment of the present invention is in a range of 12 to 30% by mass. Further, the above-described content in another embodiment of the present invention is in a range of 13 to 30% by mass. Further, the above-described content in another embodiment of the present invention is in a range of 3 to 26% by mass. Further, the above-described content in another embodiment of the present invention is in a range of 3 to 13% by mass. Further, the above-described content in another embodiment of the present invention is in a range of 3 to 8% by mass. Further, the above-described content in another embodiment of the present invention is in a range of 4 to 7% by mass. Further, the above-described content in another embodiment of the present invention is in a range of 5 to 12% embodiment of the present invention is in a range of 9 to 12% by mass. Further, the above-described content in another embodiment of the present invention is in a range of 6 to 16% by mass. Further, the above-described content in another embodiment of the present invention is in a range of 7 to 16% by mass. Further, the above-described content in another embodiment of the present invention is in a range of 7 to 10% by mass. Further, the above-described content in another embodiment of the present invention is in a range of 8 to 26% by mass. Further, the above-described content in another embodiment of the present invention is in a range of 8 to 15% by mass. Further, the above-described content in another embodiment of the present invention is in a range of 8 to 13% by mass. Further, the above-described content in another embodiment of the present invention is in a range of 9 to 25% by mass. Further, the above-described content in another embodiment of the present invention is in a range of 10 to 21% by mass. Further, the above-described content in another embodiment of the present invention is in a range of 12 to 21% by mass. Further, the above-described content in another embodiment of the present invention is in a range of 13 to 16% by mass. Further, the above-described content in another embodiment of the present invention is in a range of 11 to 26% by mass.

Further, the compound represented by General Formula (I-1-1) is preferably a compound selected from the compound group represented by from formula (1.1) to formula (1.5), is preferably a compound represented by formula (1.2) or formula (1.3), and is particularly preferably a compound represented by formula (1.3).

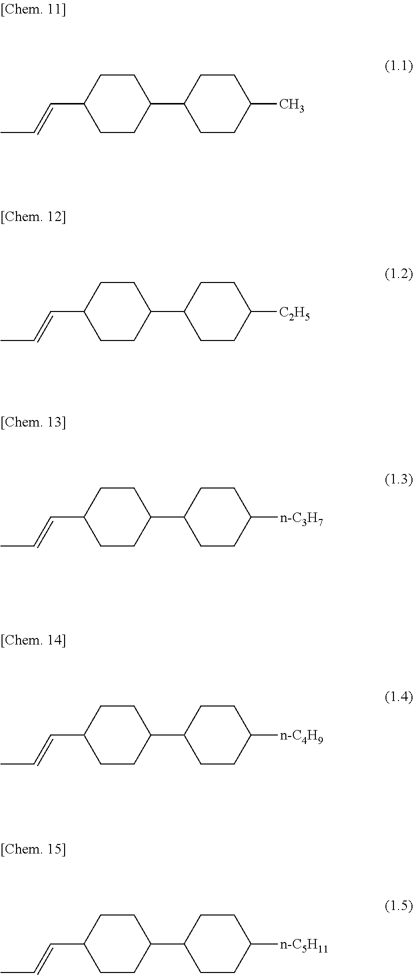

In a case where the compound represented by the above-described formula (1.2) or the above-described formula (1.3) is used alone, the content of the compound represented by formula (1.2) is preferably increased so as to improve the response speed, and the content of the compound represented by formula (1.3) is preferably in a range described below so as to realize a liquid crystal composition having the fast response speed and electrically and optically high reliability.

With respect to the total content of the liquid crystal composition of the present invention, the content of the compound represented by the above-described formula (1.3) in one embodiment of the present invention is for example, in a range of 1 to 45% by mass. Further, the above-described content in one embodiment of the present invention is in a range of 1 to 35% by mass. Or the above-described content in another embodiment of the present invention is in a range of 1 to 30% by mass. Or the above-described content in another embodiment of the present invention is in a range of 1 to 25% by mass. Or the above-described content in another embodiment of the present invention is in a range of 1 to 21% by mass. Or the above-described content in another embodiment of the present invention is in a range of 1 to 18% by mass. Or the above-described content in another embodiment of the present invention is in a range of 1 to 16% by mass. Or the above-described content in another embodiment of the present invention is in a range of 1 to 15% by mass. Or the above-described content in another embodiment of the present invention is in a range of 1 to 13% by mass. Or the above-described content in another embodiment of the present invention is in a range of 1 to 12% by mass. Or the above-described content in another embodiment of the present invention is in a range of 1 to 11% by mass. Or the above-described content in another embodiment of the present invention is in a range of 1 to 10% by mass. Or the above-described content in another embodiment of the present invention is in a range of 1 to 8% by mass. Or the above-described content in another embodiment of the present invention is in a range of 1 to 7% by mass. Or the above-described content in another embodiment of the present invention is in a range of 1 to 5% by mass. Or the above-described content in another embodiment of the present invention is in a range of 1 to 4% by mass. Or the above-described content in another embodiment of the present invention is in a range of 3 to 21% by mass. Or the above-described content in another embodiment of the present invention is in a range of 4 to 21% by mass. Or the above-described content in another embodiment of the present invention is in a range of 5 to 21% by mass. Or the above-described content in another embodiment of the present invention is in a range of 6 to 21% by mass. Or the above-described content in another embodiment of the present invention is in a range of 7 to 21% by mass. Or the above-described content in another embodiment of the present invention is in a range of 8 to 21% by mass. Or the above-described content in another embodiment of the present invention is in a range of 9 to 21% by mass. Or the above-described content in another embodiment of the present invention is in a range of 10 to 21% by mass. Or the above-described content in another embodiment of the present invention is in a range of 11 to 21% by mass. Or the above-described content in another embodiment of the present invention is in a range of 12 to 21% by mass. Or the above-described content in another embodiment of the present invention is in a range of 13 to 21% by mass. Or the above-described content in another embodiment of the present invention is in a range of 3 to 13% by mass. Or the above-described content in another embodiment of the present invention is in a range of 3 to 8% by mass. Or the above-described content in another embodiment of the present invention is in a range of 4 to 7% by mass. Or the above-described content in another embodiment of the present invention is in a range of 5 to 12% by mass. Or the above-described content in another embodiment of the present invention is in a range of 9 to 12% by mass. Or the above-described content in another embodiment of the present invention is in a range of 6 to 16% by mass. Or the above-described content in another embodiment of the present invention is in a range of 10 to 16% by mass. Or the above-described content in another embodiment of the present invention is in a range of 13 to 16% by mass. Or the above-described content in another embodiment of the present invention is in a range of 7 to 16% by mass. Or the above-described content in another embodiment of the present invention is in a range of 7 to 10% by mass. Or the above-described content in another embodiment of the present invention is in a range of 8 to 18% by mass. Or the above-described content in another embodiment of the present invention is in a range of 8 to 15% by mass. Or the above-described content in another embodiment of the present invention is in a range of 8 to 13% by mass. Or the above-described content in another embodiment of the present invention is in a range of 9 to 13% by mass.

Further, the compound represented by General Formula (I-1) according to the present invention is preferably a compound selected from the compound group represented by General Formula (I-1-2).

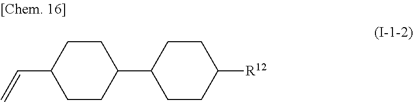

In General Formula (I-1-2), R¹² represents the same meaning as being in General Formula (I).

The number of the types of the compounds to be used as the compound represented by General Formula (I-1-2) is, for example, one in one embodiment of the present invention. The number of the types thereof is two in another embodiment of the present invention. Further, the number of the types thereof is three in another embodiment of the present invention.

In the liquid crystal composition of the present invention, the content of the compound represented by General Formula (I-1-2) is required to be appropriately adjusted in accordance with desired performance such as the solubility at low temperature, the viscosity, the transition temperature, the electrical reliability, the birefringence, the process adaptability, the drip mark, the burn-in, and the dielectric anisotropy.

With respect to the total content of the liquid crystal composition of the present invention, the content of the compound represented by General Formula (I-1-2) in one embodiment of the present invention is, for example, in a range of 1 to 70% by mass. Further, the above-described content thereof in one embodiment of the present invention is in a range of 1 to 65% by mass. Further, the above-described content thereof in one embodiment of the present invention is in a range of 1 to 55% by mass. Or the above-described content in another embodiment of the present invention is in a range of 1 to 50% by mass. Further, the above-described content in another embodiment of the present invention is in a range of 1 to 49% by mass. Further, the above-described content in another embodiment of the present invention is in a range of 1 to 47% by mass. Further, the above-described content in another embodiment of the present invention is in a range of 1 to 45% by mass. Further, the above-described content in another embodiment of the present invention is in a range of 1 to 44% by mass. Further, the above-described content in another embodiment of the present invention is in a range of 1 to 40% by mass. Further, the above-described content in another embodiment of the present invention is in a range of 1 to 39% embodiment of the present invention is in a range of 1 to 38% by mass. Further, the above-described content in another embodiment of the present invention is in a range of 1 to 36% by mass. Further, the above-described content in another embodiment of the present invention is in a range of 1 to 35% by mass. Further, the above-described content in another embodiment of the present invention is in a range of 1 to 32% by mass. Further, the above-described content in another embodiment of the present invention is in a range of 1 to 30% by mass. Further, the above-described content in another embodiment of the present invention is in a range of 1 to 28% by mass. Further, the above-described content in another embodiment of the present invention is in a range of 1 to 27% by mass. Further, the above-described content in another embodiment of the present invention is in a range of 1 to 26% by mass. Further, the above-described content in another embodiment of the present invention is in a range of 1 to 24% by mass. Further, the above-described content in another embodiment of the present invention is in a range of 1 to 21% by mass. Further, the above-described content in another embodiment of the present invention is in a range of 1 to 20% by mass. Further, the above-described content in another embodiment of the present invention is in a range of 1 to 19% by mass. Further, the above-described content in another embodiment of the present invention is in a range of 1 to 16% by mass. Further, the above-described content in another embodiment of the present invention is in a range of 1 to 15% by mass. Further, the above-described content in another embodiment of the present invention is in a range of 11 to 49% by mass. Further, the above-described content in another embodiment of the present invention is in a range of 12 to 49% by mass. Further, the above-described content in another embodiment of the present invention is in a range of 13 to 49% by mass. Further, the above-described content in another embodiment of the present invention is in a range of 15 to 49% by mass. Further, the above-described content in another embodiment of the present invention is in a range of 16 to 49% by mass. Further, the above-described content in another embodiment of the present invention is in a range of 17 to 49% by mass. Further, the above-described content in another embodiment of the present invention is in a range of 20 to 49% by mass. Further, the above-described content in another embodiment of the present invention is in a range of 23 to 49% by mass. Further, the above-described content in another embodiment of the present invention is in a range of 24 to 49% by mass. Further, the above-described content in another embodiment of the present invention is in a range of 25 to 49% by mass. Further, the above-described content in another embodiment of the present invention is in a range of 28 to 49% embodiment of the present invention is in a range of 30 to 49% by mass. Further, the above-described content in another embodiment of the present invention is in a range of 33 to 49% by mass. Further, the above-described content in another embodiment of the present invention is in a range of 35 to 49% by mass. Further, the above-described content in another embodiment of the present invention is in a range of 38 to 49% by mass. Further, the above-described content in another embodiment of the present invention is in a range of 39 to 49% by mass. Further, the above-described content in another embodiment of the present invention is in a range of 45 to 49% by mass. Further, the above-described content in another embodiment of the present invention is in a range of 11 to 44% by mass. Further, the above-described content in another embodiment of the present invention is in a range of 12 to 24% by mass. Further, the above-described content in another embodiment of the present invention is in a range of 13 to 16% by mass. Further, the above-described content in another embodiment of the present invention is in a range of 15 to 32% by mass. Further, the above-described content in another embodiment of the present invention is in a range of 15 to 21% by mass. Further, the above-described content in another embodiment of the present invention is in a range of 17 to 20% by mass. Further, the above-described content in another embodiment of the present invention is in a range of 16 to 27% by mass. Further, the above-described content in another embodiment of the present invention is in a range of 17 to 28% by mass. Further, the above-described content in another embodiment of the present invention is in a range of 20 to 35% by mass. Further, the above-described content in another embodiment of the present invention is in a range of 23 to 26% by mass. Further, the above-described content in another embodiment of the present invention is in a range of 24 to 40% by mass. Further, the above-described content in another embodiment of the present invention is in a range of 28 to 38% by mass. Further, the above-described content in another embodiment of the present invention is in a range of 30 to 38% by mass. Further, the above-described content in another embodiment of the present invention is in a range of 25 to 36% by mass. Further, the above-described content in another embodiment of the present invention is in a range of 27 to 30% by mass. Further, the above-described content in another embodiment of the present invention is in a range of 30 to 40% by mass. Further, the above-described content in another embodiment of the present invention is in a range of 30 to 39% by mass. Further, the above-described content in another embodiment of the present invention is in a range of 35 to 44% by mass. Further, the above-described content in another embodiment of the present invention is in a range of 35 to 40% embodiment of the present invention is in a range of 33 to 47% by mass. Further, the above-described content in another embodiment of the present invention is in a range of 39 to 47% by mass. Further, the above-described content in another embodiment of the present invention is in a range of 38 to 45% by mass.

Further, the compound represented by General Formula (I-1-2) is preferably a compound selected from the compound group represented by from formula (2.1) to formula (2.8), and is preferably a compound selected from the compound group represented by from formula (2.2) to formula (2.4). The compound represented by formula (2.2) is particularly preferable so as to improve the response speed the liquid crystal composition of the present invention. In addition, when T_{NI} which is higher than the response speed is required, it is preferable to use the compound represented by formula (2.3) or formula (2.4). The content of the compound represented by formula (2.3) and formula (2.4) is preferably less than 30% so as to improve the solubility at low temperature.

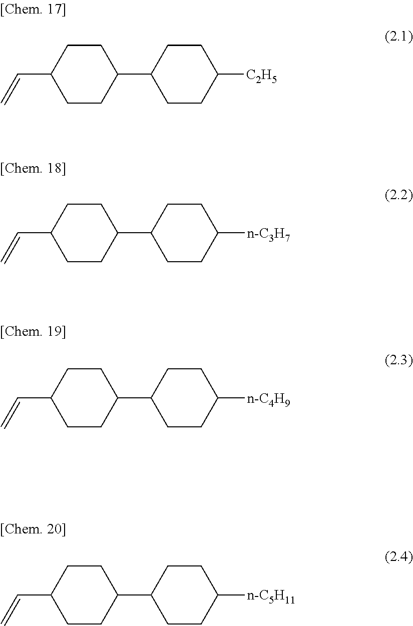

With respect to the total content of the liquid crystal composition of the present invention, the content of the compound represented by formula (2.2) in the liquid crystal composition of the present invention is preferably in a range of 1% by mass to 70% by mass, is preferably in a range of 1% by mass to 65% by mass, is preferably in a range of 1% by mass to 60% by mass, is preferably in a range of 1% by mass to 55% by mass, is preferably in a range of 1% by mass to 50% by mass, and 5% by mass to 50% by mass. Among them, it is preferable that the above-described content is in a range of 9% by mass to 47% by mass, 9% by mass to 15% by mass, 11% by mass to 44% by mass, 15% by mass to 32% by mass, 20% by mass to 35% by mass, 23% by mass to 26% by mass, 24% by mass to 40% by mass, 25% by mass to 36% by mass, 28% by mass to 38% by mass, 30% by mass to 40% by mass, 30% by mass to 39% by mass, 30% by mass to 38% by mass, 33% by mass to 47% by mass, 35% by mass to 44% by mass, 35% by mass to 40% by mass, 38% by mass to 45% by mass, and 39% by mass to 47% by mass.

With respect to the total content of the liquid crystal composition of the present invention, the content of the compound represented by formula (2.3) in the liquid crystal composition of the present invention is preferably in a range of 1% by mass to 30% by mass, is preferably in a range of 1% by mass to 25% by mass, is preferably in a range of 3% by mass to 25% by mass, is preferably in a range of 4% by mass to 22% by mass, is preferably in a range of 5% by mass to 22% by mass, is preferably in a range of 11% by mass to 22% by mass, is preferably in a range of 13% by mass to 22% by mass, is preferably in a range of 4% by mass to 16% by mass, is preferably in a range of 4% by mass to 15% by mass, is preferably in a range of 4% by mass to 10% by mass, is preferably in a range of 5% by mass to 10% by mass, is preferably in a range of 12% by mass to 15% by mass, and is preferably in a range of 13% by mass to 16% by mass.

With respect to the total content of the liquid crystal composition of the present invention, the content of the compound represented by formula (2.4) in the liquid crystal composition of the present invention is preferably in a range of 1% by mass to 30% by mass, is preferably in a range of 1% by mass to 25% by mass, is preferably in a range of 3% by mass to 25% by mass, is preferably in a range of 4% by mass to 25% by mass, is preferably in a range of 12% by mass to 25% by mass, is preferably in a range of 17% by mass to 25% by mass, is preferably in a range of 20% by mass to 25% by mass, is preferably in a range of in a range of 4% by mass to 20% by mass, is preferably in a range of 4% by mass to 13% by mass, is preferably in a range of 12% by mass to 24% by mass, and is preferably in a range of 17% by mass to 20% by mass.

The liquid crystal composition of the invention of the present application can also contain the compound represented by formula (2.5) which has a structure similar to the compound represented by General Formula (I-1-2).

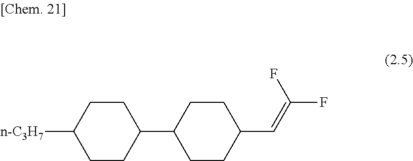

It is preferable to adjust the content of the compound represented by formula (2.5) in accordance with the desired performance such as the solubility at low temperature, the transition temperature, the electrical reliability, and the birefringence, and a preferable range of the content is as shown in the following table.

It is preferable to adjust the content of the compound represented by formula (2.5) in accordance with the desired performance such as the solubility at low temperature, the transition temperature, the electrical reliability, and the birefringence, and with respect to the total content of the liquid crystal composition of the present invention, the content of the above-described compound is preferably in a range of 0 to 40% by mass, is preferably in a range of 1 to 35% by mass, is preferably in a range of 1 to 30% by mass, is preferably in a range of 5 to 30% by mass, is preferably in a range of 10 to 30% by mass, is preferably in a range of 15 to 30% by mass, is preferably in a range of 20 to 30% by mass, and is preferably in a range of 25 to 30% by mass.

Further, the compound represented by General Formula (I) according to the present invention is preferably a compound selected from the compound group represented by General Formula (I-2).

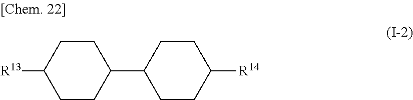

In General Formula (I-2), R¹³ and R¹⁴ each independently represent an alkyl group having 1 to 5 carbon atoms.

The compounds that can be combined are not particularly limited; however, the compounds are appropriately combined with each other in accordance with the desired performance such as the solubility at low temperature, the transition temperature, the electrical reliability, and the birefringence. The number of the types of the compounds to be used is, for example, one in one embodiment of the present invention. The number of the types thereof is two in another embodiment of the present invention. Further, the number of the types thereof is three in another embodiment of the present invention.

In the liquid crystal composition of the present invention, the content of the compound represented by General Formula (I-2) is required to be appropriately adjusted in accordance with desired performance such as the solubility at low temperature, the transition temperature, the electrical reliability, the birefringence, the process adaptability, the drip mark, the burn-in, and the dielectric anisotropy.

With respect to the total content of the liquid crystal composition of the present invention, the content of the compound represented by General Formula (I-2) in one embodiment of the present invention is, for example, in a range of 1 to 30% by mass. Or the above-described content in another embodiment of the present invention is in a range of 2 to 30% by mass. Further, the above-described content in another embodiment of the present invention is in a range of 4 to 30% by mass. Further, the above-described content in another embodiment of the present invention is in a range of 4 to 25% by mass. Further, the above-described content in another embodiment of the present invention is in a range of 4 to 23% by mass.

Further, the compound represented by General Formula (I-2) is preferably a compound selected from the compound group represented by formula (3.1) to formula (3.4), and is preferably a compound represented by formula (3.1), formula (3.3), or formula (3.4). The compound represented by formula (3.2) is particularly preferably used so as to improve the response speed of the liquid crystal composition of the present invention. Further, when high T_{NI} is required more than the response speed, it is preferable to use the compound represented by formula (3.3) or formula (3.4). The content of the compounds represented by formula (3.3) and formula (3.4) are preferably less than 20% so as to improve the solubility at low temperature.

Further, the compound represented by General Formula (I-2) is preferably a compound selected from the compound group represented by formula (3.1) to formula (3.4), and is preferably a compound represented by formula (3.1), formula (3.3) and/or formula (3.4).

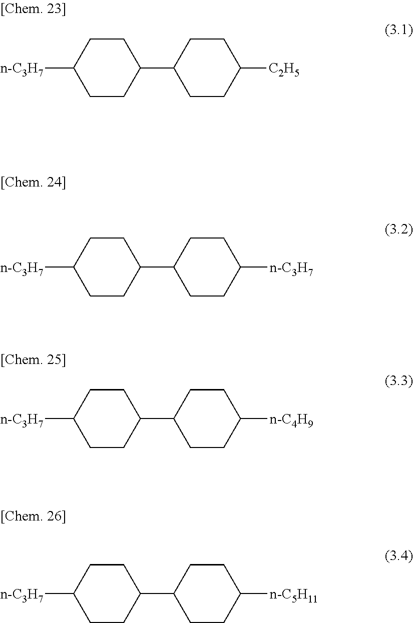

With respect to the total content of the liquid crystal composition of the present invention, the content of the compound represented by the above-described formula (3.3) in the liquid crystal composition of the present invention is preferably in a range of 1% by mass to 25% by mass, is preferably in a range of 1% by mass to 20% by mass, is preferably in a range of 1% by mass to 15% by mass, is preferably in a range of 1% by mass to 10% by mass, and is preferably in a range of 1% by mass to 5% by mass.

Further, the compound represented by General Formula (I) according to the present invention is preferably a compound selected from the compound group represented by General Formula (I-3).

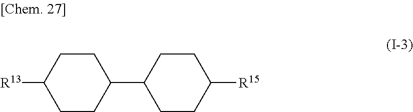

In General Formula (I-3), R¹³ represents the same meaning as being in General Formula (I-2).

The compounds that can be combined are not particularly limited; however, the compounds combined with each other in accordance with the desired performance such as the solubility at low temperature, the transition temperature, the electrical reliability, and the birefringence. The number of the types of the compounds to be used is, for example, one in one embodiment of the present invention. The number of the types thereof is two in another embodiment of the present invention. Further, the number of the types thereof is three in another embodiment of the present invention.

In the liquid crystal composition of the present invention, the content of the compound represented by General Formula (I-3) is required to be appropriately adjusted in accordance with desired performance such as the solubility at low temperature, the transition temperature, the electrical reliability, the birefringence, the process adaptability, the drip mark, the burn-in, and the dielectric anisotropy.

A preferable range of the content is as shown in the following table.

With respect to the total content of the liquid crystal composition of the present invention, the content of the compound represented by General Formula (I-3) in one embodiment of the present invention is, for example, in a range of 3 to 30% by mass. Or the above-described content in another embodiment of the present invention is in a range of 4 to 30% embodiment of the present invention is in a range of 15 to 30% by mass. Further, the above-described content in another embodiment of the present invention is in a range of 25 to 30% by mass. Further, the above-described content in another embodiment of the present invention is in a range of 3 to 25% by mass. Further, the above-described content in another embodiment of the present invention is in a range of 3 to 20% by mass. Further, the above-described content in another embodiment of the present invention is in a range of 3 to 15% by mass. Further, the above-described content in another embodiment of the present invention is in a range of 3 to 5% by mass.

In a case where emphasis is placed on the solubility at low temperature, it is preferable to set the content to be higher; whereas in a case where emphasis is placed on response speed, it is preferable to set the content to be lower. Furthermore, in the case of improving the drip mark or burn-in, it is preferable to set the content range to a medium level.

Further, the compound represented by General Formula (I-3) is preferably a compound selected from the compound group represented by formula (4.1) to formula (4.3), and is preferably a compound represented by formula (4.3).

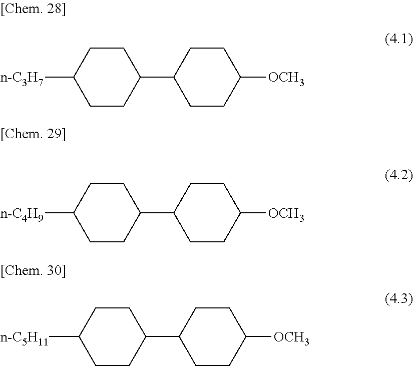

With respect to the total content of the liquid crystal composition of the present invention, the content of the compound represented by formula (4.3) is preferably in a range of 2% by mass to 30% by mass, 4% by mass to 30% by mass, 6% by mass to 30% by mass, 8% by mass to 30% by mass, 10% by mass to 30% by mass, 12% by mass to 30% by mass, 14% by mass to 30% by mass, 16% by mass to 30% by mass, 18% by mass to 25% by mass, 20% by mass to 24% by mass, and 22% by mass to 23% by mass.

Further, the compound represented by General Formula (I) according to the present invention is preferably a compound selected from the compound group represented by General Formula (I-0).

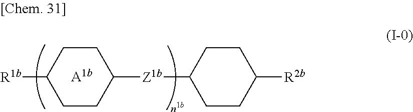

In General Formula (I-0), R^{1b} represents the same as R¹ in General Formula (I), R^{2b} represents the same as R² in General Formula (I), n^{1b} represents 1 or 2, A^{1b} represents the same as A¹ in General Formula (I), Z^{1b} represents the same as Z¹ in General Formula (I).

With respect to the total content of the liquid crystal composition of the present invention, the content of the compound represented by General Formula (I-0) in the liquid crystal composition of the present invention is preferably in a range of 1% by mass to 55% by mass, 1% by mass to 50% by mass, and 5% by mass to 50% by mass. Among them, it is preferable that the above-described content is in a range of 9% by mass 47% by mass, 9% by mass to 15% by mass, 11% by mass to 44% by mass, 15% by mass to 32% by mass, 20% by mass to 35% by mass, 23% by mass to 26% by mass, 24% by mass to 40% by mass, 25% by mass to 36% by mass, 28% by mass to 38% by mass, 30% by mass to 40% by mass, 30% by mass to 39% by mass, 30% by mass to 38% by mass, 33% by mass to 47% by mass, 35% by mass to 44% by mass, 35% by mass to 40% by mass, 38% by mass to 45% by mass, and 39% by mass to 47% by mass.

With respect to the total content of the liquid crystal composition of the present invention, the content of the compound represented by formula (2.3) in the liquid crystal composition of the present invention is preferably in a range of 1% by mass to 30% by mass, is preferably in a range of 1% by mass to 25% by mass, is preferably in a range of 3% by mass to 25% by mass, is preferably in a range of 4% by mass to 22% by mass, is preferably in a range of 5% by mass to 22% by mass, is preferably in a range of 11% by mass to 22% by mass, is preferably in a range of 13% by mass to 22% by mass, is preferably in a range of 4% by mass to 16% by mass, is preferably in a range of 4% by mass to 15% by mass, is preferably in a range of 4% by mass to 10% by mass, is preferably in a range of 5% by mass to 10% by mass, is preferably in a range of 12% by mass to 15% by mass, and is preferably in a range of 13% by mass to 16% by mass.

In the liquid crystal composition of the present invention, the content of the compound represented by General Formula (I-0) is required to be appropriately adjusted in accordance with desired performance such as the solubility at low temperature, the transition temperature, the electrical reliability, the birefringence, the process adaptability, the drip mark, the burn-in, and the dielectric anisotropy.

Particularly, it is preferable that a compound represented by the following General Formula (II-2) is contained in a composition in terms of the improvement of the response speed of the liquid crystal composition.

Further, the compound represented by General Formula (I) according to the present invention is preferably a compound selected from the compound group represented by General Formula (I-4).

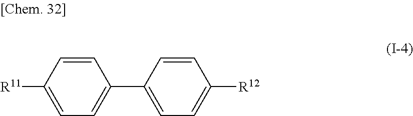

In General Formula (I-4), R¹¹ and R¹² represent the same meaning as being in General Formula (I).

The compounds that can be combined are not particularly limited; however, the compounds combined with each other in accordance with the desired performance such as the solubility at low temperature, the transition temperature, the electrical reliability, and the birefringence. The number of the types of the compounds to be used is, for example, one in one embodiment of the present invention. The number of the types of the compounds is two in another embodiment of the present invention.

In the liquid crystal composition of the present invention, the content of the compound represented by General Formula (I-4) is required to be appropriately adjusted in accordance with desired performance such as the solubility at low temperature, the transition temperature, the electrical reliability, the birefringence, the process adaptability, the drip mark, the burn-in, and the dielectric anisotropy.

Particularly, it is preferable that a compound represented by the following Formula (5.4) is contained in a composition in terms of the improvement of the response speed of the liquid crystal composition, and in terms of an even-odd effect and an elastic constant (K₃₃).

With respect to the total content of the liquid crystal composition of the present invention, the content of the compound represented by General Formula (I-4) in one embodiment of the present invention is, for example, in a range of 2 to 30% by mass. Or the above-described content in another embodiment of the present invention is in a range of 5 to 30% by mass. Further, the above-described content in another embodiment of the present invention is in a range of 6 to 30% by mass. Further, the above-described content in another embodiment of the present invention is in a range of 8 to 30% by mass. Further, the above-described content in another embodiment of the present invention is in a range of 10 to 30% by mass. Further, the above-described content in another embodiment of the present invention is in a range of 12 to 30% by mass. Further, the above-described content in another embodiment of the present invention is in a range of 15 to 30% by mass. Further, the above-described content in another embodiment of the present invention is in a range of 20 to 30% by mass. Further, the above-described content in another embodiment of the present invention is in a range of 25 to 30% by mass. Further, the above-described content in another embodiment of the present invention is in a range of 2 to 25% by mass. Further, the above-described content in another embodiment of the present invention is in a range of 2 to 20% by mass. Further, the above-described content in another embodiment of the present invention is in a range of 2 to 15% by mass. Further, the above-described content in another embodiment of the present invention is in a range of 2 to 10% by mass. Further, the above-described content in another embodiment of the present invention is in a range of 5 to 8% by mass.

In a case of obtaining high birefringence, setting the content to be increased is effective, and in a case where emphasis is placed on T_{NI}, setting the content to be reduced is effective. Furthermore, in the case of improving the drip mark or burn-in characteristics, it is preferable to set the content range to a medium level.

Further, the compound represented by General Formula (I-4) is preferably a compound selected from the compound group represented by formula (5.1) to formula (5.4), is preferably a compound selected from the compound group represented by formula (5.2) to formula (5.7), and is further preferably at least one selected from the compound group represented by formula (5.3) to formula (5.4).

It is preferable to contain an alkenyl group 1 to 8 carbon atoms in one of a substituent of an end of a skeleton represented by General Formula (I-4) in terms of the high-speed responsiveness of the liquid crystal composition.

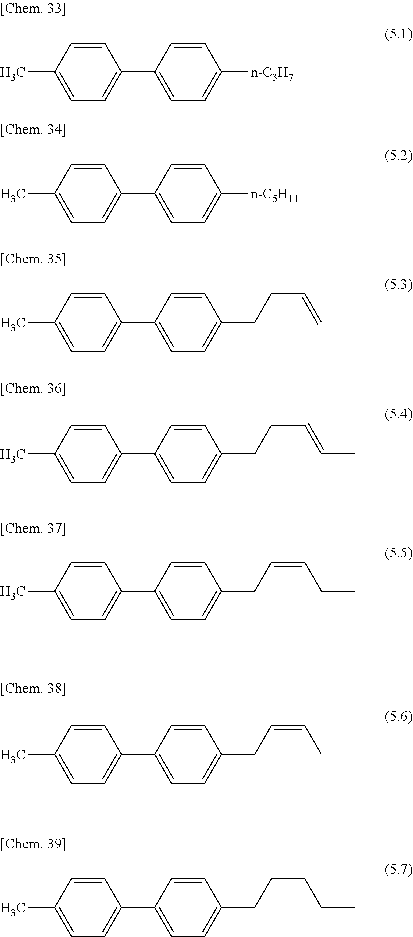

Particularly, with respect to the total content of the liquid crystal composition of the present invention, the content of the compound represented by the above-described formula (5.4) is preferably in a range of 2% by mass to 30% by mass. Among them, the above-described the content is, for example, in a range of 4% by mass to 30% by mass, 6% by mass to 30% by mass, 8% by mass to 30% by mass, 10% by mass to 30% by mass, 12% by mass to 30% by mass, 14% by mass to 30% by mass, 16% by mass to 30% by mass, 18% by mass to 30% by mass, 20% by mass to 30% by mass, 22% by mass to 30% by mass, 23% by mass to 30% by mass, 24% by mass to 30% by mass, and 25% by mass to 30% by mass, or is preferably in a range of 4% by mass to 6% by mass, 4% by mass to 8% by mass, 4% by mass to 10% by mass, is preferably in a range of 4% by mass to 12% by mass, 4% by mass to 14% by mass, 4% by mass to 16% by mass, in a range of 4% by mass to 18% by mass, in a range of 4% by mass to 20% by mass, 4% by mass to 22% by mass, 4% by mass to 23% by mass, 4% by mass to 24% by mass, and 4% by mass to 25% by mass.

Further, the compound represented by General Formula (I) according to the present invention is preferably a compound selected from the compound group represented by General Formula (I-5).

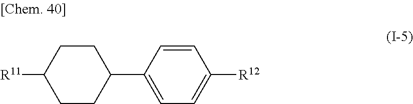

In General Formula (I-5), R¹ and R¹² represent the same meaning as being in General Formula (I).

The compounds that can be combined are not particularly limited; however, the compounds are used in appropriate combination in accordance with the desired performance such as the solubility at low temperature, the transition temperature, the electrical reliability, and the birefringence. The type of the compound to be used is, for example, one type in one embodiment of the present invention. The number of the types thereof is two in another embodiment of the present invention.

In the liquid crystal composition of the present invention, the content of the compound represented by General Formula (I-5) is required to be appropriately adjusted in accordance with desired performance such as the solubility at low temperature, the transition temperature, the electrical reliability, the birefringence, the process adaptability, the drip mark, the burn-in, and the dielectric anisotropy.

A preferable range of the content is as shown in the following table.

With respect to the total content of the liquid crystal composition of the present invention, the content of the compound represented by General Formula (I-5) in one embodiment of the present invention is, for example, in a range of 1 to 30% by mass. Or the above-described content in another embodiment of the present invention is in a range of 1 to 25% by mass. Further, the above-described content in another embodiment of the present invention is in a range of 1 to 20% by mass. Further, the above-described content in another embodiment of the present invention is in a range of 1 to 15% by mass. Further, the above-described content in another embodiment of the present invention is in a range of 1 to 11% by mass. Further, the above-described content in another embodiment of the present invention is in a range of 1 to 8% by mass. Further, the above-described content in another embodiment of the present invention is in a range of 1 to 5% by mass. Further, the above-described content in another embodiment of the present invention is in a range of 1 to 4% by mass. Further, the above-described content in another embodiment of the present invention is in a range of 4 to 11% by mass. Further, the above-described content in another embodiment of the present invention is in a range of 5 to 11% by mass. Further, the above-described content in another embodiment of the present invention is in a range of 8 to 11% by mass. Further, the above-described content in another embodiment of the present invention is in a range of 10 to 11% by mass.

In a case where emphasis is placed on the solubility at low temperature, it is preferable to set the content to be higher; whereas in a case where emphasis is placed on response speed, it is preferable to set the content to be lower. Furthermore, in the case of improving the drip mark or burn-in characteristics, it is preferable to set the content range to a medium level.

Further, the compound represented by General Formula (I-5) is preferably a compound selected from the compound group represented by formula (6.1) to formula (6.6), and is preferably a compound selected from the compound group represented by formula (6.3), formula (6.4), and formula (6.6).

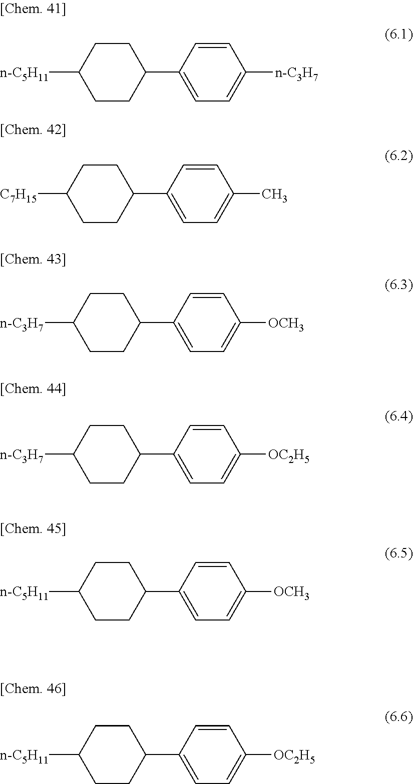

The liquid crystal composition of the invention of the present application can also contain the compounds represented by formula (2.7) and formula (6.8) having a structure similar to the compound represented by General Formula (I-5).

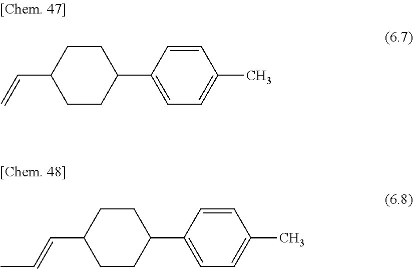

It is preferable to adjust the content of the compound represented by formula (6.7) in accordance with the desired performance such as the solubility at low a temperature, the transition temperature, the electrical reliability, and the birefringence.

Further, the compound represented by General Formula (I) according to the present invention is preferably a compound selected from the compound group represented by General Formula (I-6).

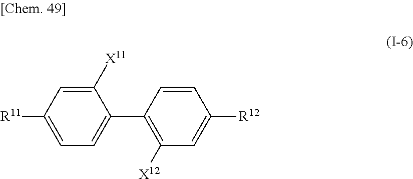

In General Formula (I-6), R¹¹ and R¹² represent the same meaning as being in General Formula (I).

With respect to the total content of the liquid crystal composition of the present invention, the content of the compound represented by General Formula (I-6) is preferably in a range of 2% by mass to 30% by mass, 4% by mass to 30% by mass, 5% by mass to 30% by mass, 6% by mass to 30% by mass, 9% by mass to 30% by mass, 12% by mass to 30% by mass, 14% by mass to 30% by mass, 16% by mass to 30% by mass, 18% by mass to 25% by mass, 20% by mass to 24% by mass, and 22% by mass to 23% by mass.

Further, the compound represented by General Formula (I-6) is preferably a compound represented by formula (7.1).

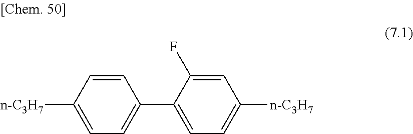

Further, the compound represented by General Formula (I) is preferably a compound selected from the compound group represented by General Formula (I-7).

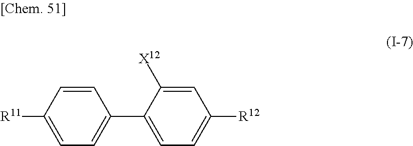

In the formula, R¹¹ and R¹² represent the same meaning as being in in General Formula (I).

With respect to the total content of the liquid crystal composition of the present invention, the content of the compound represented by General Formula (I-7) is preferably in a range of 1% by mass to 20% by mass, in a range of 1% by mass to 15% by mass, in a range of 1% by mass to 10% by mass, and in a range of 1% by mass to 5% by mass.

Further, the compound represented by General Formula (I-7) is preferably a compound represented by formula (8.1).

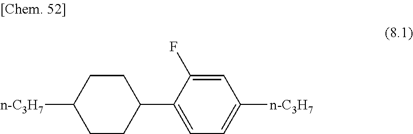

Further, the compound represented by General Formula (I) is preferably a compound selected from the compound group represented by General Formula (I-8).

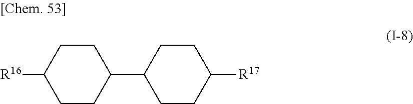

In the formula, R¹⁶ and R¹⁷ each independently represent an alkenyl group having 2 to 5 carbon atoms.

The compounds that can be combined are not particularly limited; however, one to three types of the compounds are preferably used in appropriate combination in accordance with the desired performance such as the solubility at low temperature, the transition temperature, the electrical reliability, and the birefringence. Further, with respect to the total content of the liquid crystal composition of the present invention, the content of the compound represented by General Formula (I-8) is preferably in a range of 1 to 30% by mass, is preferably in a range of 1 to 25% by mass, is preferably in a range of 1 to 20% by mass, is preferably in a range of 1 to 18% by mass, is preferably in a range of 3 to 18% by mass, is preferably in a range of 4 to 9% by mass, is preferably in a range of 4 to 6% by mass, in accordance with the desired performance such as the solubility at low temperature, the transition temperature, the electrical reliability, the birefringence, the process adaptability, the drip mark, the burn-in, and the dielectric anisotropy.

Further, the compound represented by General Formula (I-8) is preferably a compound selected from the compound group represented by formula (9.1) to formula (9.10), and a compound selected from the compound group represented by formula (9.2), formula (9.4), and formula (9.7).

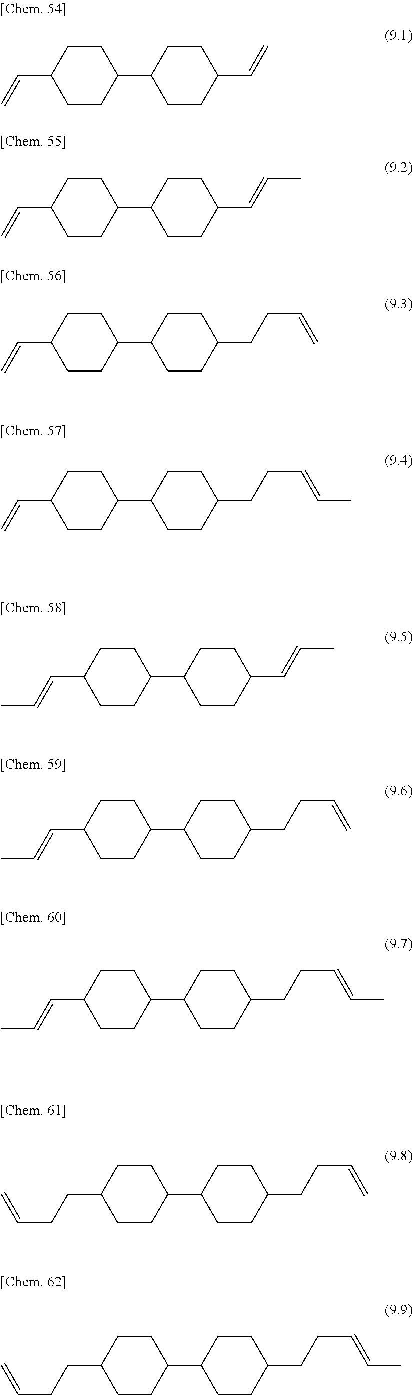

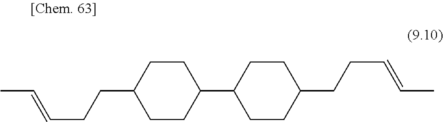

Further, the compound represented by General Formula (I) according to the present invention is, for example, a compound selected from the compounds represented by General Formula (II).

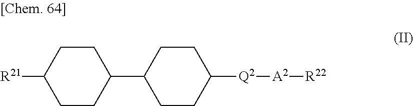

In General Formula (II), R²¹ and R²² each independently represent an alkenyl group having 2 to 5 carbon atoms, an alkyl group having 1 to 5 carbon atoms, or an alkoxy group having 1 to 4 carbon atoms, A² represents a 1,4-cyclohexylene group or a 1,4-phenylene group, and Q² represents a single bond, —COO—, —CH₂—CH₂—, or —CF₂O—.

The compounds that can be combined are not particularly limited; however, the compounds are combined in accordance with the desired performance such as the solubility at low temperature, the transition temperature, the electrical reliability, and the birefringence. The number of the types of the compounds to be used is, for example, one in one embodiment of the present invention. The number of the types thereof is two in another embodiment of the present invention. Further, the number of the types thereof is three in still another embodiment of the present invention. Further, the number of the types thereof is four or more in still another embodiment of the present invention.

In the liquid crystal composition of the present invention, the content of the compound represented by General Formula (II) is required to be appropriately adjusted in accordance with desired performance such as the solubility at low temperature, the transition temperature, the electrical reliability, the birefringence, the process adaptability, the drip mark, the burn-in, and the dielectric anisotropy.

With respect to the total content of the liquid crystal composition of the present invention, the content of the compound represented by General Formula (II) in one embodiment of the present invention is, for example, in a range of 3 to 35% by mass. Or the above-described content in another embodiment of the present invention is in a range of 3 to 30% by mass. Further, the above-described content in another embodiment of the present invention is in a range of 3 to 25% by mass. Further, the above-described content in another embodiment of the present invention is in a range of 3 to 21% by mass. Further, the above-described content in another embodiment of the present invention is in a range of 3 to 20% by mass. Further, the above-described content in another embodiment of the present invention is in a range of 3 to 18% by mass. Further, the above-described content in another embodiment of the present invention is in a range of 3 to 15% by mass. Further, the above-described content in another embodiment of the present invention is in a range of 3 to 12% by mass. Further, the above-described content in another embodiment of the present invention is in a range of 4 to 21% by mass. Further, the above-described content in another embodiment of the present invention is in a range of 11 to 21% embodiment of the present invention is in a range of 13 to 21% by mass. Further, the above-described content in another embodiment of the present invention is in a range of 15 to 21% by mass. Further, the above-described content in another embodiment of the present invention is in a range of 16 to 21% by mass. Further, the above-described content in another embodiment of the present invention is in a range of 4 to 12% by mass. Further, the above-described content in another embodiment of the present invention is in a range of 11 to 20% by mass. Further, the above-described content in another embodiment of the present invention is in a range of 13 to 15% by mass. Further, the above-described content in another embodiment of the present invention is in a range of 15 to 18% by mass.

Further, the compound represented by General Formula (II) is, for example, preferably a compound selected from the compound group represented by General Formula (II-1).

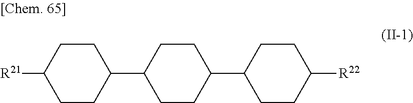

In General Formula (II-1), R²¹ and R²² represent the same meaning as being in General Formula (II).

The content of the compound represented by General Formula (II-1) is preferably adjusted in accordance with the desired performance such as the solubility at low a temperature, the transition temperature, the electrical reliability, and the birefringence.

A preferable range of the content is as shown in the following table.

The content of the compound represented by General Formula (II-1) is preferably adjusted in accordance with the desired performance such as the solubility at low a temperature, the transition temperature, the electrical reliability, and the birefringence, and is preferably in a range of 4% by mass to 24% by mass, and is preferably in a range of 8% by mass to 18% by mass, and is further preferably in a range of 12% by mass to 14% by mass.

Further, the compound represented by General Formula (II-1) is, for example, preferably the compounds represented by formula (10.1) and formula (10.2).

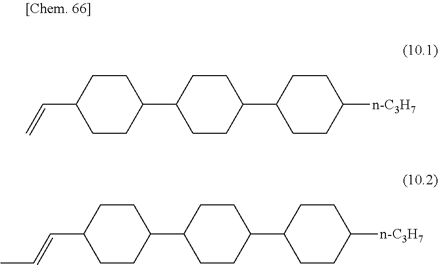

Further, the compound represented by according to the present invention General Formula (II) is, for example, preferably a compound selected from the compound group represented by General Formula (II-2).

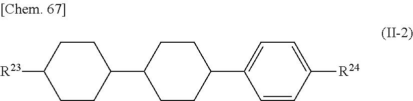

In General Formula (II-2), R²³ represents an alkenyl group having 2 to 5 carbon atoms, and R²⁴ represents an alkyl group having 1 to 5 carbon atoms or an alkoxy group having 1 to 4 carbon atoms.

The compounds that can be combined are not particularly limited; however, the compounds are combined in accordance with the desired performance such as the solubility at low temperature, the transition temperature, the electrical reliability, and the birefringence. When formula (11.1) and formula (11.2) are contained in the liquid crystal composition, it contributes to improving parameters regarding the high-speed responsiveness of the liquid crystal composition. In addition, the number of the types of the compounds to be used is, for example, one in one embodiment of the present invention. The number of the types of the compounds to be used is two or more in another embodiment of the present invention.

In the liquid crystal composition of the present invention, the content of the compound represented by General Formula (II-2) is required to be appropriately adjusted in accordance with desired performance such as the solubility at low temperature, the transition temperature, the electrical reliability, the birefringence, the process adaptability, the drip mark, the burn-in, the high-speed responsiveness, and the dielectric anisotropy.

With respect to the total content of the liquid crystal composition of the present invention, the content of the compound represented by General Formula (II-2) is preferably in a range of 2 to 45% by mass. Among them, for example, the content thereof is in a range of 5 to 45% by mass, 8 to 45% by mass, 11 to 45% by mass, 14 to 45% by mass, 17 to 35% by mass, 17 to 31% by mass, 18 to 28% by mass, 18 to 27% by mass, and 18 to 26% by mass, or the content thereof is preferably in a range of 2 to 45% by mass, 3 to 40% by mass, 4 to 35% by mass, 5 to 30% by mass, 6 to 25% by mass, 7 to 24% by mass, 8 to 23% by mass, and 9 to 23% by mass.

Further, the compound represented by according to the present invention General Formula (II-2) is, for example, preferably the compound represented by formula (11.1) to formula (11.9).

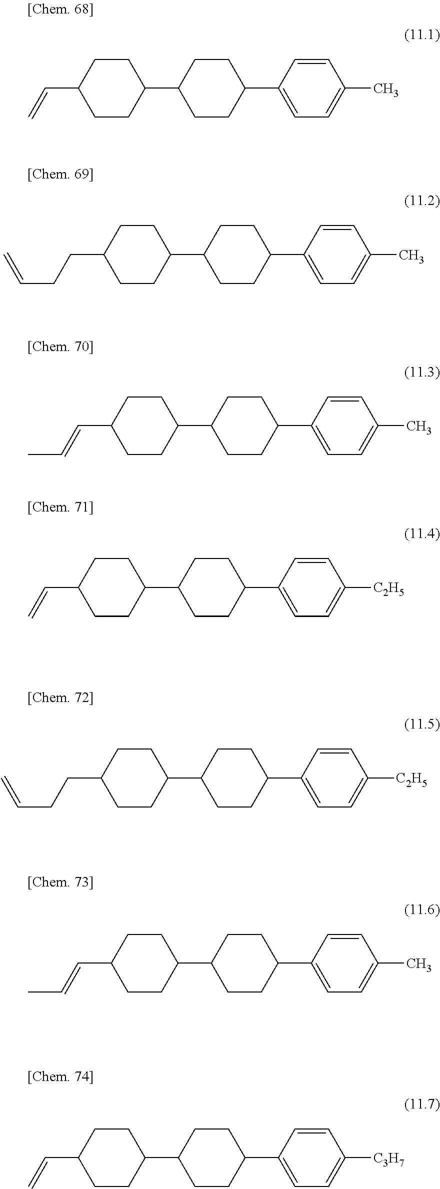

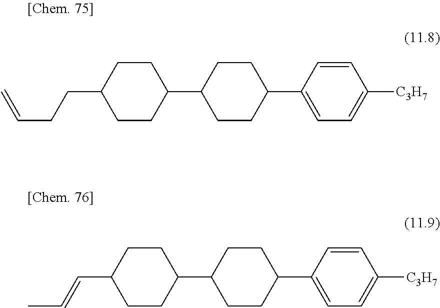

In accordance with desired performance such as the solubility at low temperature, the transition temperature, the electrical reliability, and the birefringence, one of the compounds represented by formulas (11.1) to (11.9) may be contained, or two of the compounds represented by formulas (11.1) to (11.9) may be contained, and three of the compounds represented by formulas (11.1) to (11.9) may be contained. Further, the compound represented by formula (11.1) or the compound represented by formula (11.2) may be contained, or both of the compound represented by formula (11.1) and the compound represented by formula (11.2) may be contained, and all of the compounds represented by formulas (11.1) to (11.3) may be contained. It is further preferable to contain the compounds represented by formula (11.1) and/or formula (11.2), and a preferable range of the content is as shown in the following table.

With respect to the total content of the liquid crystal composition of the present invention, the content of the compound represented by formula (11.1) in the liquid crystal composition of the present invention is preferably in a range of 1% by mass to 55% by mass, is preferably in a range of 2% by mass to 30% by mass, and is preferably in a range of 3% by mass to 25% by mass. Among them, it is preferable that the content thereof is in a range of 4% by mass to 22% by mass, 4% by mass to 20% by mass, 4% by mass to 18% by mass, 5% by mass to 16% by mass, 6% by mass to 15% by mass, 7% by mass to 15% by mass, and 8% by mass to 14% by mass.

With respect to the total content of the liquid crystal composition of the present invention, the content of the compound represented by formula (11.2) in the liquid crystal composition of the present invention is preferably in a range of 1% by mass to 30% by mass, is preferably in a range of 1% by mass to 25% by mass, is preferably in a range of 3% by mass to 25% by mass, is preferably in a range of 4% by mass to 22% by mass, is preferably in a range of 5% by mass to 15% by mass, is preferably in a range of 6% by mass to 14% by mass, is preferably in a range of 7% by mass to 13% by mass, is preferably in a range of 7% by mass to 12% by mass, and is preferably in a range of 7% by mass to 11% by mass.

It is preferable to contain both of the compound represented by formula (11.1) and the compound represented by formula (11.2) in the liquid crystal composition according to the present invention in terms of the compatibility. In a case where both of the compound represented by formula (11.1) and the compound represented by formula (11.2) are contained, the total content both compounds is preferably in a range of 5% by mass to 35% by mass, is preferably in a range of 6% by mass to 30% by mass, and is preferably in a range of 7% by mass to 28% by mass with respect to the total content of the liquid crystal composition of the present invention. Among them, it is preferable that the content thereof is in a range of 8% by mass to 27% by mass, 9% by mass to 28% by mass, and 10% by mass to 25% by mass.

Further, the compound represented by General Formula (II) is, for example, preferably a compound selected from the compound group represented by General Formula (II-3).

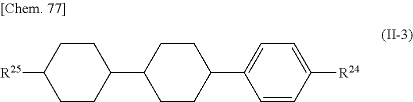

In General Formula (II-3), R²⁵ represents an alkyl group having 1 to 5 carbon atoms, and R²⁴ represents an alkyl group having 1 to 5 carbon atoms or an alkoxy group having 1 to 4 carbon atoms.

The compounds that can be combined are not particularly limited; however, among the compounds, one to three types of compounds are preferably contained in accordance with desired performance such as the solubility at low temperature, the transition temperature, the electrical reliability, and the birefringence.

The content of the compound represented by General Formula (II-3) is required to be appropriately adjusted in accordance with desired performance such as the solubility at low temperature, the transition temperature, the electrical reliability, the birefringence, the process adaptability, the drip mark, the burn-in, and the dielectric anisotropy.

With respect to the total content of the liquid crystal composition of the present invention, the compound represented by General Formula (II-3) is preferably in a range of 2 to 45% by mass. Among them, for example, the content thereof is preferably in a range of 5 to 45% by mass, 8 to 45% by mass, 11 to 45% by mass, 14 to 45% by mass, 17 to 45% by mass, 20 to 45% by mass, 23 to 45% by mass, 26 to 45% by mass, and 29 to 45% by mass, or 2 to 45% by mass, 2 to 40% by mass, 2 to 35% by mass, 2 to 30% by mass, 2 to 25% by mass, 2 to 20% by mass, 2 to 15% by mass, and 2 to 10% by mass.

Further, the compound represented by General Formula (II-3) is, for example, preferably the compound represented by formula (12.1) to formula (12.3).

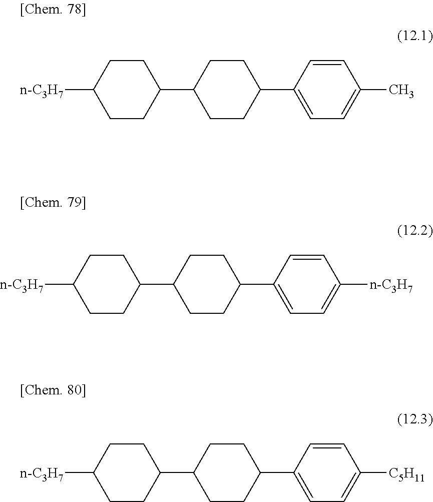

In accordance with desired performance such as the solubility at low temperature, the transition temperature, the electrical reliability, and the birefringence, the compound represented by formula (12.1) may be contained, the compound represented by formula (12.2) may be contained, and both of the compound represented by formula (12.1) and the compound represented by formula (12.2) may be contained. The compound represented by formula (12.3) may be an optically active compound.

Further, the compound represented by General Formula (II-3) according to the present invention is, for example, preferably a compound selected from the compound group represented by General Formula (II-3-1).

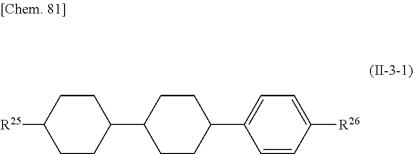

In General Formula (II-3-1), R²⁵ represents an alkyl group having 1 to 5 carbon atoms, and R²⁶ represents an alkoxy group having 1 to 4 carbon atoms.

The content of the compound represented by General Formula (II-3-1) is preferably adjusted in accordance with desired performance such as the solubility at low temperature, the transition temperature, the electrical reliability, and the birefringence so as to be in a range of 1% by mass to 24% by mass, 4% by mass to 18% by mass, and 6% by mass to 14% by mass.

Further, the compound represented by General Formula (II-3-1) is, for example, preferably the compounds represented by formula (13.1) to formula (13.4), and is particularly preferably the compound represented by formula (13.3).

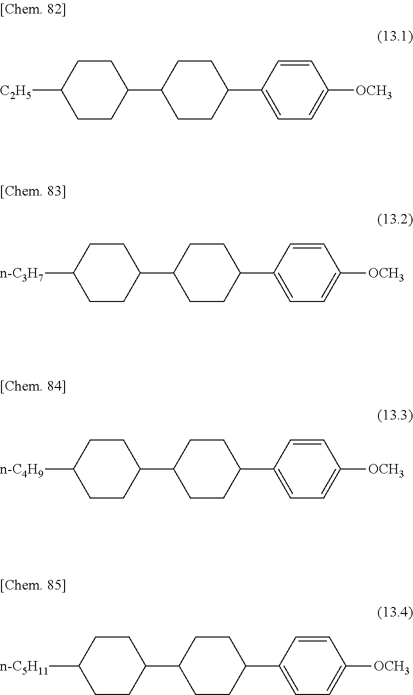

Further, the compound represented by General Formula (II) according to the present invention is, for example, preferably a compound selected from the compound group represented by General Formula (II-4).

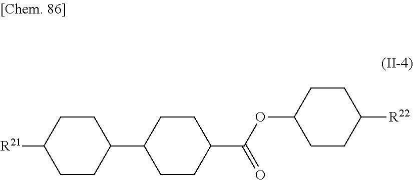

In General Formula (II-4), R²¹ and R²² each independently represent an alkenyl group having 2 to 5 carbon atoms, an alkyl group having 1 to 5 carbon atoms or an alkoxy group having 1 to 4 carbon atoms.

One or two or more types of the above-described compounds may be contained, and it is preferable that the compounds are appropriately combined in accordance with the desired properties. The compounds that can be combined are not particularly limited; however, among the compounds, one or two types of compounds are preferably contained, or one to three types of compounds are further preferably contained in accordance with desired performance such as the solubility at low temperature, the transition temperature, the electrical reliability, and the birefringence.

With respect to the total content of the liquid crystal composition of the present invention, the content of the compound represented by General Formula (II-4) is preferably in a range of 1% by mass to 15% by mass, preferably in a range of 2% by mass to 15% by mass, preferably in a range of 3% by mass to 15% by mass, preferably in a range of 4% by mass to 12% by mass, and preferably in a range of 5% by mass to 7% by mass.

Further, the compound represented by General Formula (II-4) is, for example, preferably the compounds represented by formula (14.1) to formula (14.5), and is particularly preferably the compound represented by formula (14.2) or/and formula (14.5).

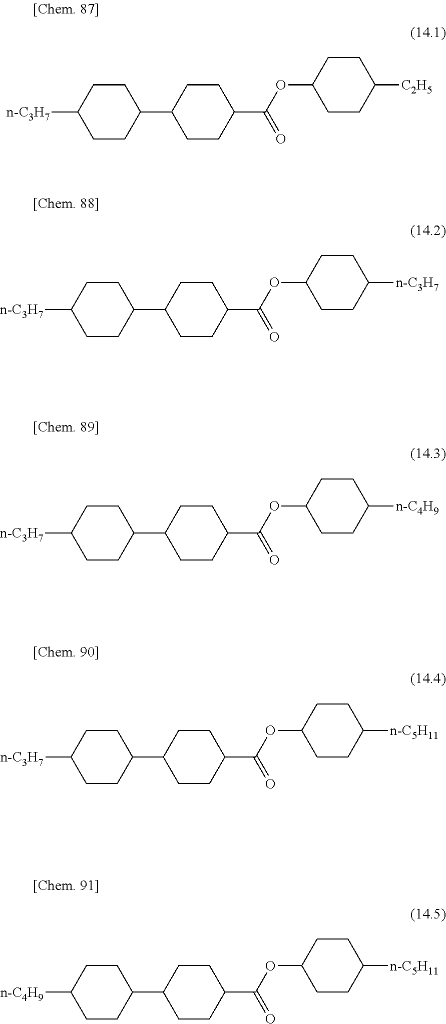

Further, the compound represented by General Formula (I) according to the present invention is preferably a compound selected from the compound group represented by General Formula (III).

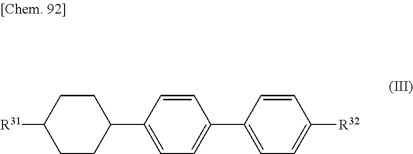

In General Formula (III), R³¹ and R³² each independently represent an alkenyl group having 2 to 5 carbon atoms, or represent an alkyl group having 1 to 5 carbon atoms or an alkoxy group having 1 to 4 carbon atoms.

With respect to the total content of the liquid crystal composition of the present invention, the content of the compound represented by General Formula (III) is preferably in a range of 1% by mass to 25% by mass, is preferably in a range of 2% by mass to 20% by mass, is preferably in a range of 2% by mass to 15% by mass, is preferably in a range of 2% by mass to 10% by mass, is preferably in a range of 4% by mass to 6% by mass in consideration of the required solubility and birefringence.

Further, the compound represented by General Formula (III) is, for example, preferably the compound represented by formula (15.1) or formula (15.2), and is particularly preferably the compound represented by formula (15.1).

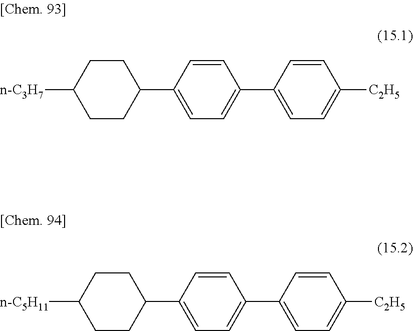

Further, the compound represented by General Formula (III) is preferably a compound selected from the compound group represented by General Formula (III-1).

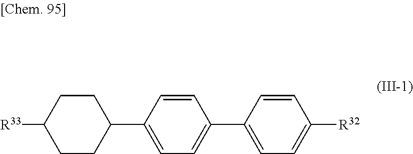

In General Formula (III-1), R³³ represents an alkenyl group having 2 to 5 carbon atoms, R³² each independently represents an alkyl group having 1 to 5 carbon atoms or an alkoxy group having 1 to 4 carbon atoms.

The compound represented by General Formula (III-1) is preferably adjusted in accordance with desired performance such as the solubility at low temperature, the transition temperature, the electrical reliability, and the birefringence. With respect to the total content of the liquid crystal composition of the present invention, the content thereof is preferably in a range of 4% by mass to 23% by mass, 6% by mass to 18% by mass, and 10% by mass to 13% by mass.

The compound represented by General Formula (III-1) is, for example, preferably the compound represented by formula (16.1) or formula (16.2).

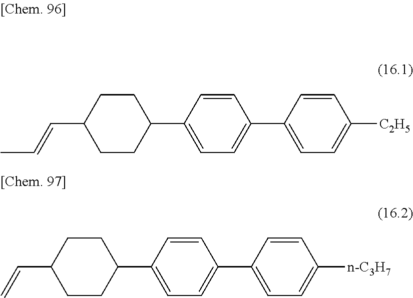

Further, the compound represented by General Formula (III) is preferably a compound selected from the compound group represented by General Formula (III-2).

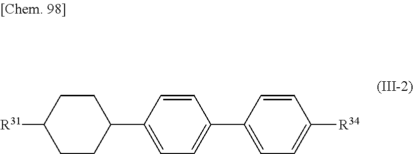

In General Formula (III-2), R³¹ represent the same meaning as being in General Formula (III).

The content of the compound represented by General Formula (III-2) is preferably adjusted in accordance with desired performance such as the solubility at low temperature, the transition temperature, the electrical reliability, and the birefringence, and is preferably in a range of 4% by mass to 23% by mass, is preferably in a range of 6% by mass to 18% by mass, and is preferably in a range of 10% by mass to 13% by mass, with respect to the total content of the liquid crystal composition of the present invention.

Further, the compound represented by General Formula (III-2) is, for example, preferably a compound selected from the compound group represented by formula (17.1) to formula (17.3), and is particularly preferably the compound represented by formula (17.3).

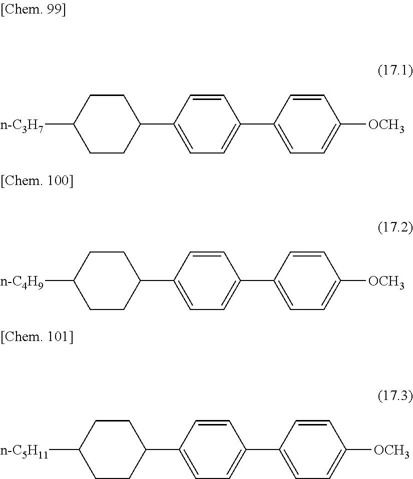

The compound represented by General Formula (I) according to the present invention is preferably selected by the group represented by General Formula (IV).

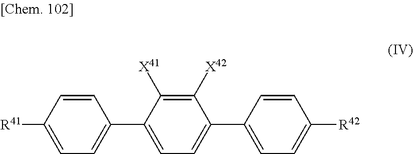

In General Formula (IV), R⁴¹ and R⁴² each independently represent an alkyl group having 1 to 5 carbon atoms, or represents an alkenyl group having 2 to 5 carbon atoms, and X⁴¹ and X⁴² each independently represent a hydrogen atom, or represents a fluorine atom.

The compounds represented by General Formula (IV), which can be combined are not particularly limited; however, the compounds are appropriately combined with each other in accordance with desired performance such as the solubility at low temperature, the transition temperature, the electrical reliability, and the birefringence. When a compound having a structure of General Formula (IV) such as the compounds represented by the following formula (18.1) to formula (18.9) is added to the liquid crystal composition, Δn of the liquid crystal composition and the solubility of the other compositions forming the liquid crystal composition are improved.

The number of the types of the compounds to be used is, for example, one to six in one embodiment of the present invention.

With respect to the total content of the liquid crystal composition of the present invention, the content of the compound represented by General Formula (IV) in one embodiment is, for example, in a range of 1 to 35% by mass. Further, the above-described content in another embodiment of the present invention is in a range of 1 to 30% by mass. Further, the above-described content in another embodiment of the present invention is in a range of 1 to 26% by mass. Further, the above-described content in another embodiment of the present invention is in a range of 1 to 22% by mass. Further, the above-described content in another embodiment of the present invention is in a range of 1 to 10% by mass. Further, the above-described content in another embodiment of the present invention is in a range of 1 to 8% by mass. Further, the above-described content in another embodiment of the present invention is in a range of 1 to 6% by mass. Further, the above-described content in another embodiment of the present invention is in a range of 2 to 26% by mass. Further, the above-described content in another embodiment of the present invention is in a range of 3 to 26% by mass. Further, the above-described content in another embodiment of the present invention is in a range of 11 to 26% by mass. Further, the above-described content in another embodiment of the present invention is in a range of 20 to 26% by mass. Further, the above-described content in another embodiment of the present invention is in a range of 2 to 8% by mass. Further, the above-described content in another embodiment of the present invention is in a range of 2 to 6% by mass. Further, the above-described content in another embodiment of the present invention is in a range of 11 to 22% by mass.

Further, the compound represented by General Formula (IV) is, for example, preferably a compound selected from the compound group represented by General Formula (IV-1).

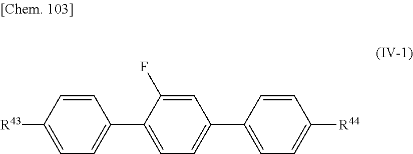

In General Formula (IV), R⁴³ and R⁴⁴ each independently represent an alkyl group having 1 to 5 carbon atoms.

The content of the compound represented by General Formula (IV-1) is required to be appropriately adjusted in accordance with desired performance such as the solubility at low temperature, the transition temperature, the electrical reliability, the birefringence, the process adaptability, the drip mark, the burn-in, and the dielectric anisotropy. Particularly, regarding the liquid crystal display element in the FFS mode, it is confirmed that the problem of the drip mark and alignment unevenness of the p-type liquid crystal composition can be reduced in the liquid crystal composition containing two or more types of General Formula (IV-1).

With respect to the total content of the liquid crystal composition of the present invention, the content of the compound represented by General Formula (IV-1) in one embodiment is, for example, in a range of 1 to 35% by mass. Further, the above-described content in another embodiment of the present invention is in a range of 1 to 30% by mass. Further, the above-described content in another embodiment of the present invention is in a range of 1 to 26% by mass. Further, the above-described content in another embodiment of the present invention is in a range of 1 to 22% by mass. Further, the above-described content in another embodiment of the present invention is in a range of 1 to 10% by mass. Further, the above-described content in another embodiment of the present invention is in a range of 1 to 8% by mass. Further, the above-described content in another embodiment of the present invention is in a range of 1 to 6% by mass. Further, the above-described content in another embodiment of the present invention is in a range of 2 to 26% by mass. Further, the above-described content in another embodiment of the present invention is in a range of 3 to 26% by mass. Further, the above-described content in another embodiment of the present invention is in a range of 11 to 26% by mass. Further, the above-described content in another embodiment of the present invention is in a range of 20 to 26% by mass. Further, the above-described content in another embodiment of the present invention is in a range of 2 to 8% by mass. Further, the above-described content in another embodiment of the present invention is in a range of 2 to 6% by mass. Further, the above-described content in another embodiment of the present invention is in a range of 11 to 22% by mass.

Further, the compound represented by General Formula (IV-1) is, for example, preferably the compounds represented by formula (18.1) to formula (18.9).

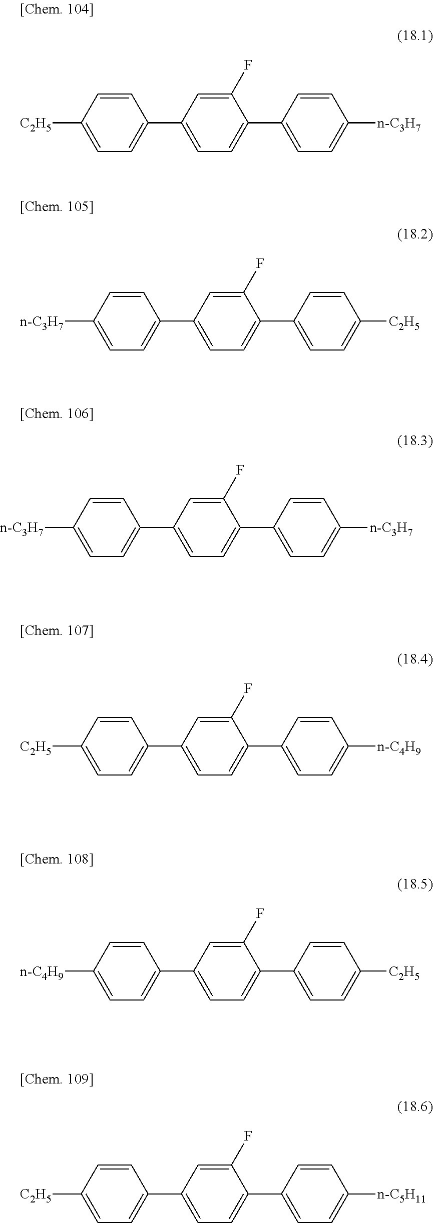

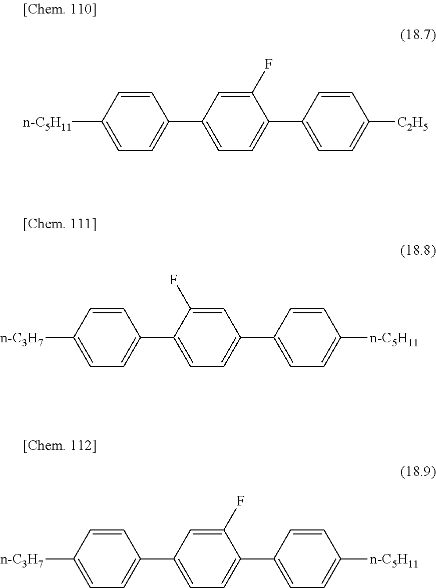

In the compound represented by General Formula (IV-1), the compounds that can be combined are not particularly limited; however, it is preferable to contain one to three types of compounds among the above-described compounds, and it is further preferable to contain one to four types of compounds. In addition, if the molecular weight of the compound selected from the compound group represented by General Formula (IV-1) is widely distributed, it is effective for the solubility, and thus for example, it is preferable that one of the compounds represented by formula (18.1) and formula (18.2), one of the compounds represented by formula (18.4) and formula (18.5), one of the compounds represented by formula (18.6) and formula (18.7), and one of the compounds represented by formula (18.8) and formula (18.9) are selected and are appropriately combined with each other. Among them, it is preferable to contain the compounds represented by formula (18.1), formula (18.3), formula (18.4), formula (18.6), and formula (18.9).

Further, the compound represented by General Formula (IV) is, for example, preferably a compound selected from the compound group represented by General Formula (IV-2).

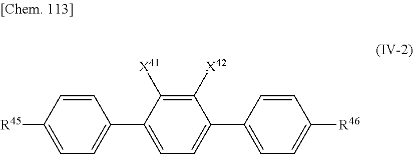

In General Formula (IV-2), R⁴⁵ and R⁴⁶ each independently represent an alkyl group having 1 to 5 carbon atoms, or represents an alkenyl group having 2 to 5 carbon atoms, and at least one of the aforementioned R⁴⁵ and R⁴⁶ represents an alkenyl group having 2 to 5 carbon atoms, and X⁴¹ and X⁴² each independently represent a hydrogen atom or a fluorine atom.

Particularly, regarding the liquid crystal display element in the FFS mode, it is confirmed that the problem of the drip mark and alignment unevenness of the p-type liquid crystal composition can be reduced in the liquid crystal composition containing two or more types of General Formula (IV-1).

The compounds that can be combined are not particularly limited; however, the compounds are combined in accordance with the desired performance such as the solubility at low temperature, the transition temperature, the electrical reliability, and the birefringence.

The content of the compound represented by General Formula (IV-2) is required to be appropriately adjusted in accordance with desired performance such as the solubility at low temperature, the transition temperature, the electrical reliability, the birefringence, the process adaptability, the drip mark, the burn-in, and the dielectric anisotropy. For example, with respect to the total content of the liquid crystal composition of the present invention, the content of the compound represented by General Formula (IV-2) is preferably in a range of 1 to 20% by mass. The content is, for example, further preferably in a range of 1 to 11% by mass, 2 to 11% by mass, 4 to 11% by mass, 1 to 6% by mass, 1 to 4% by mass, and 2 to 6% by mass.

Further, the compound represented by General Formula (IV-2) is, for example, preferably the compounds represented by formula (19.1) to formula (18.8). Among them, the compound represented by formula (19.2) is preferably used.

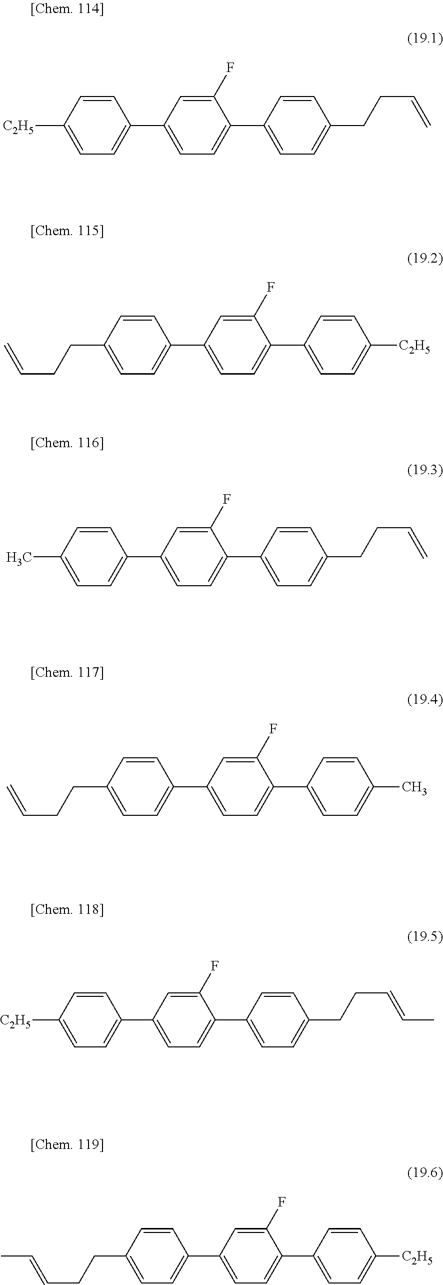

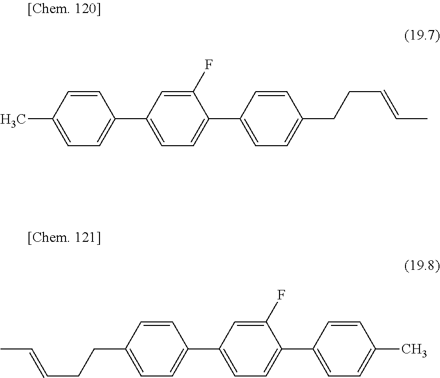

If the molecular weight of the compound selected as the liquid crystal composition is widely distributed, it is effective for the solubility, and thus for example, it is preferable that one of the compounds represented by formula (19.1) and formula (19.2), one of the compounds represented by formula (19.3) and (19.4), one of the compounds represented by formula (19.5) and formula (19.6), one of the compounds represented by formula (19.7) and formula (19.8) are selected and are appropriately combined with each other.

Further, the compound represented by General Formula (I) according to the present invention is preferably a compound selected from the group represented by General Formula (V).

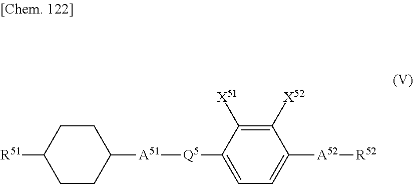

In General Formula (V), R⁵¹ and R⁵² each independently represent an alkyl group having 1 to 5 carbon atoms, an alkenyl group having 2 to 5 carbon atoms, or an alkoxy group having 1 to 4 carbon atoms, A⁵¹ and A⁵² each independently represent a 1,4-cyclohexylene group or a 1,4-phenylene group, Q⁵ represents a single bond or —COO—, and X⁵¹ and X⁵² each independently represent a fluorine atom, or a hydrogen atom.

The compounds that can be combined are not particularly limited; however, the compounds are appropriately combined with each other in accordance with desired performance such as the solubility at low temperature, the transition temperature, the electrical reliability, and the birefringence. The number of the types of the compounds to be used is, for example, one in one embodiment of the present invention. The number of the types thereof is two in another embodiment of the present invention. Further, the number of the types thereof is three in another embodiment of the present invention. Further, the number of the types thereof is four in another embodiment of the present invention.

With respect to the total content of the liquid crystal composition according to the present invention, the content of the compound represented by General Formula (V) in one embodiment is, for example, in a range of 1 to 25% by mass. Further, the above-described content in another embodiment of the present invention is in a range of 1 to 20% by mass. Further, the above-described content in another embodiment of the present invention is in a range of 1 to 19% by mass. Further, the above-described content in another embodiment of the present invention is in a range of 1 to 10% by mass. Further, the above-described content in another embodiment of the present invention is in a range of 1 to 9% by mass. Further, the above-described content in another embodiment of the present invention is in a range of 1 to 8% by mass. Further, the above-described content in another embodiment of the present invention is in a range of 1 to 7% by mass. Further, the above-described content in another embodiment of the present invention is in a range of 1 to 5% by mass. Further, the above-described content in another embodiment of the present invention is in a range of 1 to 3% by mass. Further, the above-described content in another embodiment of the present invention is in a range of 1 to 2% by mass. Further, the above-described content in another embodiment of the present invention is in a range of 2 to 19% by mass. Further, the above-described content in another embodiment of the present invention is in a range of 5 to 19% by mass. Further, the above-described content in another embodiment of the present invention is in a range of 9 to 19% by mass. Further, the above-described content in another embodiment of the present invention is in a range of 2 to 8% by mass. Further, the above-described content in another embodiment of the present invention is in a range of 6 to 8% by mass.

Further, the compound represented by General Formula (V) according to the present invention is preferably a compound represented by General Formula (V-1).

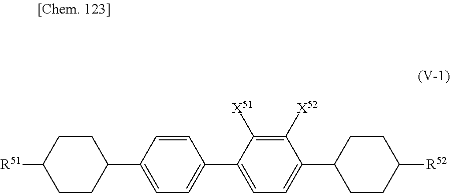

In General Formula (V-1), R⁵¹ and R⁵², and X⁵¹ and X⁵² represent the same meaning as being in General Formula (V).

Further, the compound represented by General Formula (V-1) is preferably a compound represented by General Formula (V-1-1).

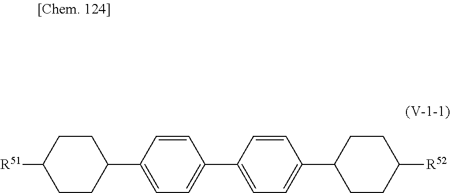

In General Formula (V-1-1), R⁵¹ and R⁵² represent the same meaning as being in General Formula (V).

With respect to the total content of the liquid crystal composition of the present invention, the compound represented by General Formula (V-1-1) is preferably in a range of 1% by mass to 15% by mass, is further preferably in a range of 1% by mass to 10% by mass, is preferably in a range of 3% by mass to 10% by mass, is preferably in a range of 3% by mass to 7% by mass, is preferably in a range of 3% by mass to 5% by mass, and is preferably in a range of 3% by mass to 4% by mass.

Further, the compound represented by General Formula (V-1-1) is preferably compounds represented by formula (20.1) to formula (20.4), and the compound represented by formula (20.2) is preferably used.

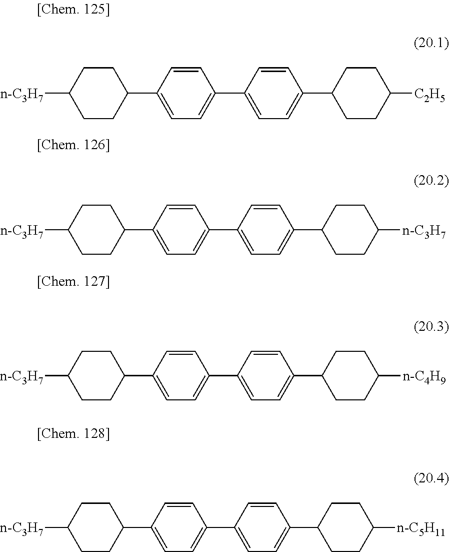

Further, the compound represented by General Formula (V-1) according to the present invention is preferably a compound represented by General Formula (V-1-2).

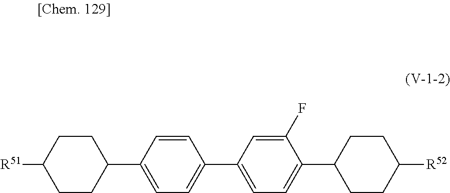

In General Formula (V-1-2), R⁵¹ and R⁵² represent the same meaning as being in General Formula (V).

With respect to the total content of the liquid crystal composition of the present invention, the compound represented by General Formula (V-1-2) is preferably in a range of 1% by mass to 15% by mass, is preferably in a range of 1% by mass to 10% by mass, is preferably in a range of 1% by mass to 7% by mass, and is preferably in a range of 1% by mass to 5% by mass.

Further, the compound represented by General Formula (V-1-2) is preferably compounds represented by formula (21.1) to formula (21.3), and the compound represented by formula (21.1) is preferably used.

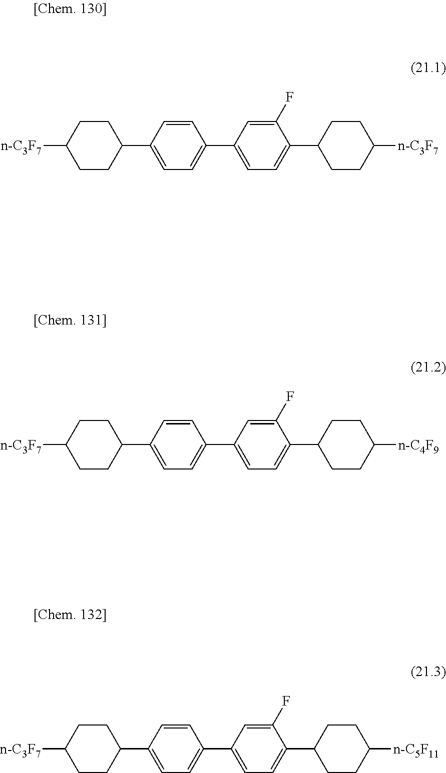

Further, the compound represented by General Formula (V-1) according to the present invention is preferable the compound represented by General Formula (V-1-3).

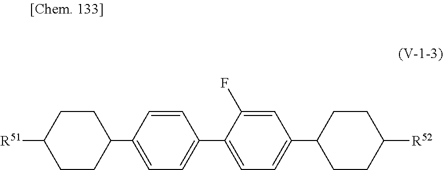

In General Formula (V-1-3), R⁵¹ and R⁵² represent the same meaning as being in General Formula (V).

With respect to the total content of the liquid crystal composition of the present invention, the compound represented by General Formula (V-1-3) is preferably in a range of 1% by mass to 15% by mass, is preferably in a range of 2% by mass to 15% by mass, is preferably in a range of 3% by mass to 10% by mass, and is preferably in a range of 4% by mass to 8% by mass.

Further, the compound represented by General Formula (V-1-3) is the compound represented by formula (22.1) to formula (22.3). The compound represented by formula (22.1) is preferably used.

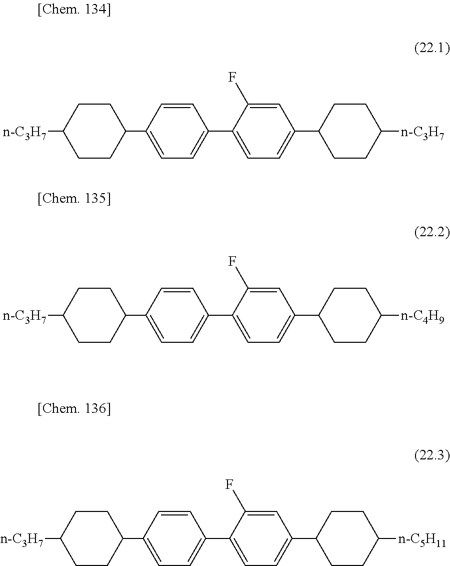

Further, the compound represented by General Formula (V) according to the present invention is preferably a compound represented by General Formula (V-2).

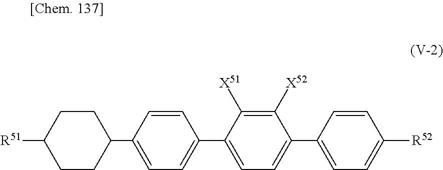

In General Formula (V-2), R⁵¹ and R⁵², and X⁵¹ and X⁵² represent the same meaning as being in General Formula (V).

The compounds that can be combined are not particularly limited; however, the compounds are appropriately combined with each other in accordance with desired performance such as the solubility at low temperature, the transition temperature, the electrical reliability, and the birefringence. The number of the types of the compounds to be used is, for example, one in one embodiment of the present invention. The number of the types of the compounds is two or more in another embodiment of the present invention.

With respect to the total content of the liquid crystal composition of the present invention, the content of the compound represented by General Formula (V-2) in one embodiment is, for example, 1 to 30% by mass. Further, the content of the compound in another embodiment of the present invention is 2 to 25% by mass. Further, the content of the compound in another embodiment of the present invention is 5 to 19% by mass. Further, the content of the compound in another embodiment of the present invention is 6 to 10% by mass. Further, the content of the compound in another embodiment of the present invention is 10 to 19% by mass. Further, the content of the compound in another embodiment of the present invention is 4 to 8% by mass.

In a case where the embodiment in which the T_{NI} of the liquid crystal composition of the present invention is high is desired, the content of the compound represented by formula (V-2) is preferably set to be increased, and in a case where the embodiment in which the low viscosity is desired, the content thereof is preferably set to be decreased.

Further, the compound represented by General Formula (V-2) according to the present invention is preferably a compound represented by General Formula (V-2-1)

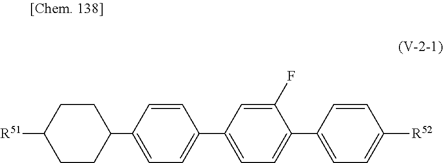

In General Formula (V-2), R⁵¹ and R⁵² represent the same meaning as being in General Formula (V).

Further, the compound represented by General Formula (V-2-1) is preferably compounds represented by formula (23.1) to formula (23.4), and is preferably a compound represented by formula (23.1) or/and formula (23.2).

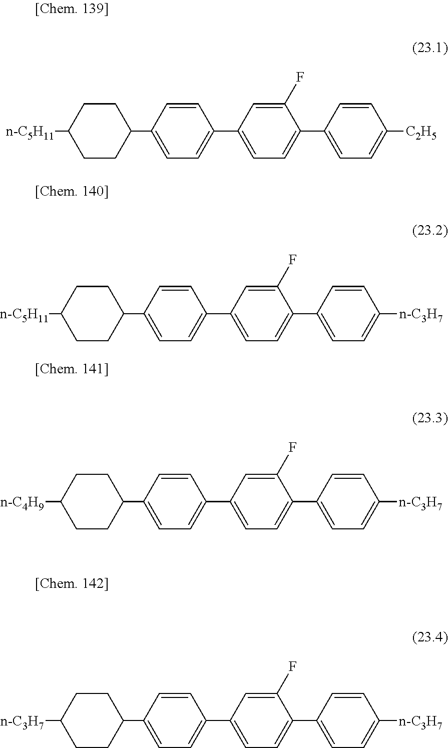

Further, the compound represented by General Formula (V-2) according to the present invention is preferably a compound represented by General Formula (V-2-2).

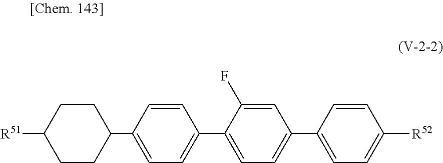

In General Formula (V-2-2), R⁵¹ and R⁵² represent the same meaning as being in General Formula (V).

Further, the compound represented by General Formula (V-2-2) is preferably compounds represented by formula (24.1) to formula (24.4), and is preferably a compound represented by formula (24.1) or/and formula (24.2).

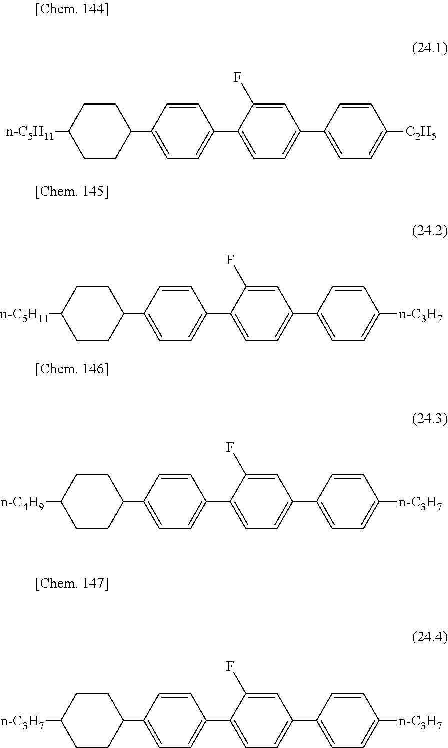

Further, the compound represented by General Formula (V) according to the present invention is preferably a compound represented by General Formula (V-3).

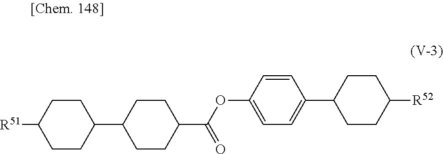

In General Formula (V-3), R⁵¹ and R⁵² represent the same meaning as being in General Formula (V).

The compounds that can be combined are not particularly limited; the compounds are appropriately combined with each other in accordance with desired performance such as the however, solubility at low temperature, the transition temperature, the electrical reliability, and the birefringence. The number of types of the compounds to be used is, for example, one in one embodiment of the present invention. The number of the types thereof is two in another embodiment of the present invention. Further, the number of the types thereof is three or more in another embodiment of the present invention.

With respect to the total content of the liquid crystal composition of the present invention, the compound represented by General Formula (V-3) is preferably in a range of 1% by mass to 16% by mass, is preferably in a range of 1% by mass to 13% by mass, is preferably in a range of 1% by mass to 9% by mass, and is preferably in a range of 3% by mass to 9% by mass.

Further, the compound represented by General Formula (V-3) is preferably compounds represented by formula (25.1) to formula (24.3).

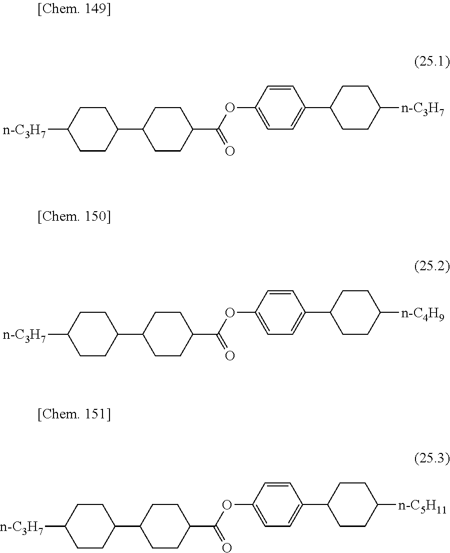

The compound represented by General Formula (V) according to the present invention is preferably a compound represented by General Formula (V-4).

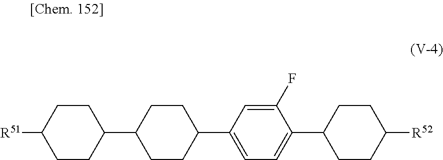

In General Formula (V-4), R⁵¹ and R⁵² each independently represent an alkyl group having 1 to 5 carbon atoms, an alkenyl group having 2 to 5 carbon atoms or an alkoxy group having 1 to 4 carbon atoms.

With respect to the total content of the liquid crystal composition of the present invention, the compound represented by General Formula (V-4) is preferably in a range of 1% by mass to 15% by mass, 2% by mass to 15% by mass, 3% by mass to 10% by mass, and 4% by mass to 8% by mass.

Further, the compound represented by General Formula (V-4) is preferably at least one compound selected from compound group represented by formula (25.11) to formula (25.13), and the compound represented by formula (25.13) is further preferably used.

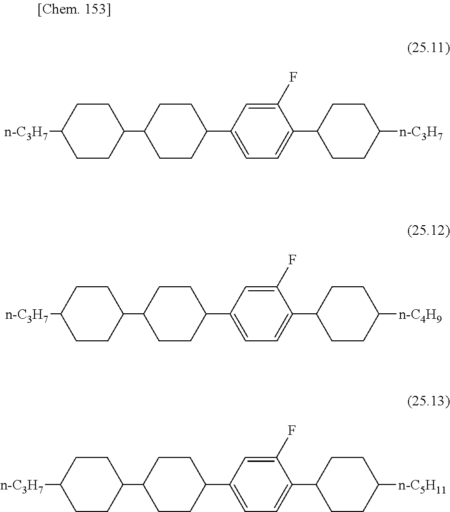

The compound represented by General Formula (I) according to the present invention is preferably a compound represented by General Formula (V′-5).

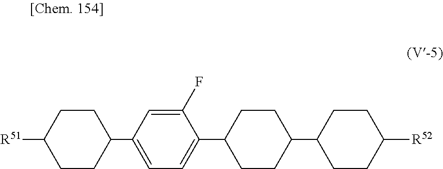

(in General Formula (V′-5), R⁵¹ and R⁵² each independently represent an alkyl group having 1 to 5 carbon atoms, an alkenyl group having 2 to 5 carbon atoms or an alkoxy group having 1 to 4 carbon atoms.

With respect to the total content of the liquid crystal composition of the present invention, the compound represented by General Formula (V′-5) is preferably in a range of 1% by mass to 15% by mass, is preferably in a range of 2% by mass to 15% by mass, is preferably in a range of 2% by mass to 10% by mass, and is preferably in a range of 5% by mass to 10% by mass.

Further, the compound represented by General Formula (V′-5) is preferably at least one compound selected from the compound group represented by formula (25.21) to formula (25.24), and the compound represented by formula (25.21) and/or formula (25.23) is preferably used.

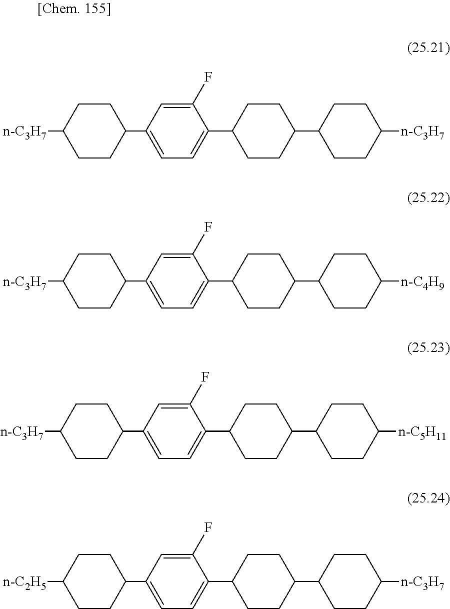

The liquid crystal composition of the present invention preferably contains at least one compound from the group consisting of the compound represented by General Formula (VI) and the compound represented by General Formula (VII). In addition, the compound represented by General Formula (I) according to the present invention is preferably a compound represented by General Formula (VI) and/or is the compound represented by General Formula (VII).

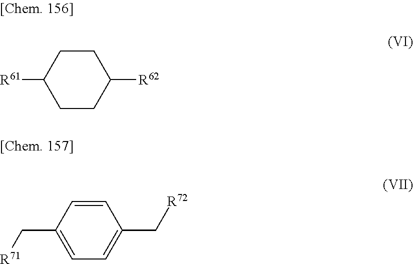

In General Formula (VI) and (VII), R⁶¹, R⁶², R⁷¹ and R⁷² each independently represent a linear alkyl group having 1 to 10 carbon atoms, a linear alkoxy group having 1 to 10 carbon atoms, or a linear alkenyl group having 2 to 10 carbon atoms.

As the compound represented by General Formula (VI), specifically, the following compounds can be suitably used.

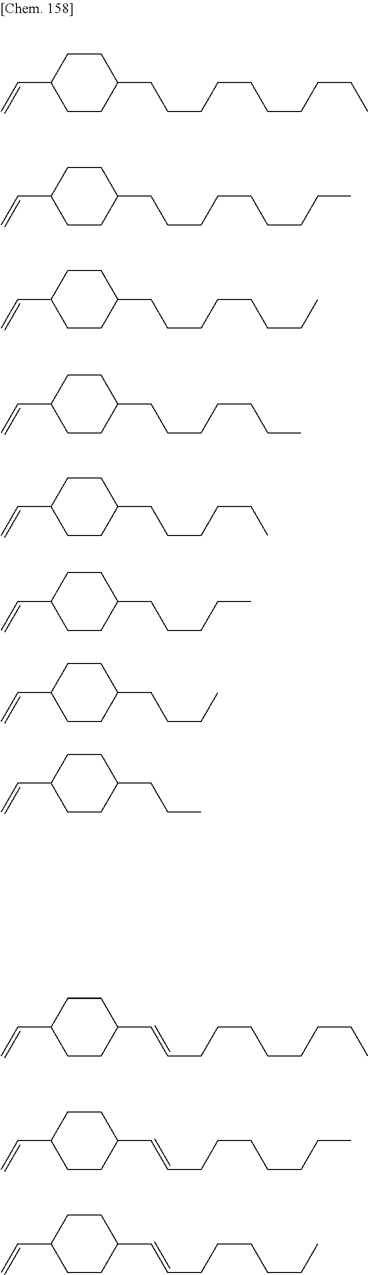

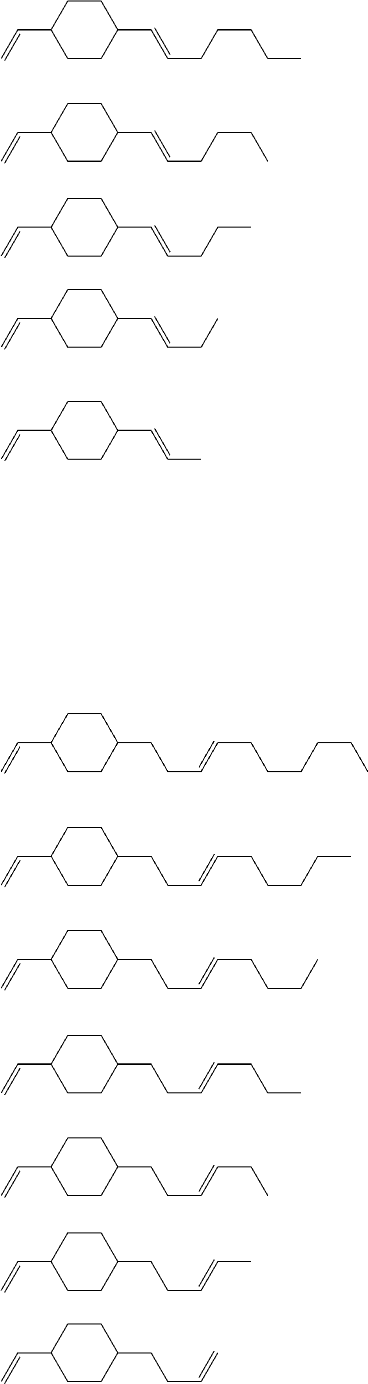

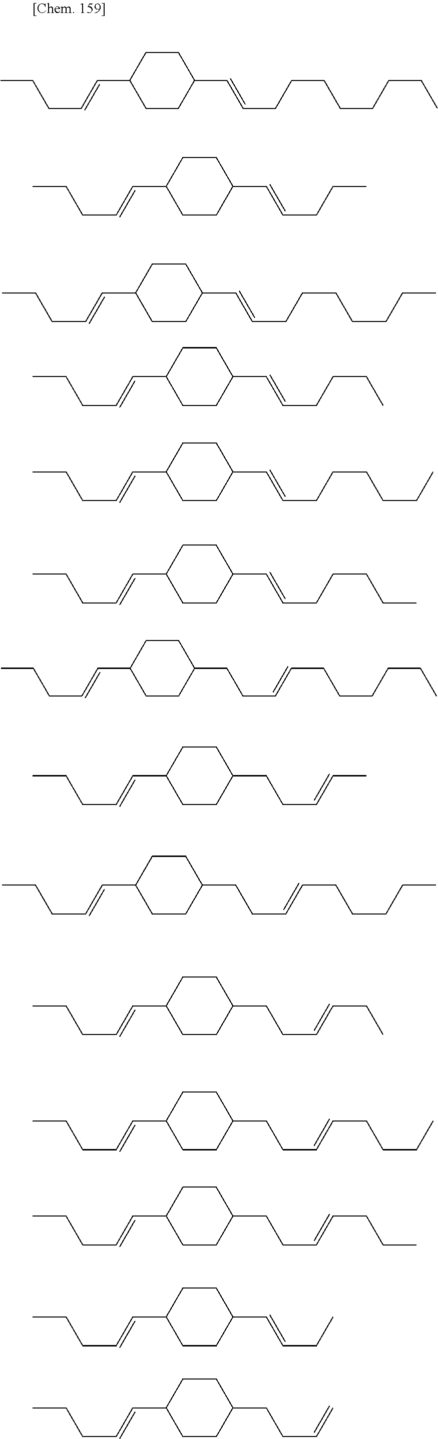

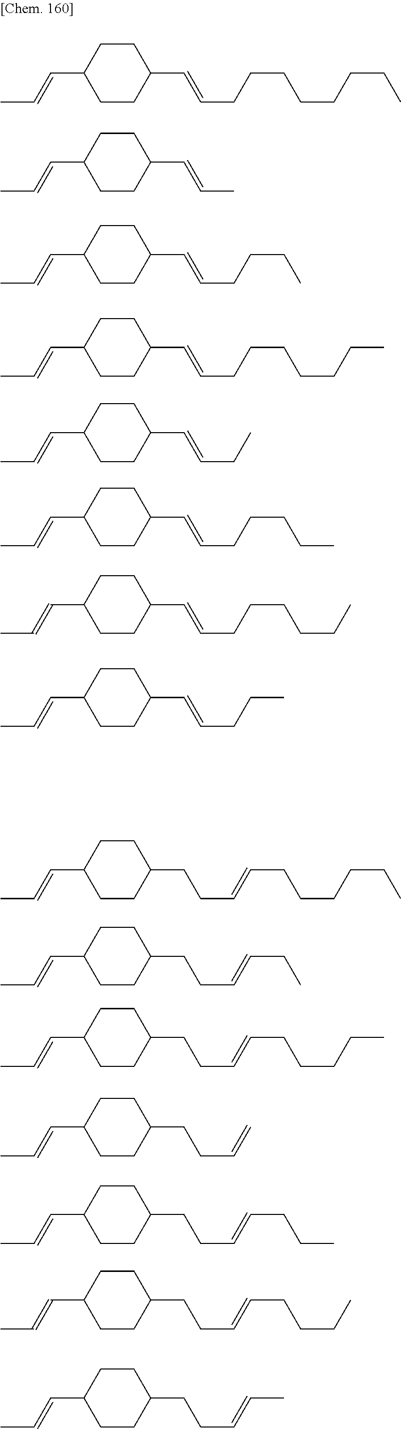

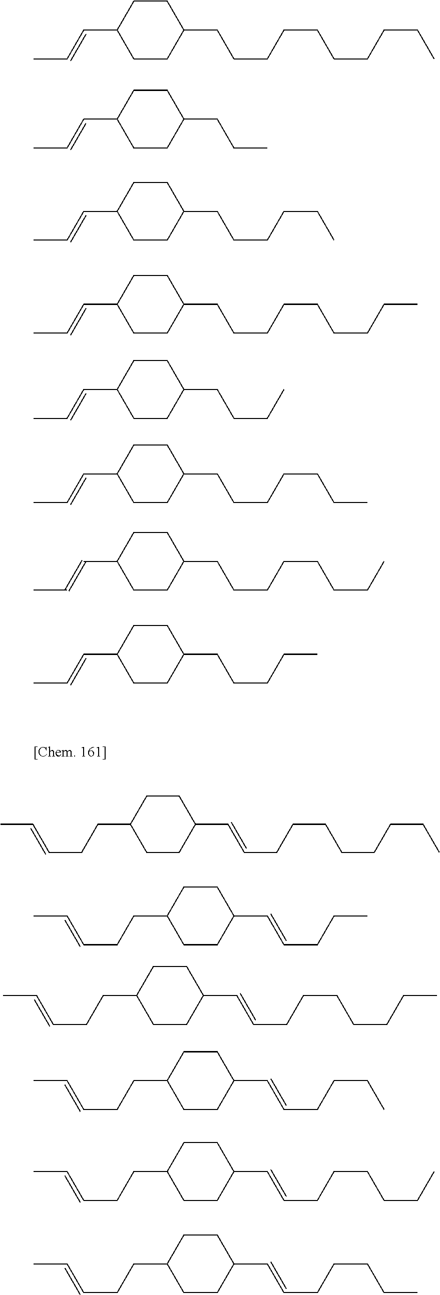

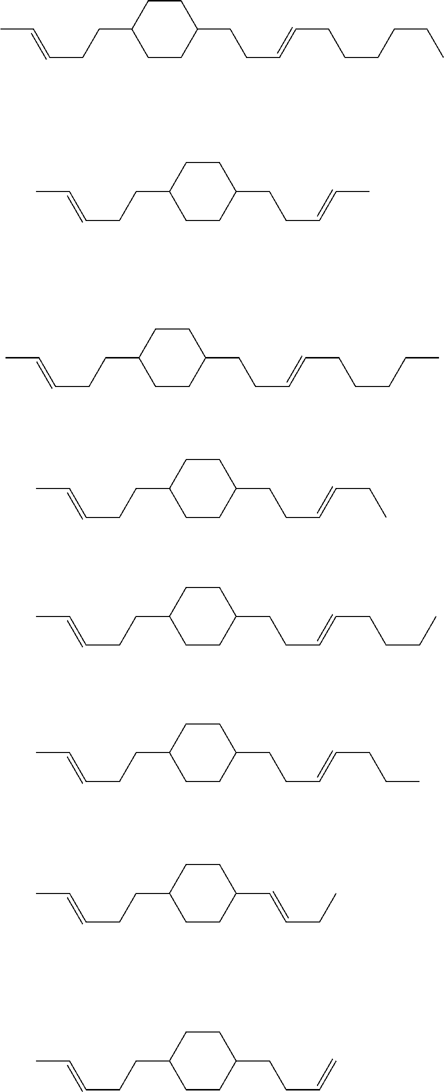

As the compound represented by General Formula (VII), specifically, the following compounds can be suitably used.

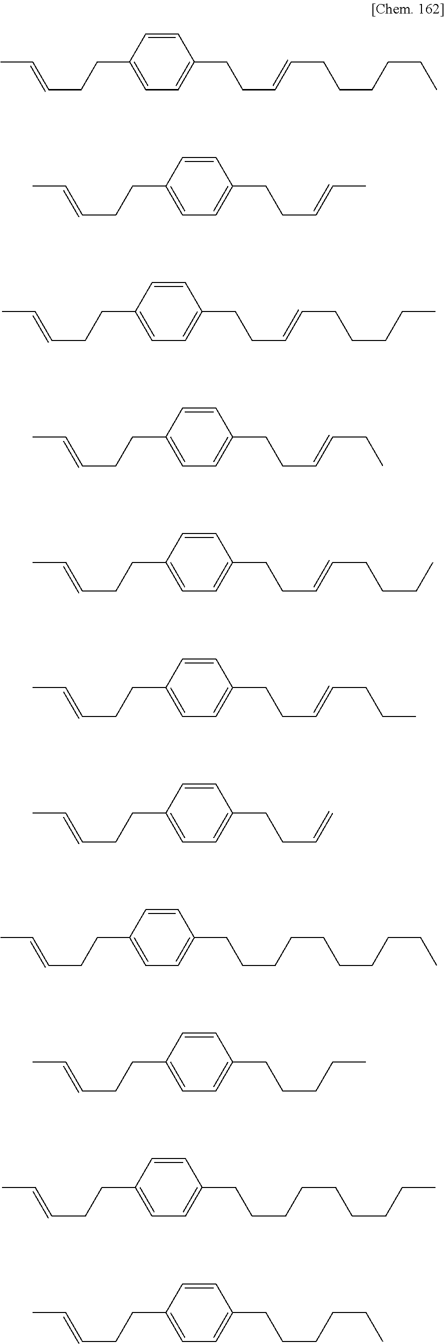

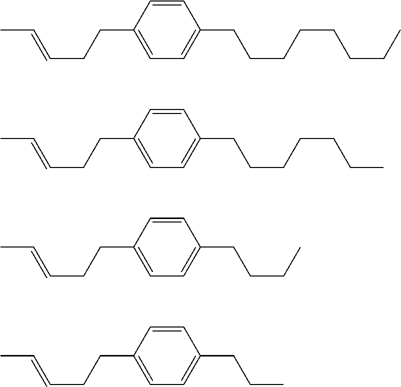

In each of the compounds represented by General Formula (VI) and General Formula (VII), the types of the compounds satisfying the formula, which can be used in combination, is not particularly limited; however, among the compounds satisfying each formula, one to three types of the compounds are preferably used in combination, one to four types of the compounds are further preferably used in combination, and one to five types of the compounds are particularly preferably used in combination in accordance with desired performance such as the solubility at low temperature, the transition temperature, the electrical reliability, and the birefringence.

With respect to the total content of the liquid crystal composition of the present invention, the content of the compound represented by General Formula (VI) is preferably in a range of 0 to 35% by mass, is preferably in a range of 0 to 25% by mass, and is preferably in a range of 0 to 15% by mass.

With respect to the total content of the liquid crystal composition of the present invention, the content of the compound represented by General Formula (VII) is preferably in a range of 0 to 35% by mass, is further preferably in a range of 0 to 25% by mass, and is preferably in a range of 0 to 15% by mass.

The liquid crystal composition according to the present invention contains at least one or more compounds represented by General Formula (M) as a second component. The aforementioned General Formula (M) as the second component is represented by the following chemical structure.

The General Formula (M) according to the present invention is as follows.

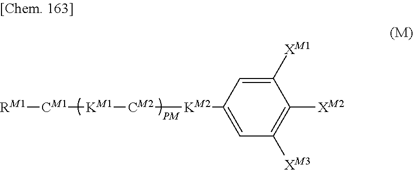

In General Formula (M), R^{M1} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, one or two or more non-adjacent —CH₂— in the alkyl group, the alkenyl group, the alkoxy group, and the alkenyloxy group may be independently substituted with —CH═CH—, —C≡C—, —O—, —CO—, —COO—, or —OCO—,
PM represents 0, 1, 2, 3, or 4,
C^{M1} and CM² each independently represent a group selected from the group consisting of (d) 1,4-cyclohexylene group (one —CH₂— or two or more non-adjacent —CH₂— present in this group may be substituted with —O— or —S—) and (e) 1,4-phenylene group (one —CH═ or two or more non-adjacent —CH═ present in this group may be substituted with —N═), and the group (d) and the group (e) may be independently substituted with a cyano group, a fluorine atom, or a chlorine atom,
K^{M1} and K^{M2} each independently represent a single bond, —CH₂CH₂—, —(CH₂)₄—, —OCH₂—, —CH₂O—, —OCF₂—, —CF₂O—, —COO—, —OCO—, —C≡C—,
in a case where PM is 2, 3, or 4 and plural K^{M1}'s are present, these may be the same as or different from each other, and in a case where PM is 2, 3, or 4 and plural C^{M2}'s are present, these may be the same as or different from each other,
X^{M1} and X^{M3} each independently represent a hydrogen atom, a chlorine atom, or a fluorine atom, and
X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group,
with the proviso that the compounds represented by General Formula (I) are excluded.

The types of the compounds represented by General Formula (M), which can be combined as the second component are not particularly limited; however, the compounds are used in appropriate combination in accordance with the desired performance such as the solubility at low temperature, the transition temperature, the electrical reliability, the dielectric constant, and the birefringence. The number of types of the compounds to be used is, for example, one in one embodiment of the present invention. The number of types of the compounds to be used is two in another embodiment of the present invention. Further, the number of the types thereof is three in another embodiment of the present invention. Further, the number of the types thereof is four in another embodiment of the present invention. Further, the number of the types thereof is five in another embodiment of the present invention. Further, the number of the types thereof is six in another embodiment of the present invention. Further, the number of the types thereof is seven or more in another embodiment of the present invention.

In the liquid crystal composition of the present invention, the content of the compound represented by General Formula (M) is required to be appropriately adjusted in accordance with desired performance such as the solubility at low temperature, the transition temperature, the electrical reliability, the birefringence, the process adaptability, the drip mark, the burn-in, and the dielectric anisotropy.

With respect to the total content of the liquid crystal composition of the present invention, the content of the compound represented by General Formula (M) in one embodiment of the present invention is in a range of 1 to 70% by mass. Further, for example, the content of the compound in another embodiment of the present invention is in a range of 1 to 65% by mass. For example, the above-described content of the compound in still another embodiment of the present invention is in a range of 1 to 60% by mass. For example, the above-described content of the compound in still another embodiment of the present invention is in a range of 1 to 55% by mass. For example, the above-described content of the compound in still another embodiment of the present invention is in a range of 1 to 54% by mass. For example, the above-described content of the compound in still another embodiment of the present invention is in a range of 1 to 51% by mass. For example, the above-described content of the compound in still another embodiment of the present invention is in a range of 1 to 47% by mass. For example, the above-described content of the compound in still another embodiment of the present invention is in a range of 1 to 42% by mass. For example, the above-described content of the compound in still another embodiment of the present invention is in a range of 1 to 40% by mass. For example, the above-described content of the compound in still another embodiment of the present invention is in a range of 1 to 39% by mass. For example, the above-described content of the compound in still another embodiment of the present invention is in a range of 1 to 37% by mass. For example, the above-described content of the compound in still another embodiment of the present invention is in a range of 1 to 35% by mass. For example, the above-described content of the compound in still another embodiment of the present invention is in a range of 1 to 33% by mass. For example, the above-described content of the compound in still another embodiment of the present invention is in a range of 1 to 32% by mass. For example, the above-described content of the compound in still another embodiment of the present invention is in a range of 1 to 31% by mass. For example, the above-described content of the compound in still another embodiment of the present invention is in a range of 1 to 30% by mass. For example, the above-described content of the compound in still another embodiment of the present invention is in a range of 1 to 29% by mass. For example, the above-described content of the compound in still another embodiment of the present invention is in a range of 1 to 25% by mass. For example, the above-described content of the compound in still another embodiment of the present invention is in a range of 1 to 24% by mass. For example, the above-described content of the compound in still another embodiment of the present invention is in a range of 1 to 20% by mass. For example, the above-described content of the compound in still another embodiment of the present invention is in a range of 1 to 19% by mass. For example, the above-described content of the compound in still another embodiment of the present invention is in a range of 1 to 10% by mass. For example, the above-described content of the compound in still another embodiment of the present invention is in a range of 1 to 9% by mass. For example, the above-described content of the compound in still another embodiment of the present invention is in a range of 1 to 8% by mass. For example, the above-described content of the compound in still another embodiment of the present invention is in a range of 3 to 54% by mass. For example, the above-described content of the compound in still another embodiment of the present invention is in a range of 9 to 54% by mass. For example, the above-described content of the compound in still another embodiment of the present invention is in a range of 19 to 54% by mass. For example, the above-described content of the compound in still another embodiment of the present invention is in a range of 20 to 54% by mass. For example, the above-described content of the compound in still another embodiment of the present invention is in a range of 22 to 54% by mass. For example, the above-described content of the compound in still another embodiment of the present invention is in a range of 26 to 54% by mass. For example, the above-described content of the compound in still another embodiment of the present invention is in a range of 28 to 54% by mass. For example, the above-described content of the compound in still another embodiment of the present invention is in a range of 29 to 54% by mass. For example, the above-described content of the compound in still another embodiment of the present invention is in a range of 30 to 54% by mass. For example, the above-described content of the compound in still another embodiment of the present invention is in a range of 31 to 54% by mass. For example, the above-described content of the compound in still another embodiment of the present invention is in a range of 32 to 54% by mass. For example, the above-described content of the compound in still another embodiment of the present invention is in a range of 33 to 54% by mass. For example, the above-described content of the compound in still another embodiment of the present invention is in a range of 39 to 54% by mass. For example, the above-described content of the compound in still another embodiment of the present invention is in a range of 42 to 54% by mass. For example, the above-described content of the compound in still another embodiment of the present invention is in a range of 46 to 54% by mass. For example, the above-described content of the compound in still another embodiment of the present invention is in a range of 48 to 54% by mass. For example, the above-described content of the compound in still another embodiment of the present invention is in a range of 52 to 54% by mass. For example, the above-described content of the compound in still another embodiment of the present invention is in a range of 3 to 8% by mass. For example, the above-described content of the compound in still another embodiment of the present invention is in a range of 9 to 10% by mass. For example, the above-described content of the compound in still another embodiment of the present invention is in a range of 19 to 25% by mass. For example, the above-described content of the compound in still another embodiment of the present invention is in a range of 22 to 24% by mass. For example, the above-described content of the compound in still another embodiment of the present invention is in a range of 26 to 29% by mass. For example, the above-described content of the compound in still another embodiment of the present invention is in a range of 28 to 35% by mass. For example, the above-described content of the compound in still another embodiment of the present invention is in a range of 28 to 33% by mass. For example, the above-described content of the compound in still another embodiment of the present invention is in a range of 31 to 32% by mass. For example, the above-described content of the compound in still another embodiment of the present invention is in a range of 32 to 33% by mass. For example, the above-described content of the compound in still another embodiment of the present invention is in a range of 33 to 42% by mass. For example, the above-described content of the compound in still another embodiment of the present invention is in a range of 39 to 42% by mass. For example, the above-described content of the compound in still another embodiment of the present invention is in a range of 42 to 47% by mass. For example, the above-described content of the compound in still another embodiment of the present invention is in a range of 48 to 51% by mass.

In a case where a liquid crystal composition having a fast response speed while keeping the viscosity of the liquid crystal composition of the present invention to be low is required, it is preferable that the lower limit is set to be low and the upper limit is set to be low. Further, in a case where the liquid crystal composition having good temperature stability while keeping the T_{NI} of the liquid crystal composition of the present invention to be high is required, it is preferable that the lower limit is set to be low and the upper limit is set to be low. Further, when the dielectric anisotropy is set to be large so as to keep the driving voltage to be low, it is preferable that the lower limit is set to be high and the upper limit is set to be high.

In a case where the ring structure to which R^{M1} is bonded is a phenyl group (aromatic group), a linear alkyl group having 1 to 5 carbon atoms, a linear alkoxy group having 1 to 4 carbon atoms, and an alkenyl group having 4 to 5 carbon atoms are preferable, and in a case where the ring structure to which R^{M1} is bonded is saturated, such as cyclohexane, pyran, and dioxane, a linear alkyl group having 1 to 5 carbon atoms, a linear alkoxy group having 1 to 4 carbon atoms, and a linear alkenyl group having 2 to 5 carbon atoms are preferable.

In a case where the chemical stability of the liquid crystal composition is required, the compound represented by General Formula (M) according to the present invention is preferable not to have a chlorine atom in the molecule. Further, the compound having a chlorine atom in the liquid crystal composition is preferably equal to or less than 5%, equal to or less than 3%, equal to or less than 1%, equal to or less than 0.5%, and is preferably not substantially contained. The meaning of “substantially not contained” is that only a compound unintentionally having a chlorine atom, such as a compound or the like produced as impurities at the time of producing the intended compound is mixed into the liquid crystal composition.

The compound represented by General Formula (M) according to the present invention is preferably a compound represented by the following General Formula (B).

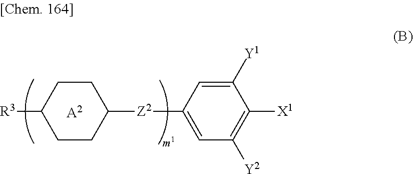

In General Formula (B), R³ represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively, A² each independently represents, a 1,4-cyclohexylene cyclohexylene group, a 1,4-phenylene group, a tetrahydropyran-2,5-diyl group, a dioxane-2,5-diyl group, or a pyrimidine-2,5-diyl group, and in a case where A¹ represents the 1,4-phenylene group, one or more hydrogen atom in the 1,4-phenylene groups may be substituted with a fluorine atom, Z² each independently represents a single bond, —OCH₂—, —OCF₂—, —CH₂O—, or —CF₂O—, Y; and Y² each independently represent, a fluorine atom, or a hydrogen atom, X¹ represents a fluorine atom, a —CN group, or a —OCF₃ group, and m¹ represents 1, 2, 3, or 4.

In addition, in the compound represented by General Formula (B) according to the present invention, m¹ is preferably 2 or 3. When m¹ is 2, the compound has the properties having lower driving voltage. In addition, when m¹ is 3, the compound has the properties having higher transition temperature.

The compound represented by General Formula (M) according to the present invention is preferably a compound represented by General Formula (X).

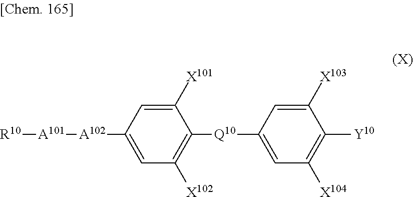

In General Formula (X), X¹⁰¹ to X¹⁰⁴ each independently represent a fluorine atom or a hydrogen atom, Y¹⁰ represents a fluorine atom, a chlorine atom, and —OCF₃, Q¹⁰ represents a single bond or —CF₂O—, R¹⁰ represents an alkyl group having 1 to 5 carbon atoms, an alkenyl group having 2 to 5 carbon atoms, or an alkoxy group having 1 to 4 carbon atoms, and A¹⁰¹ and A¹⁰² each independently represent a 1,4-cyclohexylene group, a 1,4-phenylene group, or the groups represented by the following formulas.

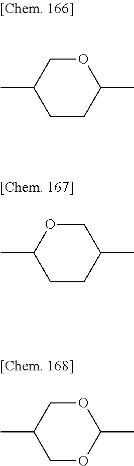

However, a hydrogen atom on the 1,4-phenylene group may be substituted with a fluorine atom.

The compounds represented by General Formula (X) which can be used in combination is not particularly limited; however, the compounds are appropriately combined with each other in consideration of the solubility at low temperature, the transition temperature, the electrical reliability, and the birefringence. For example, the number of the types of the compound is one in one embodiment of the present invention. Further, the number of the types of the compound is two in another embodiment of the present invention. Further the number of the types of the compound is three in another embodiment of the present invention. Further, the number of the types of the compound is four in still another embodiment of the present invention. Further, the number of the types of the compound is five or more in still another embodiment of the present invention.

The content of the compound represented by General Formula (X) is appropriately adjusted for each embodiment in consideration of the properties such as the solubility at low temperature, the transition temperature, the electrical reliability, and the birefringence. For example, with respect to the total content of the liquid crystal composition of the present invention, the content of the compound represented by General Formula (X) in one embodiment of the present invention is in a range of 1 to 35% by mass, the above-described content of the compound in another embodiment of the present invention is in a range of 1 to 30% by mass, the above-described content of the compound in still another embodiment of the present invention is in a range of 1 to 25% by mass, the above-described content of the compound in still another embodiment is in a range of 1 to 24% by mass, the above-described content of the compound in still another embodiment is in a range of 1 to 20% by mass, the above-described content of the compound in still another embodiment is in a range of 1 to 19% by mass, the above-described content of the compound in still another embodiment is in a range of 1 to 16% by mass, the above-described content of the compound in still another embodiment is in a range of 1 to 12% by mass, the above-described content of the compound in still another embodiment is in a range of 1 to 11% by mass, the above-described content of the compound in still another embodiment is in a range of 1 to 10% by mass, the above-described content of the compound in still another embodiment is in a range of 1 to 9% by mass, the above-described content of the compound in still another embodiment is in a range of 1 to 8% by mass, the above-described content of the compound in still another embodiment is in a range of 1 to 7% by mass, the above-described content of the compound in still another embodiment is in a range of 1 to 3% by mass, the above-described content of the compound in still another embodiment is in a range of 3 to 24% by mass, the above-described content of the compound in still another embodiment is in a range of 5 to 24% by mass, the above-described content of the compound in still another embodiment is in a range of 6 to 24% by mass, the above-described content of the compound in still another embodiment is in a range of 8 to 24% by mass, the above-described content of the compound in still another embodiment is in a range of 11 to 24% by mass, the above-described content of the compound in still another embodiment is in a range of 13 to 24% by mass, the above-described content of the compound in still another embodiment is in a range of 15 to 24% by mass, the above-described content of the compound in still another embodiment is in a range of 17 to 24% by mass, the above-described content of the compound in still another embodiment is in a range of 3 to 7% by mass, the above-described content of the compound in still another embodiment is in a range of 5 to 10% by mass, the above-described content of the compound in still another embodiment is in a range of 6 to 9% by mass, the above-described content of the compound in still another embodiment is in a range of 6 to 8% by mass, the above-described content of the compound in still another embodiment is in a range of 8 to 11% by mass, the above-described content of the compound in still another embodiment is in a range of 11 to 19% by mass, the above-described content of the compound in still another embodiment is in a range of 11 to 12% by mass, the above-described content of the compound in still another embodiment is in a range of 13 to 16% by mass, the above-described content of the compound in still another embodiment is in a range of 15 to 19% by mass, and the above-described content of the compound in still another embodiment is in a range of 17 to 20% by mass.

In a case where a liquid crystal composition having a fast response speed while keeping the viscosity of the liquid crystal composition of the present invention to be low is required, it is preferable that the lower limit is set to be low and the upper limit is set to be low. Further, in a case where the liquid crystal composition in which the burn-in is hard to occur is required, it is preferable that the lower limit is set to be low and the upper limit is set to be low. In addition, when the dielectric anisotropy is set to be large so as to keep the driving voltage to be low, it is preferable that the lower limit is set to be high and the upper limit is set to be high.

The compound represented by General Formula (M) according to the present invention is preferably a compound represented by General Formula (X-1).

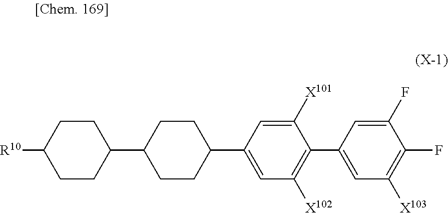

In General Formula (X-1), X¹⁰¹ to X¹⁰³, and R¹⁰ represent the same meaning as being in General Formula (X).

The compounds that can be combined are not particularly limited; however, the compounds are appropriately combined with each other for each embodiment in consideration of the solubility at low temperature, the transition temperature, the electrical reliability, and the birefringence. For example, the number of the types of the compound is one in one embodiment of the present invention. Further, the number of the types of the compound is two in another embodiment of the present invention. Further, the number of the types of the compound is three in another embodiment of the present invention. Further, the number of the types of the compound is four in still another embodiment of the present invention. Further, the number of the types of the compound is five or more in still another embodiment of the present invention.

The content of the compound represented by General Formula (X-1) is appropriately adjusted in consideration of the properties such as the solubility at low temperature, the transition temperature, the electrical reliability, and the birefringence.

For example, with respect to the total content of the liquid crystal composition of the present invention, the content of the compound represented by General Formula (X-1) in one embodiment of the present invention is 1 to 20% by mass, the above-described content of the compound in another embodiment of the present invention is in a range of 1 to 15% by mass, the above-described content of the compound in still another embodiment of the present invention is in a range of 1 to 10% by mass, the above-described content of the compound in still another embodiment is in a range of 1 to 9% by mass, the above-described content of the compound in still another embodiment is in a range of 1 to 8% by mass, the above-described content of the compound in still another embodiment is in a range of 1 to 7% by mass, the above-described content of the compound in still another embodiment is in a range of 1 to 6% by mass, the above-described content of the compound in still another embodiment is in a range of 1 to 3% by mass, the above-described content of the compound in still another embodiment is in a range of 3 to 9% by mass, the above-described content of the compound in still another embodiment is in a range of 4 to 9% by mass, the above-described content of the compound in still another embodiment is in a range of 5 to 9% by mass, the above-described content of the compound in still another embodiment is in a range of 6 to 9% by mass, the above-described content of the compound in still another embodiment is in a range of 8 to 9% by mass, the above-described content of the compound in still another embodiment is in a range of 3 to 7% by mass, the above-described content of the compound in still another embodiment is in a range of 5 to 7% by mass, and the above-described content of the compound in still another embodiment is in a range of 6 to 7% by mass.

Further, the compound represented by General Formula (X-1) according to the present invention is preferably a compound represented by General Formula (X-1-1).

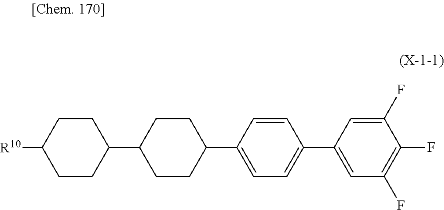

In General Formula (X-1-1), R¹⁰ represent the same meaning as being in General Formula (X).

The content of the compound represented by General Formula (X-1-1) is appropriately adjusted in consideration of the properties such as the solubility at low temperature, the transition temperature, the electrical reliability, and the birefringence.

With respect to the total content of the liquid crystal composition of the present invention, the content of the compound represented by General Formula (X-1-1) in one embodiment of the present invention is in a range of 1 to 25% by mass, the above-described content of the compound in another embodiment of the present invention is in a range of 1 to 20% by mass, the above-described content of the compound in still another embodiment of the present invention is in a range of 1 to 15% by mass, the above-described content of the compound in still another embodiment is in a range of 1 to 10% by mass, the above-described content of the compound in still another embodiment is in a range of 3 to 10% by mass, and the above-described content of the compound in still another embodiment is in a range of 5 to 10% by mass.

Further, the compound represented by General Formula (X-1-1) which is used in the liquid crystal composition of the present invention is preferably compounds specifically represented by formula (36.1) to formula (36.4), and among them, the compound represented by formula (36.1) and/or formula (36.2) is preferably contained.

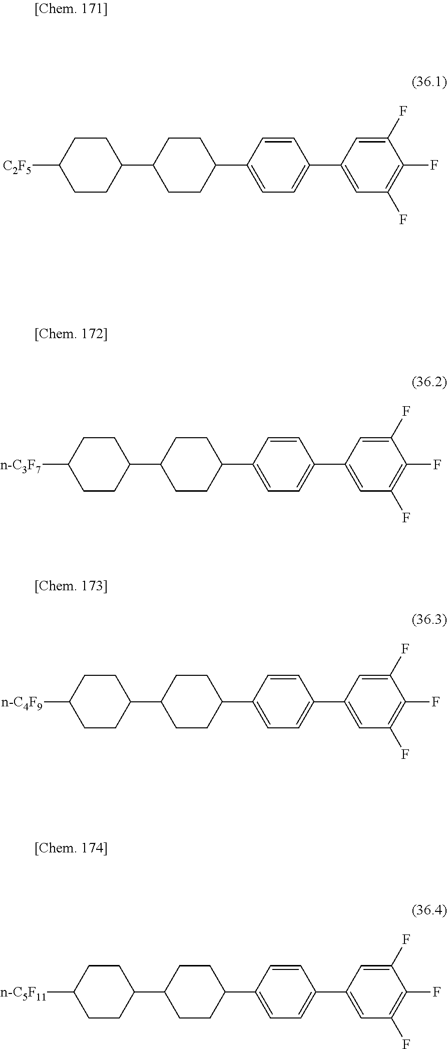

Further, the compound represented by General Formula (X-1) which is used in the liquid crystal composition of the present invention is preferably a compound represented by General Formula (X-1-2).

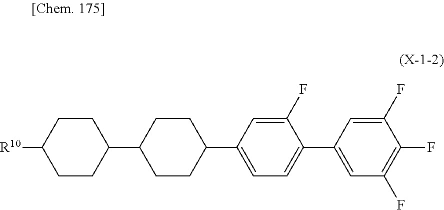

In General Formula (X-1-2), R¹⁰ represents an alkyl group having 1 to 5 carbon atoms, an alkenyl group having 2 to 5 carbon atoms, or an alkoxy group having 1 to 4 carbon atoms.

With respect to the total content of the liquid crystal compositions of the present invention, the content of the compound represented by General Formula (X-1-2) is preferably equal to or greater than 1% by mass, equal to or greater than 2% by mass, and is further preferably equal to or greater than 6% by mass. In addition, the maximum ratio is preferably set to be equal to or less than 20% by mass, is further preferably equal to or less than 16% by mass, is still further preferably equal to or less than 12% by mass, is particularly preferably equal to or less than 10% by mass in consideration of the solubility at low temperature, the transition temperature, the electrical reliability, and the like.

Further, the compound represented by General Formula (X-1-2) is preferably compounds specifically represented by formula (37.1) to formula (37.4), and among them, the compound represented by formula (37.2) is preferably contained.

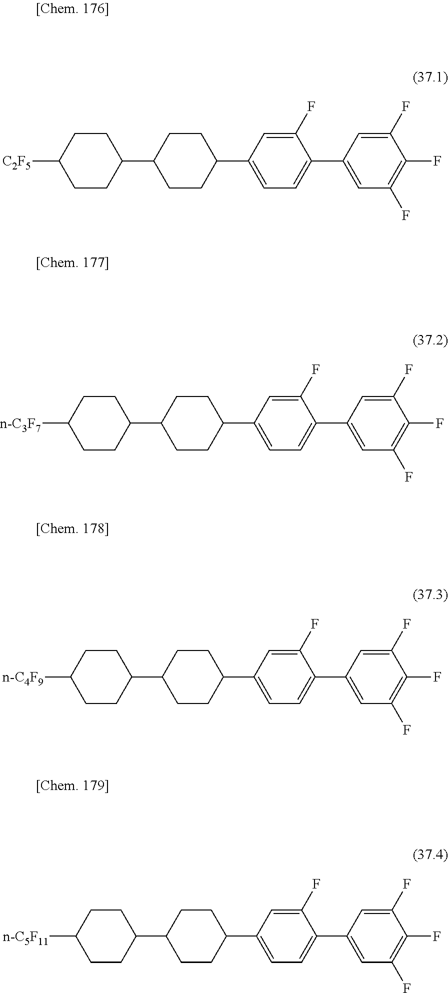

Further, the compound represented by General Formula (X-1) according to the present invention is preferably a compound represented by General Formula (X-1-3).

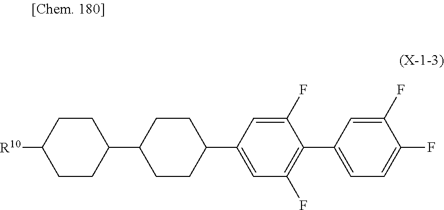

In General Formula (X-1-3), R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other in consideration of the solubility at low temperature, the transition temperature, the electrical reliability, and the birefringence.

With respect to the total content of the liquid crystal compositions of the present invention, the content of the compound represented by General Formula (X-1-3) is preferably equal to or greater than 1% by mass, is further preferably equal to or greater than 2% by mass, and is still further preferably equal to or greater than 6% by mass. In addition, the maximum ratio is preferably set to be equal to or less than 20% by mass, is further preferably equal to or less than 16% by mass, is still further preferably equal to or less than 12% by mass, and is particularly preferably equal to or less than 10% by mass in consideration of the solubility at low temperature, the transition temperature, the electrical reliability, and the like.

Further, the compound represented by General Formula (X-1-3), which is used in the liquid crystal composition of the present invention is preferably compounds specifically represented by formula (38.1) to formula (38.4), and among them, the compound represented by formula (38.2) is preferably contained.

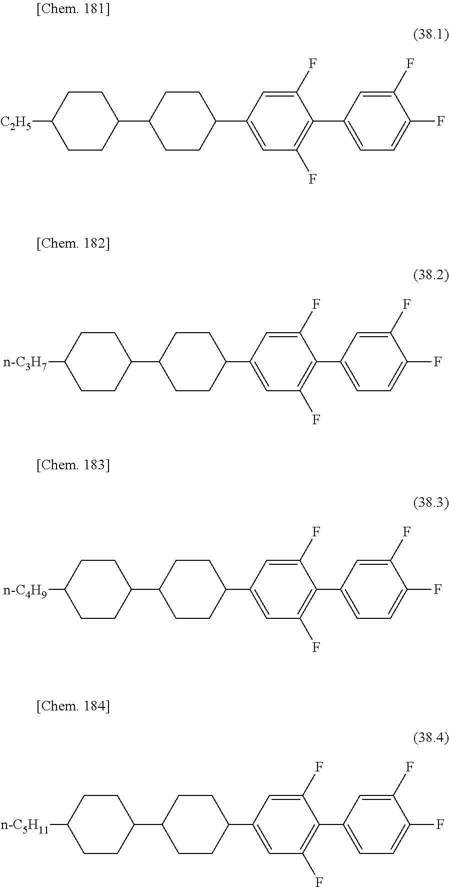

The compound represented by General Formula (X) in the liquid crystal composition of the present invention is preferably a compound represented by General Formula (X-2).

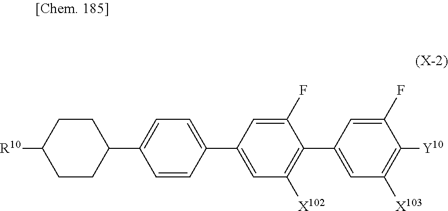

In General Formula (X-2), X¹⁰² to X¹⁰³ each independently represent a fluorine atom or a hydrogen atom, Y¹⁰ represents a fluorine atom, a chlorine atom, and —OCF₃, R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other in consideration of the solubility at low temperature, the transition temperature, the electrical reliability, and the birefringence.

Further, the compound represented by General Formula (X-2) according to the present invention is preferably a compound represented by General Formula (X-2-1).

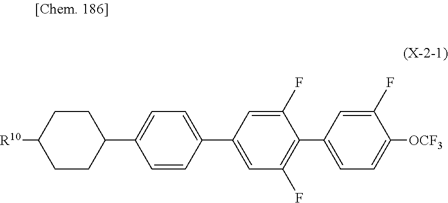

In General Formula (X-2-1), R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other, and one to three or more types of compounds are further preferably combined with each other in consideration of the solubility at low temperature, the transition temperature, the electrical reliability, and the birefringence.

With respect to the total content of the liquid crystal compositions of the present invention, the content of the compound represented by General Formula (X-2-1) is preferably equal to or greater than 3% by mass, is further preferably equal to or greater than 6% by mass, and is still further preferably equal to or greater than 9% by mass. In addition, the maximum ratio is preferably equal to or less than 20% by mass, is further preferably equal to or less than 16% by mass, is still further preferably equal to or less than 12% by mass, and is particularly preferably equal to or less than 10% by mass in consideration of the solubility at low temperature, the transition temperature, the electrical reliability, and the like.

Further, the compound represented by General Formula (X-2-1), which is used in the liquid crystal composition of the present invention is preferably compounds specifically represented by formula (39.1) to formula (39.4), and among them, the compound represented by formula (39.2) is preferably contained.

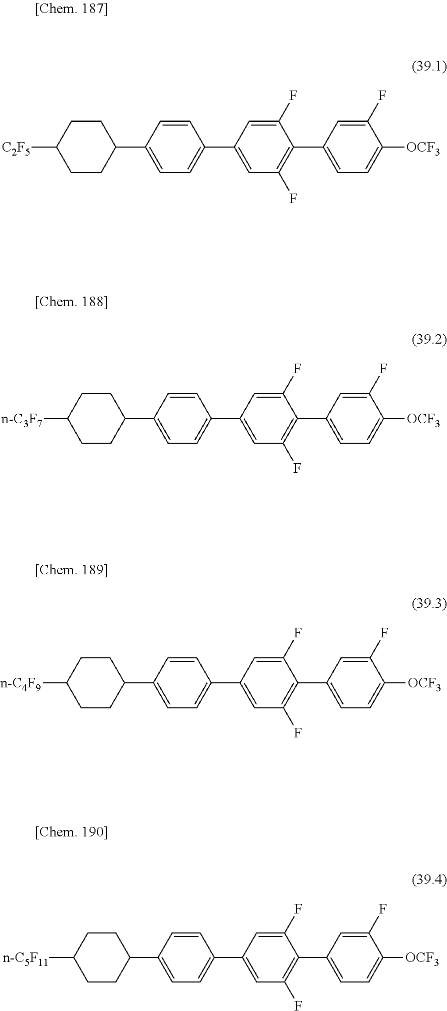

Further, the compound represented by General Formula (X-2) according to the present invention is preferably a compound represented by General Formula (X-2-2).

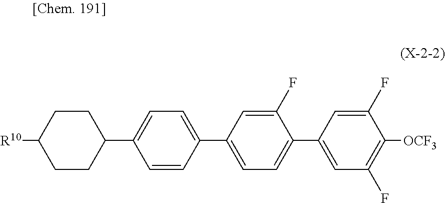

In General Formula (X-2-2), R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other in consideration of the solubility at low temperature, the transition temperature, the electrical reliability, and the birefringence. With respect to the total content of the liquid crystal compositions of the present invention, the content of the compound represented by General Formula (X-2-2) is preferably equal to or greater than 3% by mass, is further preferably equal to or greater than 6% by mass, and is still further preferably equal to or greater than 9% by mass. In addition, the maximum ratio is preferably set to be equal to or less than 20% by mass, is further preferably equal to or less than 16% by mass, is still further preferably equal to or less than 12% by mass, and is particularly equal to or less than 10% by mass in consideration of the solubility at low temperature, the transition temperature, the electrical reliability, and the like.

Further, the compound represented by General Formula (X-2-2), which is used in the liquid crystal composition of the present invention is preferably compounds specifically represented by formula (40.1) to formula (40.4), and among them, the compound represented by formula (40.2) is preferably contained.

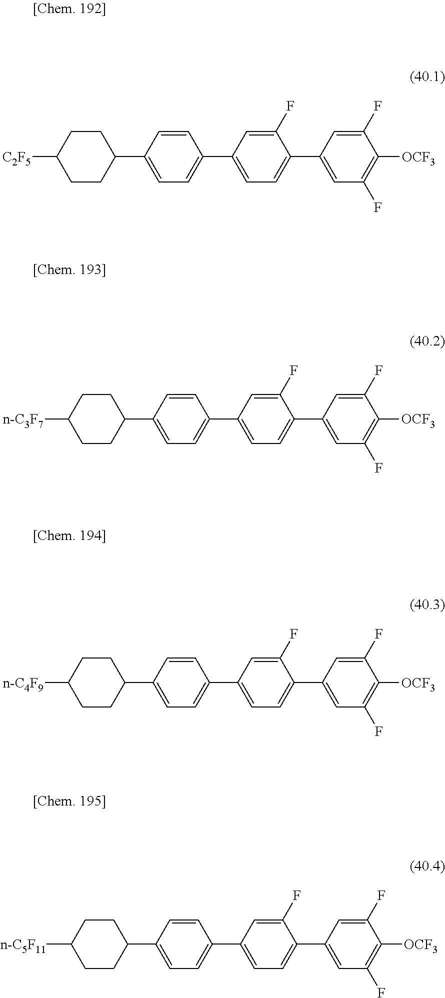

The compound represented by General Formula (M) according to the present invention is preferably a compound represented by General Formula (IIb). The above-described compound is preferably at least one compound among the compound group represented by the following formula.

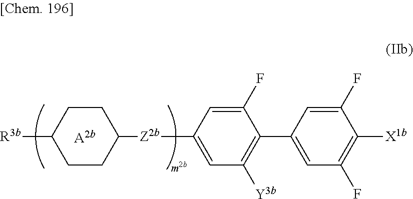

In General Formula (IIb), R^{3b} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively,
A^{2b} each independently represents a 1,4-cyclohexylene cyclohexylene group, a 1,4-phenylene group, a tetrahydropyran-2,5-diyl group, a dioxane-2,5-diyl group, or a pyrimidine-2, 5-diyl group, and A^{2b} represents a 1,4-phenylene group, one hydrogen atom in the 1,4-phenylene group may be substituted with a fluorine atom, Z^{2b} each independently represent a single bond, —OCH₂—, —OCF₂—, —CH₂O—, or —CF₂O—, m^{2b} represents 1, 2, 3, or 4, Y^{3b} each independently represents a fluorine atom or a hydrogen atom, X^{1b} represents a fluorine atom, a —CN group, or a —OCF₃ group.

The above-described m^{2b} is further preferably 2 and 3.

The content of the compound represented by General Formula (IIb) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content of the compound in one embodiment of the present invention is, for example, 0.01%, the lower limit of the content in another embodiment of the present invention is 0.05%, the lower limit of the content in still another embodiment of the present invention is 0.1%, the lower limit of the content in still another embodiment of the present invention is 0.2%, the lower limit of the content in still another embodiment of the present invention is 0.3%, the lower limit of the content in still another embodiment of the present invention is 0.4%, and the lower limit of the content in still another embodiment of the present invention is 0.5%. In addition, the upper limit of the content of the compound represented by General Formula (IIb) in one embodiment of the present invention is, for example, 10%, the upper limit of the content in another embodiment of the present invention is 8%, the upper limit of the content in still another embodiment of the present invention is 2%, the upper limit of the content in still another embodiment of the present invention is 1%, the upper limit of the content in still another embodiment of the present invention is 0.8%, and the upper limit of the content in still another embodiment of the present invention is 0.7%.

When the compound represented by General Formula (IIa) is contained in the liquid crystal composition, the dielectric properties such as Δ∈ can be secured, and the compatibility with General Formula (I) is not deteriorated as well.

The compound represented by General Formula (X) according to the present invention is preferably a compound represented by General Formula (X-3).

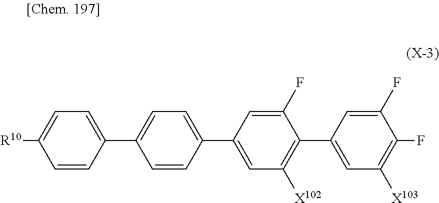

In General Formula (X-3), X¹⁰² to X¹⁰³ each independently represent a fluorine atom or a hydrogen atom, R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other in consideration of the solubility at low temperature, the transition temperature, the electrical reliability, and the birefringence. When the compound represented by General Formula (X-3) is contained in the liquid crystal composition, the dielectric properties such as AE can be secured, and the compatibility with the first component of General Formula (I) and the like is not deteriorated as well.

With respect to the total content of the liquid crystal compositions of the present invention, the content of the compound represented by General Formula (X-3) is preferably equal to or greater than 0.1% by mass, is further preferably equal to or greater than 0.2% by mass, and is still further preferably equal to or greater than 0.3% by mass. In addition, the maximum ratio is preferably set to be equal to or less than 8% by mass, is further preferably equal to or less than 5% by mass, is still further preferably equal to or less than 2% by mass, and is particularly equal to or less than 1% by mass in consideration of the solubility at low temperature, the transition temperature, the electrical reliability, and the like.

Further, the compound represented by General Formula (X-3), which is used in the liquid crystal composition of the present invention is preferably a compound represented by General Formula (X-3-1).

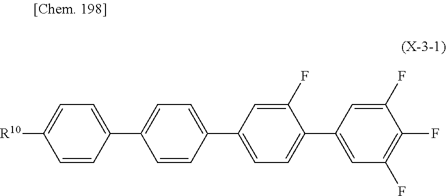

In General Formula (X-3-1), R¹⁰ represents an alkyl group having 1 to 5 carbon atoms, an alkenyl group having 2 to 5 carbon atoms, or an alkoxy group having 1 to 4 carbon atoms.

In the compound satisfying General Formula (X-3-1), the compounds that can be combined are not particularly limited; however, one and two or more types of compounds are preferably combined with each other in consideration of the solubility at low temperature, the transition temperature, the electrical reliability, and the birefringence.

With respect to the total content of the liquid crystal compositions of the present invention, the content of the compound represented by General Formula (X-3-1) is preferably equal to or greater than 0.05% by mass, is further preferably equal to or greater than 0.2% by mass, is still further preferably equal to or greater than 0.3% by mass. In addition, the maximum ratio is preferably set to be equal to or less than 5% by mass, is further preferably equal to or less than 3% by mass, is still further preferably equal to or less than 2% by mass, and is particularly equal to or less than 1% by mass in consideration of the solubility at low temperature, the transition temperature, the electrical reliability, and the like.

Further, the compound represented by General Formula (X-3-1) which is used in the liquid crystal composition of the present invention is preferably compounds specifically represented by formula (41.1) to formula (41.4), and among them, the compound represented by formula (41.2) is preferably contained. When the compounds represented by formula (41.1) to formula (41.4) are contained in the liquid crystal composition, the dielectric properties such as Δ∈ can be secured, and the compatibility with a non-polar first component is not deteriorated as well.

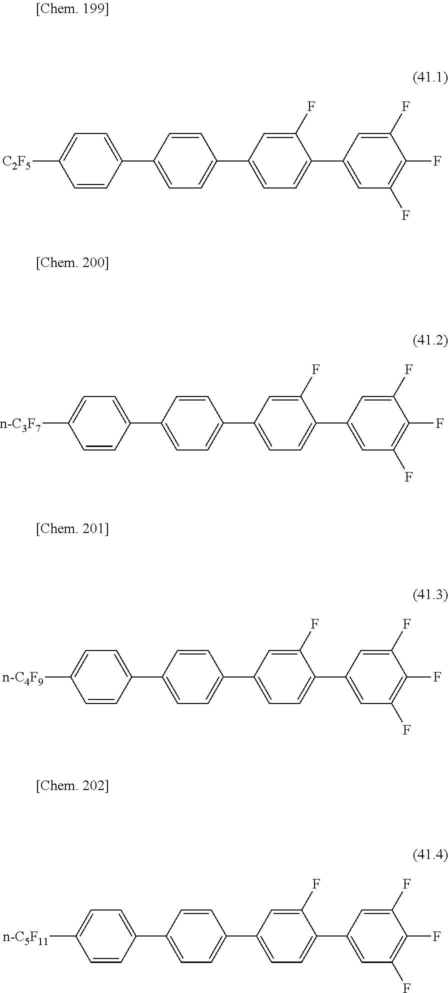

Further, the compound represented by General Formula (X) is preferably a compound represented by General Formula (X-4).

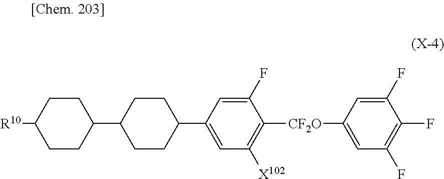

In General Formula (X-4), X¹⁰² represents a fluorine atom or a hydrogen atom, R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other, and one to three or more types of compounds are further preferably combined with each other in consideration of the solubility at low temperature, the transition temperature, the electrical reliability, and the birefringence.

Further, the compound represented by General Formula (X-4) according to the present invention is preferably a compound represented by General Formula (X-4-1).

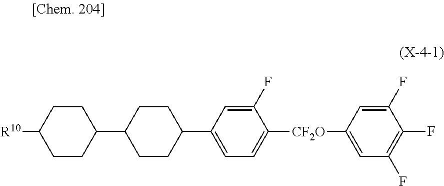

In General Formula (X-4-1), R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other, and one to three or more types of compounds are further preferably combined with each other in consideration of the solubility at low temperature, the transition temperature, the electrical reliability, and the birefringence.

With respect to the total content of the liquid crystal compositions of the present invention, the content of the compound represented by General Formula (X-4-1) is preferably equal to or greater than 2% by mass, is further preferably equal to or greater than 5% by mass, and is still further preferably equal to or greater than 10% by mass. In addition, the maximum ratio is preferably set to be equal to or less than 20% by mass, is further preferably equal to or less than 17% by mass, is still further preferably equal to or less than 15% by mass, and is particularly equal to or less than 13% by mass in consideration of the solubility at low temperature, the transition temperature, the electrical reliability, and the like.

Further, the compound represented by General Formula (X-4-1) which is used in the liquid crystal composition of the present invention is preferably compounds specifically represented by formula (42.1) to formula (42.4), and among them, the compound represented by formula (42.3) is preferably contained.

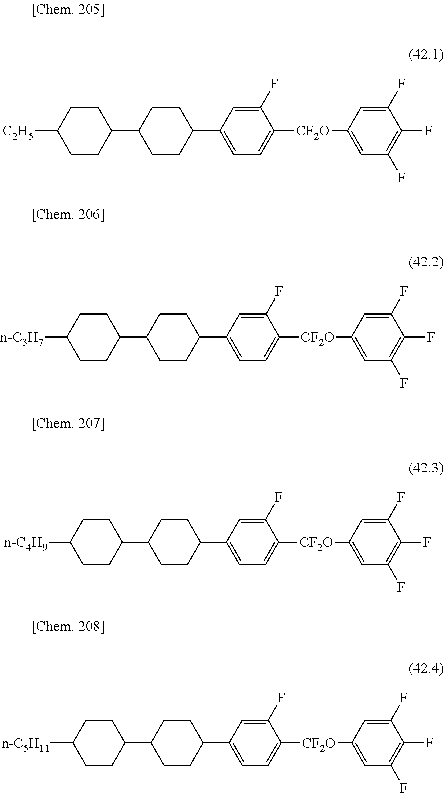

Further, the compound represented by General Formula (X) according to the present invention is preferably a compound represented by General Formula (X-5).

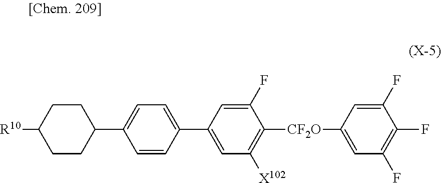

In General Formula (X-5), X¹⁰² represents a fluorine atom or a hydrogen atom, R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other, and one to three or more types of compounds are further preferably combined with each other in consideration of the solubility at low temperature, the transition temperature, the electrical reliability, and the birefringence.

Further, the compound represented by General Formula (X-5), which is used in the liquid crystal composition of the present invention is preferably the compound represented by General Formula (X-5-1).

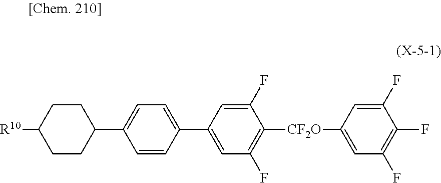

In General Formula (X-5-1), R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other, and one to three or more types of compounds are further preferably combined with each other in consideration of the solubility at low temperature, the transition temperature, the electrical reliability, and the birefringence.

Further, the compound represented by General Formula (X-5-1), which is used in the liquid crystal composition of the present invention is preferably compounds specifically represented by formula (43.1) to formula (43.4), and among them, compound represented by formula (43.2) is preferably contained.

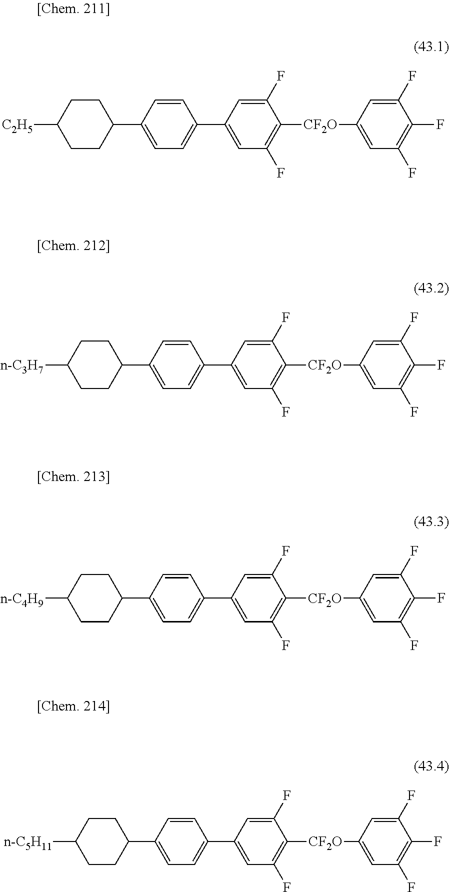

The compound represented by General Formula (M), which is used in the liquid crystal composition of the present invention is preferably the compound represented by General Formula (IIa).

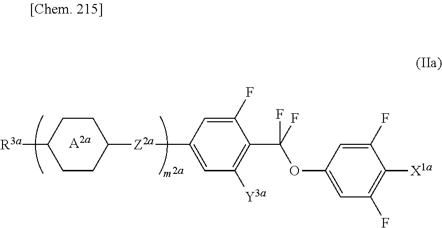

In General Formula (IIa), R^{3a} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively,

A^{2a} each independently represents a 1,4-cyclohexylene cyclohexylene group, a 1,4-phenylene group, a tetrahydropyran-2,5-diyl group, a dioxane-2,5-diyl group, or a pyrimidine-2,5-diyl group, and A^{2a} represents a 1,4-phenylene group, one or more hydrogen atoms in the 1,4-phenylene group may be substituted with a fluorine atom, Z^{2a} each independently represent a single bond, —OCH₂—, —OCF₂—, —CH_{z}O—, or —CF₂O—, m^{2a} represents 1, 2, 3, or 4, Y^{3a} each independently represents a fluorine atom or a hydrogen atom, X^{1a} represents a fluorine atom, a —CN group, or a —OCF₃ group.

The above-described compound is preferably at least one compound selected from the compound group represented by the formula (IIa), and at least two compounds are further preferably at least one compound selected from the compounds represented by General Formula (IIa). In addition, in General Formula (IIa), m^{2a} is further preferably 2, 3, or 4, m^{2a} is still further preferably 2 or 3, and m^{2a} is particularly preferably 3.

It was confirmed that the compatibility was remarkably improved by combining compounds having commonality of the chemical skeleton or features of the chemical skeleton.

The content of the compound represented by General Formula (IIa) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content of the compound in one embodiment of the present invention is, for example, 2%, the lower limit of the content in another embodiment of the present invention is 3%, the lower limit of the content in still another embodiment of the present invention is 4%, the lower limit of the content in still another embodiment of the present invention is 5%, the lower limit of the content in still another embodiment of the present invention is 6%, the lower limit of the content in still another embodiment of the present invention is 7%, and the lower limit of the content in still another embodiment of the present invention is 8%. Further, the lower limit of the content in other embodiments of the present invention is 9%. The lower limit in another embodiment of the present invention is 11%, the lower limit of the content in still another embodiment of the present invention is 15%, and the lower limit of the content in still another embodiment of the present invention is 18%. In addition, the upper limit of the content of the compound represented by General Formula (IIa) in one embodiment of the present invention is, for example, 30%, the upper limit of the content in another embodiment of the present invention is 20%, the upper limit of the content in still another embodiment of the present invention is 13%, the upper limit of the content in still another embodiment of the present invention is 10%, the upper limit of the content in still another embodiment of the present invention is 7%, and the upper limit of the content in still another embodiment of the present invention is 3%.

The compound represented by General Formula (X), which is used in the liquid crystal composition of the present invention is preferably the compound represented by General Formula (X-6).

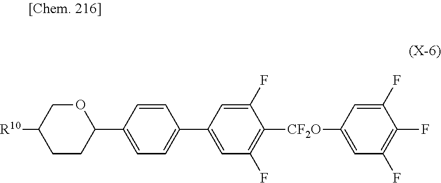

In General Formula (X-6), R¹⁰ represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other in consideration of the solubility at low temperature, the transition temperature, the electrical reliability, and the birefringence.

When the compound represented by General Formula (X-6) is present in the liquid crystal composition according to the present invention, a high transition point, and a large dielectric constant of Δ∈ were confirmed, and it was confirmed that a 4-ring compound showed low viscosity. In addition, it was confirmed that it exhibits specifically good compatibility with respect to General Formula (I-1), General Formula (II-2), and General Formula (IV).

The content of the compound represented by General Formula (X-6) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content of the compound in one embodiment of the present invention is, for example, 4%, the lower limit of the content in another embodiment of the present invention is 5%, the lower limit of the content in still another embodiment of the present invention is 6%, the lower limit of the content in still another embodiment of the present invention is 8%, the lower limit of the content in still another embodiment of the present invention is 9%, the lower limit of the content in still another embodiment of the present invention is 11%, and the lower limit of the content in still another embodiment of the present invention is 14%. Further the lower limit of the content in still another embodiment of the present invention is 18%.

In addition, the upper limit of the content of the compound in one embodiment of the present invention is, for example, 30%, the upper limit of the content in another embodiment of the present invention is 20%, the upper limit of the content in still another embodiment of the present invention is 13%, the upper limit of the content in still another embodiment of the present invention is 10%, the upper limit of the content in still another embodiment of the present invention is 7%, and the upper limit of the content in still another embodiment of the present invention is 3%.

Further, the compound represented by General Formula (X-6), which is used in the liquid crystal composition of the present invention is preferably compounds specifically represented by formula (44.1) to formula (44.4), and among them, the compound represented by formula (44.1) and/or formula (44.2) is preferably contained.

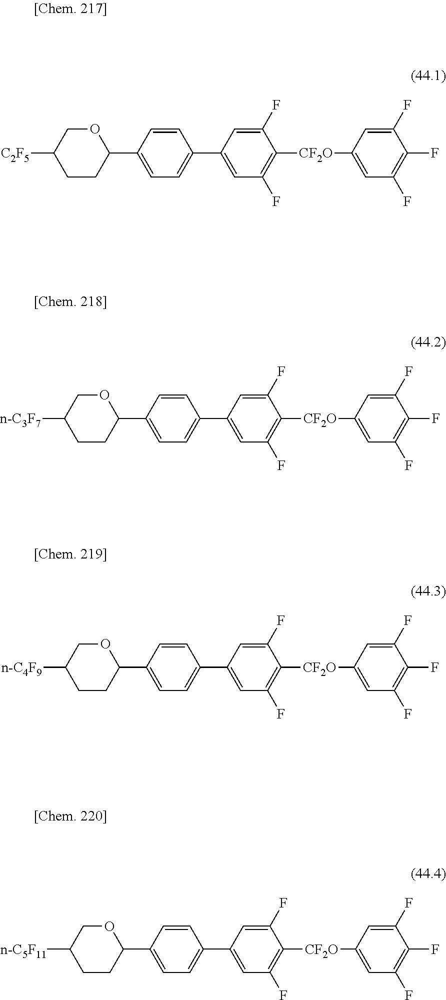

Further, the compound represented by General Formula (X) is preferably a compound selected from the group represented by General Formula (XI).

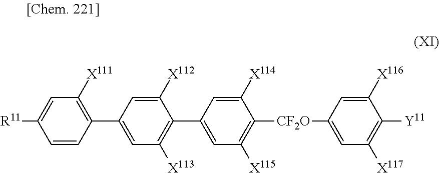

In General Formula (XI), X¹¹¹ to X¹¹⁷ each independently represent a fluorine atom or a hydrogen atom, at least one of X¹¹¹ to X¹¹⁷ represents a fluorine atom, R¹¹ represents an alkyl group having 1 to 5 carbon atoms, an alkenyl group having 2 to 5 carbon atoms, or an alkoxy group having 1 to 4 carbon atoms, and Y¹¹ represents a fluorine atom or —OCF₃.

The compounds that can be combined are not particularly limited; however, one to three or more types of the compounds are preferably combined with each other in consideration of the solubility at low temperature, the transition temperature, the electrical reliability, and the birefringence.

When the compound represented by General Formula (XI) is present in the liquid crystal composition, a high transition point, a large dielectric constant of Δ∈, and high Δn were confirmed, and it was confirmed that a 4-ring compound showed low viscosity. With this, in the liquid crystal composition according to the present invention, it is particularly preferable to contain General Formula (XI) as General Formula (M).

The content of the compound represented by General Formula (XI) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content in one embodiment of the present invention is, for example, 2%, the lower limit of the content in another embodiment of the present invention is 4%, the lower limit of the content in still another embodiment of the present invention is 5%, the lower limit of the content in still another embodiment of the present invention is 7%, the lower limit of the content in still another embodiment of the present invention is 9%, the lower limit of the content in still another embodiment of the present invention is 10%, and the lower limit of the content in still another embodiment of the present invention is 12%. Further, the lower limit of the content in still another embodiment of the present invention is 13%. Further, the lower limit of the content in still another embodiment of the present invention is 15%. Further, the lower limit of the content in still another embodiment of the present invention is 18%.

In addition, the upper limit of the content in one embodiment of the present invention is, for example, 30%, the upper limit of the content in another embodiment of the present invention is 25%, the upper limit of the content in still another embodiment of the present invention is 20%, the upper limit of the content in still another embodiment of the present invention is 15%, the upper limit of the content in still another embodiment of the present invention is 10%, and the upper limit of the content in still another embodiment of the present invention is 5%.

In a case where the liquid crystal composition of the present invention is used as a liquid crystal display element having small cell gap, it is suitable to set the content of the compound represented by General Formula (XI) to be increased. In a case where the liquid crystal composition of the present invention is used as a liquid crystal display element having small driving voltage, it is suitable to set the content of the compound represented by General Formula (XI) to be increased. In addition, in a case where the liquid crystal composition of the present invention is used in a liquid crystal display element which is used in an environment with the low temperature, it is suitable to set the content of the compound represented by General Formula (XI) to be decreased. In a case where the liquid crystal composition of the present invention is used in a liquid crystal display element having fast response speed, it is suitable to set the content of the compound represented by General Formula (XI) to be decreased.

Note that, the cell gap in the present specification means an average distance between opposing alignment layers, and in other words, it means an average thickness of the liquid crystal layer which is filled with the liquid crystal composition (for example, the thickness is calculated by an average of 10 points or the like).

Further, the compound represented by General Formula (XI), which is used in the liquid crystal composition of the present invention is preferably a compound represented by General Formula (XI-1).

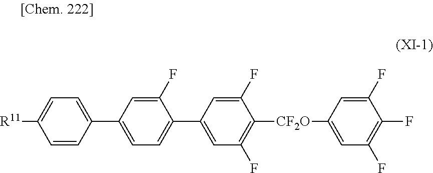

In General Formula (XI-1), R¹¹ represents an alkyl group having 1 to 5 carbon atoms, an alkenyl group having 2 to 5 carbon atoms, or an alkoxy group having 1 to 4 carbon atoms.

The compounds that can be combined are not particularly limited; however, the compounds are appropriately combined with each other for each embodiment in consideration of the solubility at low temperature, the transition temperature, the electrical reliability, and the birefringence. For example, the number of the types of the compounds is one in one embodiment of the present invention, two types of the compounds are combined with each other in another embodiment of the present invention, and three or more types of the compounds are combined with each other in still another embodiment of the present invention.

In addition, regarding the compound represented by General Formula (XI-1), it is considered that the fluorine in the benzene ring which is positioned second from the left is particularly contributing to the compatibility, a high transition point, a large dielectric constant of Δ∈ and high Δn were confirmed, and it was confirmed that a 4-ring compound showed low viscosity.

With respect to the total content of the liquid crystal compositions of the present invention, the content of the compound represented by General Formula (XI-1) is preferably equal to or greater than 1% by mass, is further preferably equal to or greater than 3% by mass, is still further preferably equal to or greater than 4% by mass, is still further preferably equal to or greater than 6% by mass, and is particularly preferably equal to or greater than 9% by mass. In addition, the maximum ratio is preferably set to be equal to or less than 20% by mass, is further preferably equal to or less than 15% by mass, is still further preferably equal to or less than 12% by mass, and is particularly equal to or less than 8% by mass in consideration of the solubility at low temperature, the transition temperature, the electrical reliability, and the like.

Further, the compound represented by General Formula (XI-1), which is used in the liquid crystal composition of the present invention is preferably compounds specifically represented by formula (45.1) to formula (45.4), and among them the compounds represented by formula (45.2) to formula (45.4) are preferably contained, and the compound represented by formula (45.2) is further preferably contained.

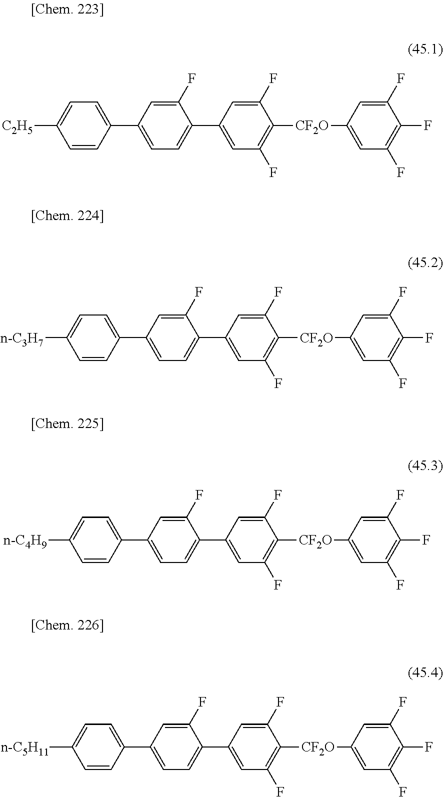

Further, the compound represented by General Formula (X) is preferably a compound selected from the group represented by General Formula (XII).

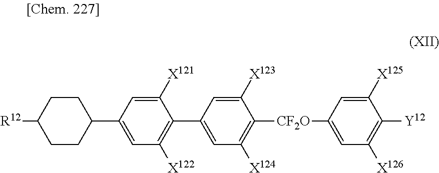

In General Formula (XII), X¹²¹ to X¹²⁶ each independently represent, a fluorine atom or a hydrogen atom, R¹² represents an alkyl group having 1 to 5 carbon atoms, an alkenyl group having 2 to 5 carbon atoms, or an alkoxy group having 1 to 4 carbon atoms, and Y¹² represents a fluorine atom or —OCF₃.

The compounds that can be combined are not particularly limited; however, one to three or more types of compounds are preferably combined with each other, and one to four or more types of compounds are further preferably combined with each other in consideration of the solubility at low temperature, the transition temperature, the electrical reliability, and the birefringence.

Further, the compound represented by General Formula (XII), which is used in the liquid crystal composition of the present invention is preferably a compound represented by General Formula (XII-1).

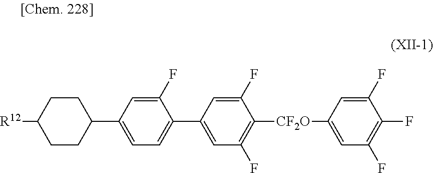

In General Formula (XII-1), R¹² represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other, and one to three or more types of compounds are further preferably combined with each other in consideration of the solubility at low temperature, the transition temperature, the electrical reliability, and the birefringence.

With respect to the total content of the liquid crystal compositions of the present invention, the content of the compound represented by General Formula (XII-1) is preferably equal to or greater than 1% by mass, is further preferably equal to or greater than 2% by mass, is still further preferably equal to or greater than 3% by mass, and particularly preferably equal to or greater than 4% by mass. Further, the maximum ratio is preferably set to be equal to or less than 15% by mass, is further preferably equal to or less than 10% by mass, is still further preferably equal to or less than 8% by mass, and is particularly equal to or less than 6% by mass in consideration of the solubility at low temperature, the transition temperature, the electrical reliability, and the like.

Further, the compound represented by General Formula (XII-1), which is used in the liquid crystal composition of the present invention is preferably compounds specifically represented by formula (46.1) to formula (46.4), among them, the compounds represented by formula (46.2) to formula (46.4) are preferably contained.

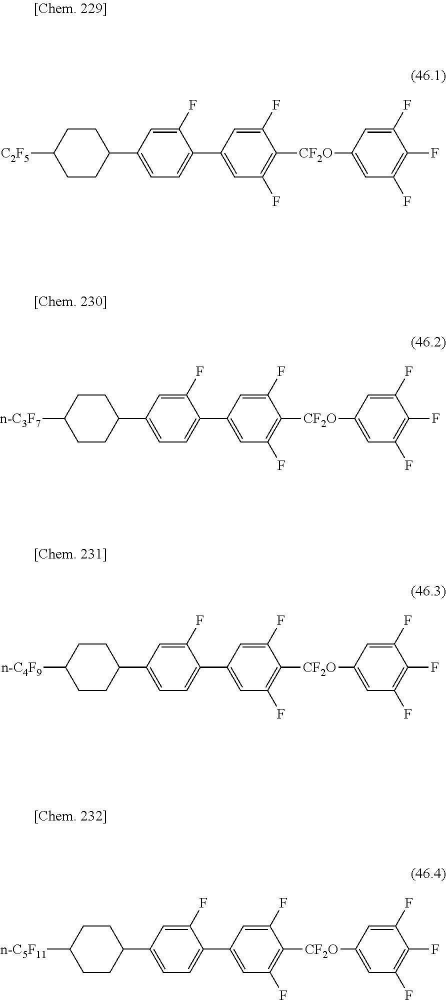

Further, the compound represented by General Formula (XII) is preferably a compound represented by General Formula (XII-2).

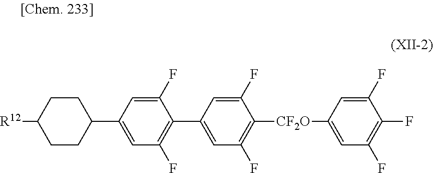

In General Formula (XII-2), R¹² represents an alkyl group having 1 to 5 carbon atoms, an alkenyl group having 2 to 5 carbon atoms, or an alkoxy group having 1 to 4 carbon atoms.

The compounds that can be combined are not particularly limited; however, one and two or more types of compounds are preferably combined with each other, and one to three or more types of compounds are further preferably combined with each other in consideration of the solubility at low temperature, the transition temperature, the electrical reliability, and the birefringence.

With respect to the total content of the liquid crystal compositions of the present invention, the content of the compound represented by General Formula (XII-2) is preferably equal to or greater than 1% by mass, is further preferably equal to or greater than 3% by mass, is still further preferably equal to or greater than 4% by mass, is still further preferably equal to or greater than 6% by mass, and particularly preferably equal to or greater than 9% by mass. In addition, the maximum ratio is preferably set to be equal to or less than 20% by mass, is further preferably equal to or less than 17% by mass, is still further preferably equal to or less than 15% by mass, and is particularly equal to or less than 13% by mass in consideration of the solubility at low temperature, the transition temperature, the electrical reliability, and the like.

Further, the compound represented by General Formula (XII-2), which is used in the liquid crystal composition of the present invention is preferably compounds specifically represented by formula (47.1) to formula (47.4), and among them, the compounds represented by formula (47.2) to formula (47.4) are preferably contained.

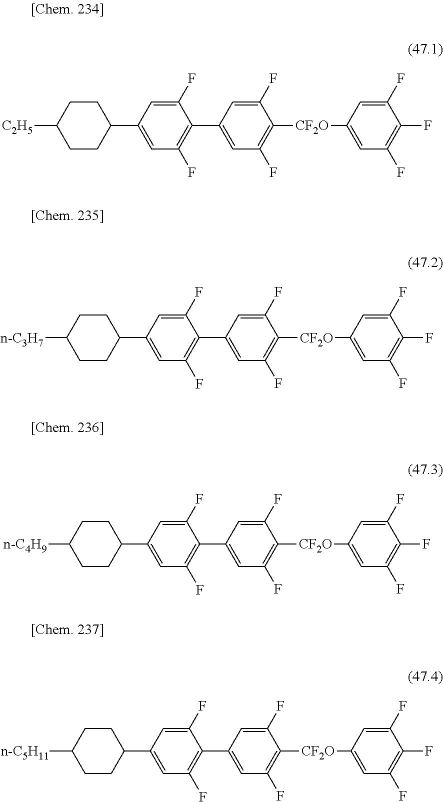

The compound represented by General Formula (M) according to the present invention is, for example, preferably a compound selected from the compound group represented by General Formula (VIII).

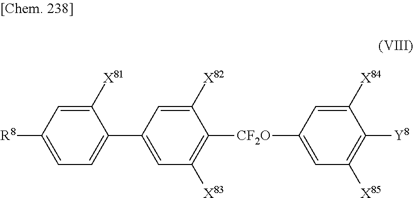

In General Formula (VIII), R⁸ represents an alkyl group having 1 to 5 carbon atoms, an alkenyl group having 2 to 5 carbon atoms, or an alkoxy group having 1 to 4 carbon atoms, X⁸¹ to X⁸⁵ each independently represent a hydrogen atom or a fluorine atom, and Y⁸ represents a fluorine atom or —OCF₃.

The compounds that can be combined are not particularly limited; however, the compounds are appropriately used in combination in accordance with the desired performance such as the solubility at low temperature, the transition temperature, the electrical reliability, and the birefringence. The number of the types of the compound to be used in one embodiment of the present invention is, for example, one. The number of the types thereof is two in another embodiment of the present invention. Further, the number of the types thereof is three or more in another embodiment of the present invention. When the compound represented by General Formula (VIII) is present in the liquid crystal composition, high Δn is shown, and an action or effect of easily controlling the transition point by adjusting ratio with other 4-ring compounds is exhibited.

In the liquid crystal composition of the present invention, the content of the compound represented by General Formula (VIII) is required to be appropriately adjusted in accordance with desired performance such as the solubility at low temperature, the transition temperature, the electrical reliability, the birefringence, the process adaptability, the drip mark, the burn-in, and the dielectric anisotropy.

With respect to the total content of the liquid crystal composition of the present invention, the content of the compound represented by General Formula (VIII) in one embodiment of the present invention is, for example, in a range of 1 to 25% by mass. Further, for example, the content of the compound in another embodiment of the present invention is 1 to 20% by mass. For example, the above-described content of the compound in still another embodiment of the present invention is in a range of 1 to 15% by mass. For example, the above-described content of the compound in still another embodiment of the present invention is in a range of 1 to 10% by mass. For example, the above-described content of the compound in still another embodiment of the present invention is in a range of 1 to 7% by mass. For example, the above-described content of the compound in still another embodiment of the present invention is in a range of 1 to 6% by mass. For example, the above-described content of the compound in still another embodiment of the present invention is in a range of 1 to 5% by mass. For example, the above-described content of the compound in still another embodiment of the present invention is in a range of 1 to 4% by mass. For example, the above-described content of the compound in still another embodiment of the present invention is in a range of 3 to 7% by mass. For example, the above-described content of the compound in still another embodiment of the present invention is in a range of 3 to 6% by mass. For example, the above-described content of the compound in still another embodiment of the present invention is in a range of 4 to 7% by mass.

In a case where a liquid crystal composition having a fast response speed while keeping the viscosity of the liquid crystal composition of the present invention to be low is required, it is preferable that the lower limit is set to be low and the upper limit is set to be low. Further, in a case where the liquid crystal composition having good temperature stability is required while keeping the T_{NI} of the liquid crystal composition of the present invention to be high, it is preferable that the lower limit is set to be low and the upper limit is set to be low. Further, when the dielectric anisotropy is to be large in order to keep the driving voltage to be low, it is preferable the lower limit is set to be high and the upper limit is set to be high.

Further, the compound represented by General Formula (VIII) according to the present invention is preferably a compound represented by General Formula (VIII-1).

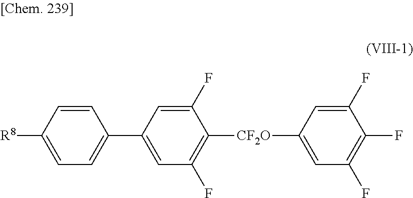

In General Formula (VIII-1), R⁸ represents the same meaning as being in General Formula (VIII).

Further, the compound represented by General Formula (VIII-1) is preferably compounds specifically represented by formula (26.1) to formula (26.4), the compound represented by formula (26.1) or formula (26.2) is preferable, and the compound represented by formula (26.2) is further preferable.

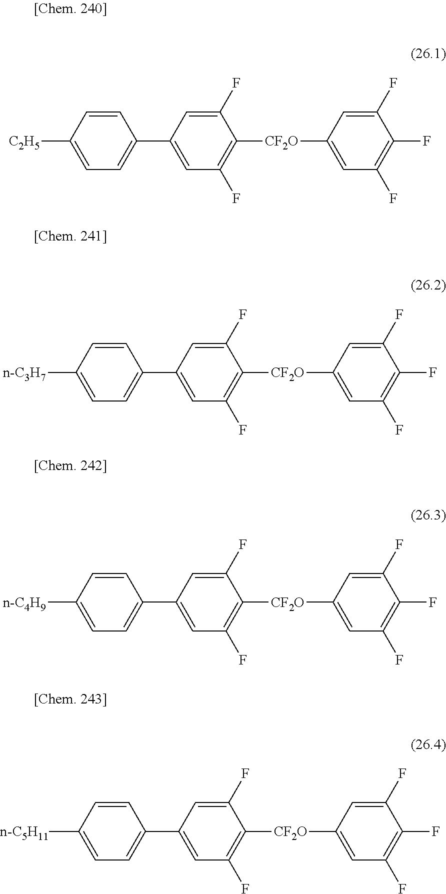

With respect to the total content of the liquid crystal composition of the present invention, the content of the compound represented by the above-described formula (26.1) is preferably in a range of 1% by mass to 20% by mass, is further preferably in a range of 1% by mass to 15% by mass, is still further preferably in a range of 1% by mass to 10% by mass, and is preferably in a range of 1% by mass to 7% by mass in consideration of the solubility at low temperature, the transition temperature, the electrical reliability, and the birefringence. Among them, for example, the above-described content of the compound is preferably in a range of 1% by mass to 6% by mass, in a range of 1% by mass to 5% by mass, in a range of 3% by mass to 7% by mass, in a range of 3% by mass to 6% by mass, and in a range of 4% by mass to 7% by mass.

Further, the compound represented by General Formula (VIII) according to the present invention is preferably a compound represented by General Formula (VIII-2).

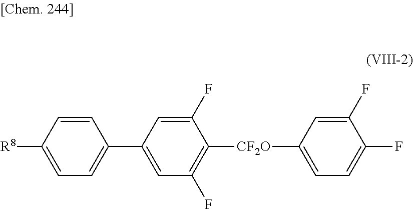

In General Formula (VIII-2), R⁸ represents represent the same meaning as being in General Formula (VIII).

The compounds that can be combined as General Formula (VIII-2) are not particularly limited; however, the compounds are used in appropriate combination in accordance with the desired performance such as ‘the solubility at low temperature, the transition temperature, the electrical reliability, and the birefringence. The number of types of the compounds to be used is, for example, one in one embodiment of the present invention. The number of types of the compounds in another embodiment of the present invention is two. The number of types of the compounds in still another embodiment of the present invention is three or more.

With respect to the total content of the liquid crystal composition of the present invention, the content of the compound represented by General Formula (VIII-2) is preferably in a range of 2.5% by mass to 25% by mass, in a range of 8% by mass to 25% by mass, in a range of 10% by mass 20% by mass, and in a range of 12% by mass to 15% by mass in consideration of the solubility at low temperature, the transition temperature, the electrical reliability, and the birefringence.

Further, the compound represented by General Formula (VIII-2) is preferably compounds represented by formula (27.1) to formula (27.4), and is preferably a compound represented by formula (27.2).

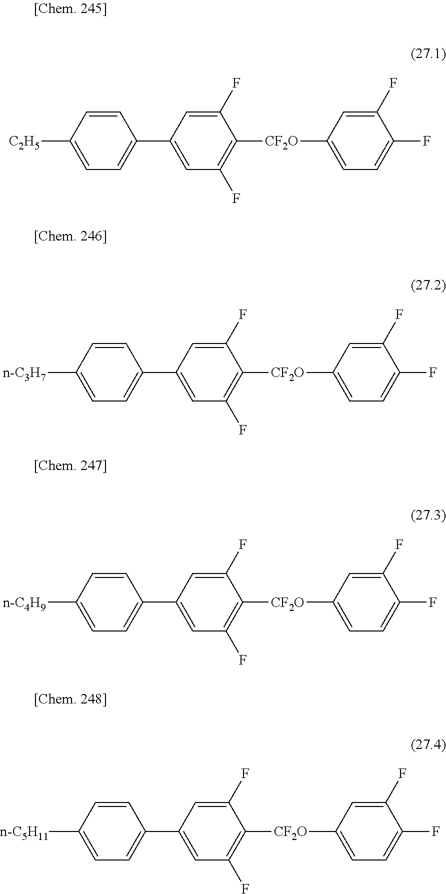

Further, the compound represented by General Formula (M) according to the present invention is, for example, preferably a compound selected from the compound group represented by General Formula (IX).

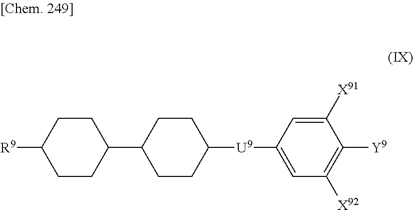

In General Formula (IX), R⁹ represents an alkyl group having 1 to 5 carbon atoms, an alkenyl group having 2 to 5 carbon atoms, or an alkoxy group having 1 to 4 carbon atoms, X⁹¹ and X⁹² each independently represent a hydrogen atom or a fluorine atom, Y⁹ represents a fluorine atom, a chlorine atom, or —OCF₃, and U⁹ represents a single bond, —COO—, or —CF₂O—.

The compounds that can be combined are not particularly limited; however, the compounds are used in appropriate combination in accordance with the desired performance such as the solubility at low temperature, the transition temperature, the electrical reliability, and the birefringence. The number of types of the compounds to be used is, for example, one in one embodiment of the present invention. The number of types of the compounds in another embodiment of the present invention is two or more.

With respect to the total content of the liquid crystal composition of the present invention, the content of the compound represented by General Formula (VIII-3) is preferably in a range of 0.5% by mass to 15% by mass, in a range of 0.5% by mass to 10% by mass, in a range of 0.5% by mass 5% by mass, and in a range of 1% by mass to 5% by mass in consideration of the solubility at low temperature, the transition temperature, the electrical reliability, and the birefringence.

In a case where a liquid crystal composition having a fast response speed while keeping the viscosity of the liquid crystal composition of the present invention to be low is required, it is preferable that the lower limit is set to be low and the upper limit is set to be low. Further, in a case where the liquid crystal composition in which the burn-in is hard to occur while keeping the TNT of the liquid crystal composition of the present invention to be high is required, it is preferable that the lower limit is set to be low and the upper limit is set to be low. In addition, when the dielectric anisotropy is set to be large so as to keep the driving voltage to be low, it is preferable that the lower limit is set to be high and the upper limit is set to be high.

Further, the compound represented by according to the present invention General Formula (IX) is preferably a compound represented by General Formula (IX-1).

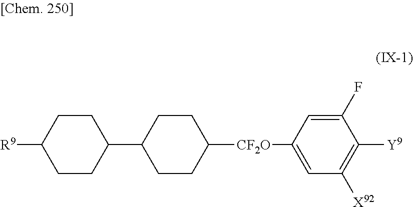

In General Formula (IX-1), R⁹ and X⁹² represent the same meaning as being in General Formula (IX).

Further, the compound represented by General Formula (IX-1) according to the present invention is preferably a compound represented by General Formula (IX-1-1).

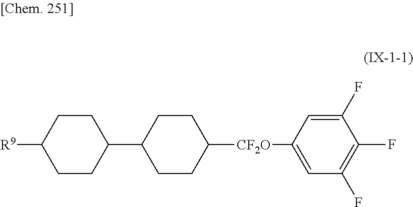

In General Formula (IX-1-1), R⁹ represents the same meaning as being in General Formula (IX).

The compounds that can be combined are not particularly limited; however, the compounds are used in appropriate combination in accordance with the desired performance such as ‘the solubility at low temperature, the transition temperature, the electrical reliability, and the birefringence. The number of types of the compounds to be used is, for example, one in one embodiment of the present invention. The number of types of the compounds in another embodiment of the present invention is two. The number of types of the compounds in still another embodiment of the present invention is three or more.

The content of the compound represented by General Formula (IX-1-1) is appropriately adjusted in accordance with the embodiment in consideration of the solubility at low temperature, the transition temperature, the electrical reliability, and the birefringence.

With respect to the total content of the liquid crystal composition of the present invention, the content of the compound represented by General Formula (IX-1-1) in one embodiment of the present invention is, for example, in a range of 1 to 30% by mass. Further, for example, the content of the compound in another embodiment of the present invention is 2 to 25% by mass. For example, the above-described content of the compound in still another embodiment of the present invention is in a range of 3 to 20% by mass. For example, the above-described content of the compound in still another embodiment of the present invention is in a range of 9 to 15% by mass. For example, the above-described content of the compound in still another embodiment of the present invention is in a range of 12 to 20% by mass.

Further, the compound represented by General Formula (IX-1-1) is preferably compounds represented by formula (28.1) to formula (28.5), is preferably the compounds represented by formula (28.3) or/and formula (28.5).

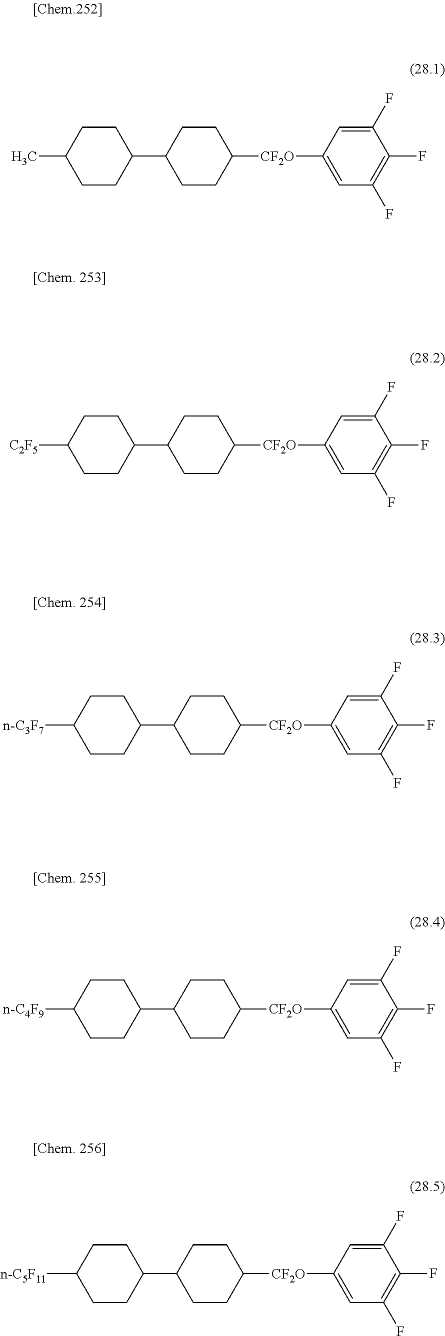

Further, the compound represented by General Formula (IX-1) according to the present invention is preferably a compound represented by General Formula (IX-1-2).

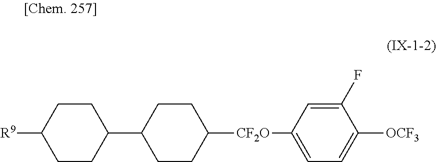

In the above-described formula (IX-1-2), R⁹ represents the same meaning as being in General Formula (IX).

The compounds that can be combined are not particularly limited; however, one to three types of compounds are preferably combined with each other, and one to four types of compounds are further preferably combined with each other in consideration of the solubility at low temperature, the transition temperature, the electrical reliability, and the birefringence.

With respect to the total content of the liquid crystal composition of the present invention, the content of the compound represented by General Formula (IX-1-2) is preferably in a range of 1% by mass to 30% by mass, in a range of 5% by mass to 25% by mass, and in a range of 8% by mass to 20% by mass in consideration of the solubility at low temperature, the transition temperature, the electrical reliability, and the like.

Further, the compound represented by General Formula (IX-1-2) is preferably compounds represented by formula (29.1) to formula (29.4), and is preferably the compounds represented by formula (29.2) or/and formula (29.4).

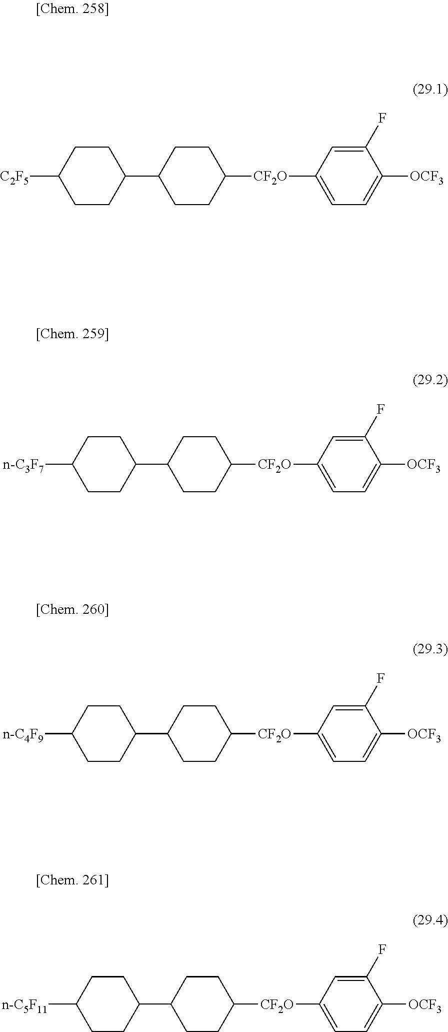

Further, the compound represented by General Formula (IX) is preferably a compound represented by General Formula (IX-2).

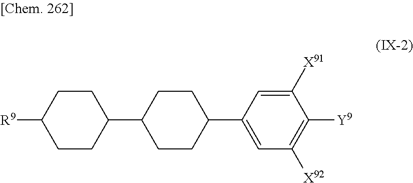

In General Formula (IX-2), R⁹, X⁹¹ and X⁹² represent the same meaning as being in General Formula (IX).

Further, the compound represented by General Formula (IX-2) according to the present invention is preferably a compound represented by General Formula (IX-2-1).

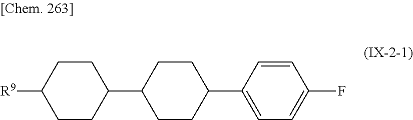

In General Formula (IX-2-1), R⁹ represents the same meaning as being in General Formula (IX).

For example, with respect to the total content of the liquid crystal composition of the present invention, the content of the compound represented by General Formula (IX-2-1) in one embodiment of the present invention is in a range of 1 to 25% by mass. The above-described content of the compound in another embodiment of the present invention is in a range of 1 to 20% by mass. The above-described content of the compound in the still another embodiment is in a range of 1 to 15% by mass. Further, the above-described content of the compound in the still another embodiment is in a range of 1 to 10% by mass. Further, the above-described content of the compound in the still another embodiment is in a range of 1 to 5% by mass. Further, the above-described content of the compound in the still another embodiment is in a range of 1 to 4% by mass.

Further, the compound represented by General Formula (IX-2-1) is preferably compounds represented by formula (30.1) to formula (30.4), and is preferably the compounds represented by formula (30.1) to formula (30.2).

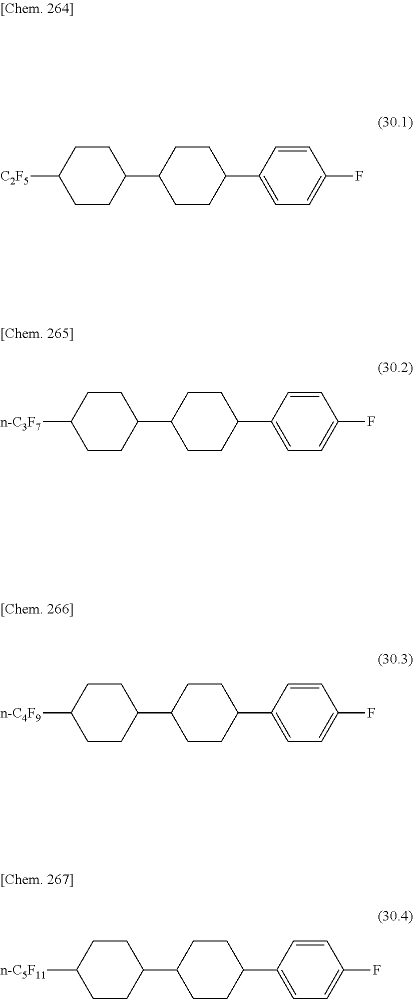

Further, the compound represented by General Formula (IX-2) according to the present invention is preferably a compound represented by General Formula (IX-2-2).

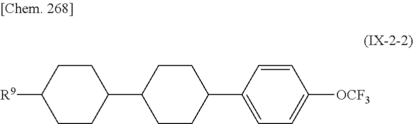

In General Formula (IX-2-2), R⁹ represents the same meaning as being in General Formula (IX).

The content of the compound represented by General Formula (IX-2-2) is appropriately adjusted for each embodiment in consideration of the properties such as the solubility at low temperature, the transition temperature, the electrical reliability, and the birefringence.

With respect to the total contents of the liquid crystal composition of the present invention, the content of the compound represented by General Formula (IX-2-2) in one embodiment of the present invention is in a range of 1 to 30% by mass, the above-described content of the compound in another embodiment of the present invention is in a range of 1 to 25% by mass, the above-described content of the compound in still another embodiment of the present invention is in a range of 1 to 20% by mass, the above-described content of the compound in still another embodiment of the present invention is in a range of 1 to 17% by mass, the above-described content of the compound in still another embodiment of the present invention is in a range of 1 to 16% by mass, the above-described content of the compound in still another embodiment of the present invention is in a range of 1 to 12% by mass, the above-described content of the compound in still another embodiment is in a range of 1 to 11% by mass, the above-described content of the compound in still another embodiment is in a range of 1 to 10% by mass, the above-described content of the compound in still another embodiment is in a range of 1 to 9% by mass, the above-described content of the compound in still another embodiment is in a range of 2 to 17% by mass, the above-described content of the compound in still another embodiment is in a range of 6 to 17% by mass, the above-described content of the compound in still another embodiment is in a range of 8 to 17% by mass, the above-described content of the compound in still another embodiment is in a range of 9 to 17% by mass, the above-described content of the compound in still another embodiment is in a range of 14 to 17% by mass, the above-described content of the compound in still another embodiment is in a range of 14 to 16% by mass, the above-described content of the compound in still another embodiment is in a range of 2 to 9% by mass, the above-described content of the compound in still another embodiment is in a range of 6 to 10% by mass, the above-described content of the compound in still another embodiment is in a range of 8 to 11% by mass, and the above-described content of the compound in still another embodiment is in a range of 9 to 12% by mass.

Further, the compound represented by General Formula (IX-2-2) is preferably compounds represented by formula (31.1) to formula (31.4), and is preferably the compounds represented by formula (31.1) to formula (31.4).

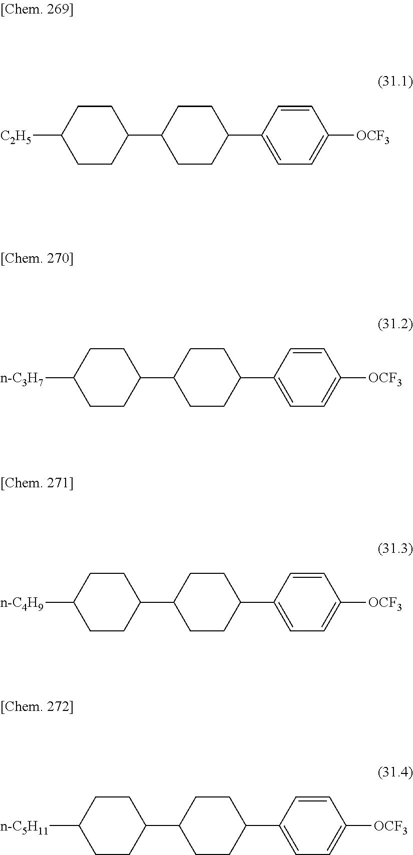

Further, the compound represented by General Formula (IX-2) is preferably a compound represented by General Formula (IX-2-3).

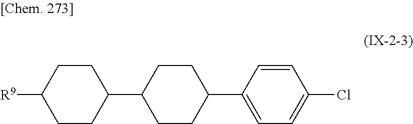

In General Formula (IX-2-3), R⁹ represents the same meaning as being in General Formula (IX).

The compounds that can be combined are not particularly limited; however, one or two types of compounds are preferably combined with each other in consideration of the solubility at low temperature, the transition temperature, the electrical reliability, and the birefringence.

With respect to the total content of the liquid crystal composition of the present invention, the content of the compound represented by General Formula (IX-2-3) is preferably in a range of 1% by mass to 30% by mass, is further preferably in a range of 3% by mass to 20% by mass, is still further preferably in a range of 6% by mass to 15% by mass, and is still further preferably in a range of 8% by mass to 10% by mass in consideration of the solubility at low temperature, the transition temperature, the electrical reliability, and the like.

Further, the compound represented by General Formula (IX-2-3) is preferably compounds represented by formula (32.1) to formula (32.4), and is preferably the compounds represented by formula (32.2) and/or formula (32.4).

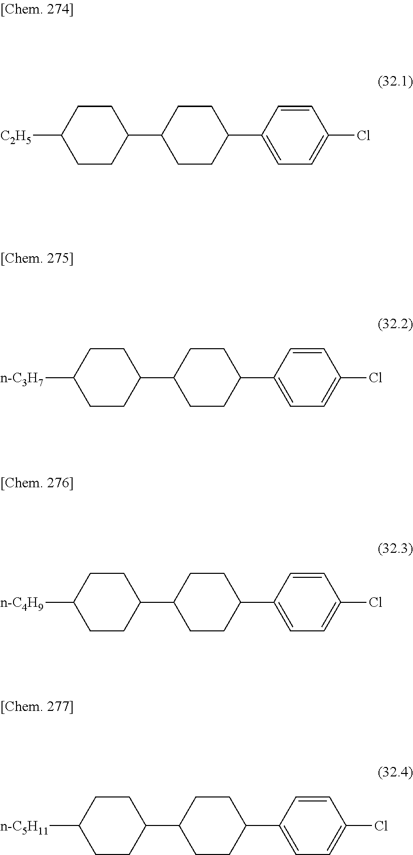

Further, the compound represented by according to the present invention General Formula (IX-2) is preferably a compound represented by General Formula (IX-2-4).

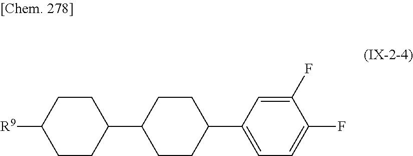

In General Formula (IX-2-4), R⁹ represents the same meaning as being in General Formula (IX).

With respect to the total content of the liquid crystal composition of the present invention, the content of the compound represented by General Formula (IX-2-4) is preferably in a range of 1% by mass to 25% by mass, in a range of 1% by mass to 20% by mass, in a range of 1% by mass to 15% by mass, in a range of 1% by mass to 12% by mass, in a range of 5% by mass to 12% by mass, and in a range of 7% by mass to 12% by mass in consideration of the solubility at low temperature, the transition temperature, the electrical reliability, and the like.

Further, the compound represented by General Formula (IX-2-4) is preferably compounds represented by formula (33.1) to formula (33.5), and is preferably the compound represented by formula (33.1) and/or formula (33.3).

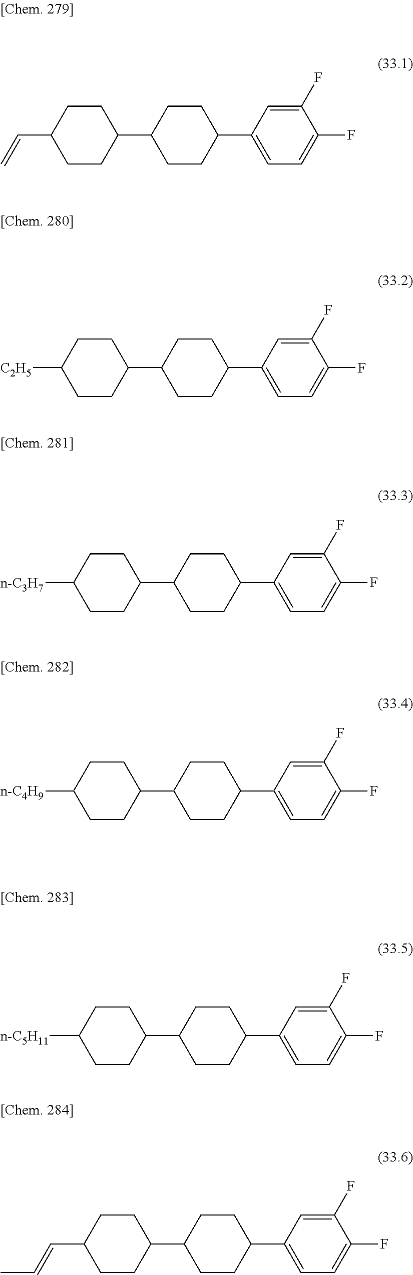

Further, the compound represented by General Formula (IX-2) according to the present invention is preferably a compound represented by General Formula (IX-2-5).

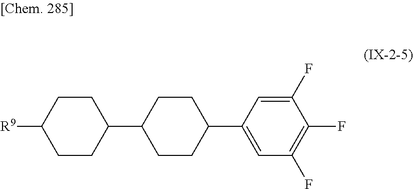

In General Formula (IX-2-5), R⁹ represents the same meaning as being in General Formula (IX).

The compounds that can be combined are not particularly limited; however, the compounds are appropriately used in combination for each embodiment in consideration of the solubility at low temperature, the transition temperature, the electrical reliability, and the birefringence. For example, the number of the types of the compounds is one in one embodiment of the present invention, two types of the compounds are combined with each other in another embodiment of the present invention, three types of the compounds are combined with each other in still another embodiment of the present invention, and four or more types of the compounds are combined with each other in still another embodiment of the present invention.

The content of the compound represented by General Formula (IX-2-5) is appropriately adjusted for each embodiment in consideration of the properties such as the solubility at low temperature, the transition temperature, the electrical reliability, and the birefringence.

For example, with respect to the total content of the liquid crystal composition of the present invention, the content of the compound represented by General Formula (IX-2-5) in one embodiment of the present invention is in a range of 1 to 40% by mass, the above-described content of the compound in another embodiment of the present invention is in a range of 1 to 35% by mass, the above-described content of the compound in still another embodiment of the present invention is in a range of 5 to 35% by mass, the above-described content of the compound in still another embodiment is in a range of 8 to 35% by mass, the above-described content of the compound in still another embodiment is in a range of 12 to 35% by mass, the above-described content of the compound in still another embodiment is in a range of 30 to 35% by mass, and the above-described content of the compound in still another embodiment is in a range of 8 to 12% by mass.

In a case where a liquid crystal composition having a fast response speed while keeping the viscosity of the liquid crystal composition of the present invention to be low is required, it is preferable that the lower limit is set to be low and the upper limit is set to be low. Further, in a case where the liquid crystal composition in which the burn-in is hard to occur while keeping the TNT of the liquid crystal composition of the present invention to be high is required, it is preferable that the lower limit is set to be low and the upper limit is set to be low. In addition, when the dielectric anisotropy is set to be large so as to keep the driving voltage to be low, it is preferable that the lower limit is set to be high and the upper limit is set to be high.

Further, the compound represented by General Formula (IX-2-5) is preferably compounds represented by formula (34.1) to formula (34.5), and is preferably the compounds represented by formula (34.1), formula (34.2), formula (34.3), and/or formula (34.5).

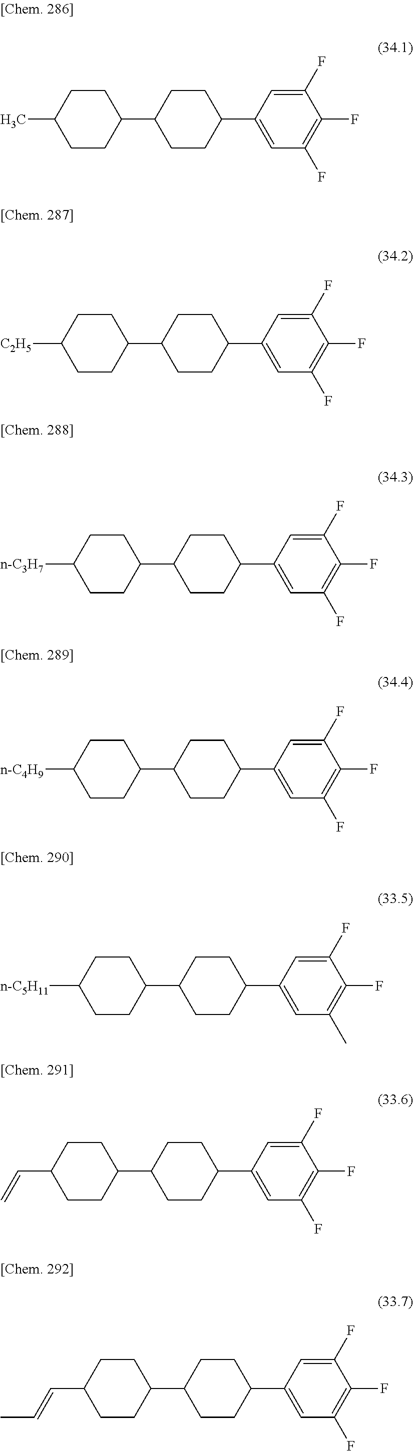

Further, the compound represented by according to the present invention General Formula (IX) is preferably a compound represented by General Formula (IX-3).

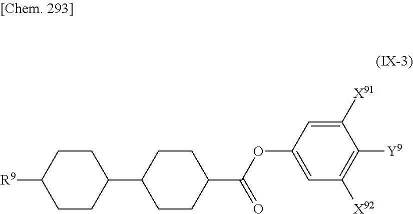

In General Formula (IX-3), R⁹, X⁹¹, and X⁹² represent the same meaning as being in General Formula (IX).

Further, the compound represented by General Formula (IX-3) is preferably a compound represented by General Formula (IX-3-1).

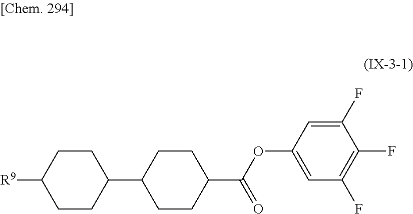

In General Formula (IX-3-1), R⁹ represents the same meaning as being in General Formula (IX).

The compounds that can be combined are not particularly limited; however, 1 or 2 types of compounds are preferably combined with each other in consideration of the solubility at low temperature, the transition temperature, the electrical reliability, and the birefringence.

With respect to the total content of the liquid crystal composition of the present invention, the content of the compound represented by General Formula (IX-3-1) is preferably in a range of 3% by mass to 30% by mass, in a range of 7% by mass to 30% by mass, in a range of 13% by mass to 20% by mass, and in a range of 15% by mass to 18% by mass in consideration of the solubility at low temperature, the transition temperature, the electrical reliability, and the like.

Further, the compound represented by General Formula (IX-3-1) is compounds represented by formula (35.1) to formula (35.4), and is preferably the compounds represented by formula (35.1) and/or formula (35.2).

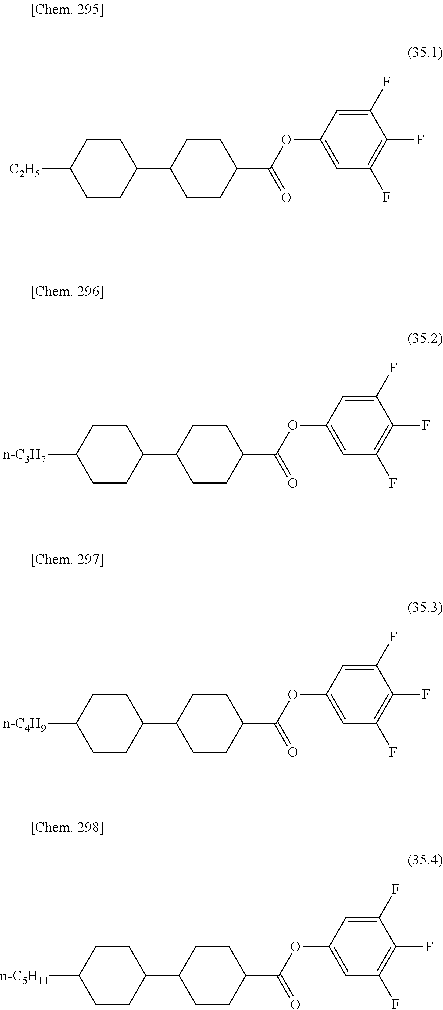

Further, the compound represented by General Formula (M) according to the present invention is preferably a compound selected from the compound group represented by General Formula (XIII).

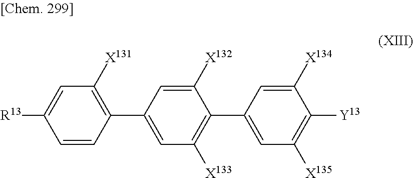

In General Formula (XIII), X¹³¹ to X¹³⁵ each independently represent a fluorine atom or a hydrogen atom, R¹³ represents an alkyl group having 1 to 5 carbon atoms, an alkenyl group having 2 to 5 carbon atoms, or an alkoxy group having 1 to 4 carbon atoms, and Y¹³ represents a fluorine atom or —OCF₃.

The compounds that can be combined are not particularly limited; however, among the compounds, one or two types of compounds are preferably contained, one to three types of compounds are further preferably contained, and one to four types of compounds are still further preferably contained.

The content of the compound represented by General Formula (XIII) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content in one embodiment of the present invention is, for example, 2%, the lower limit of the content in another embodiment of the present invention is 4%, the lower limit of the content in still another embodiment of the present invention is 5%, the lower limit of the content in still another embodiment of the present invention is 7%, the lower limit of the content in still another embodiment of the present invention is 9%, the lower limit of the content in still another embodiment of the present invention is 11%, and the lower limit of the content in still another embodiment of the present invention is 13%. Further, the lower limit of the content in still another embodiment of the present invention is 14%. Further, the lower limit of the content in still another embodiment of the present invention is 16%. Further, the lower limit of the content in still another embodiment of the present invention is 20%.

In addition, the upper limit of the content in one embodiment of the present invention is, for example, 30%, the upper limit of the content in another embodiment of the present invention is 25%, the upper limit of the content in still another embodiment of the present invention is 20%, the upper limit of the content in still another embodiment of the present invention 15%, the upper limit of the content in still another embodiment of the present invention 10%, and the upper limit of the content in still another embodiment of the present invention 5%.

In a case where the liquid crystal composition of the present invention is used as a liquid crystal display element having small cell gap, it is suitable to set the content of the compound represented by General Formula (XIII) to be increased. In a case where the liquid crystal composition of the present invention is used as a liquid crystal display element having small driving voltage, it is suitable to set the content of the compound represented by General Formula (XIII) to be increased. In addition, in a case where the liquid crystal composition of the present invention is used as a liquid crystal display element which is used in an environment with the low temperature, it is suitable to set the content of the compound represented by General Formula (XIII) to be decreased. In a case where the liquid crystal composition of the present invention is used as a liquid crystal display element having fast response speed, it is suitable to set the content of the compound represented by General Formula (XIII) to be decreased.

Further, the compound represented by according to the present invention General Formula (XIII) is preferably a compound represented by General Formula (XIII-1).

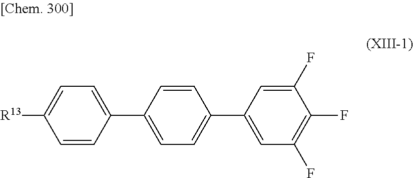

In General Formula (XIII-1), R¹³ represents an alkyl group having 1 to 5 carbon atoms, an alkenyl group having 2 to 5 carbon atoms, or an alkoxy group having 1 to 4 carbon atoms.

With respect to the total content of the liquid crystal compositions of the present invention, the content of the compound represented by General Formula (XIII-1) is preferably equal to or greater than 1% by mass, is further preferably equal to or greater than 3% by mass, is still further preferably equal to or greater than 5% by mass, and is particularly preferably equal to or greater than 10% by mass. In addition, the maximum content ratio is preferably equal to or less than 25% by mass, is further preferably equal to or less than 20% by mass, and is still further preferably equal to or less than 15% by mass.

Further, the compound represented by General Formula (XIII-1) is preferably compounds represented by formula (48.1) to formula (48.4), and is preferably a compound represented by formula (48.2).

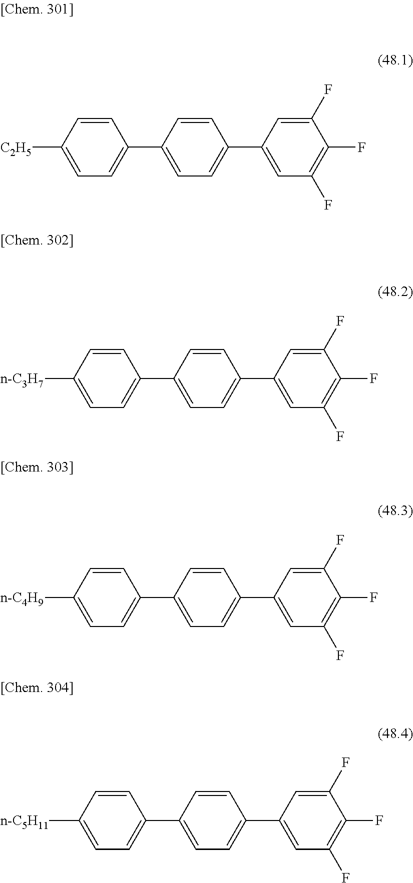

Further, the compound represented by General Formula (XIII) according to the present invention is preferably a compound represented by General Formula (XIII-2).

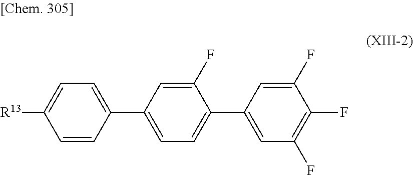

In General Formula (XIII-2), R¹³ represents an alkyl group having 1 to 5 carbon atoms, an alkenyl group having 2 to 5 carbon atoms, or an alkoxy group having 1 to 4 carbon atoms.

The compounds that can be combined are not particularly limited; however, among them, one or two or more types of compounds are preferably contained.

With respect to the total content of the liquid crystal compositions of the present invention, the content of the compound represented by General Formula (XIII-2) is preferably equal to or greater than 5% by mass, is further preferably equal to or greater than 6% by mass, is still further preferably equal to or greater than 8% by mass, and is particularly preferably equal to or greater than 10% by mass. In addition, the maximum content ratio is preferably equal to or less than 25% by mass, is further preferably equal to or less than 20% by mass, and is still further preferably equal to or less than 15% by mass.

Further, the compound represented by General Formula (XIII-2) is preferably compounds represented by formula (49.1) to formula (49.4), and is preferably the compounds represented by formula (49.1) or/and formula (49.2).

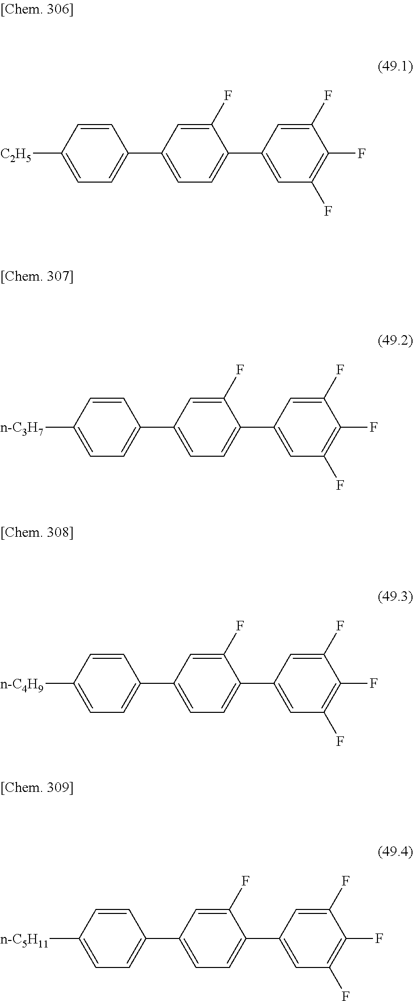

Further, the compound represented by General Formula (XIII) according to the present invention is preferably a compound represented by General Formula (XIII-3).

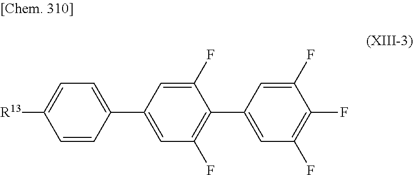

In General Formula (XIII-3), R¹³ represents an alkyl group having 1 to 5 carbon atoms, an alkenyl group having 2 to 5 carbon atoms, or an alkoxy group having 1 to 4 carbon atoms.

The compounds that can be combined are not particularly limited; however, among them, one or two types of the compounds are preferably contained.

With respect to the total content of the liquid crystal compositions of the present invention, the content of the compound represented by General Formula (XIII-3) is preferably equal to or greater than 2% by mass, is further preferably equal to or greater than 4% by mass, is still further preferably equal to or greater than 9% by mass, and particularly preferably equal to or greater than 11% by mass. In addition, the maximum content ratio is preferably equal to or less than 20% by mass, is further preferably equal to or less than 17% by mass, and is still further preferably equal to or less than 14% by mass.

Further, the compound represented by General Formula (XIII-3) is preferably compounds represented by formula (50.1) to formula (50.4), and is preferably the compounds represented by formula (50.1) or/and formula (50.2).

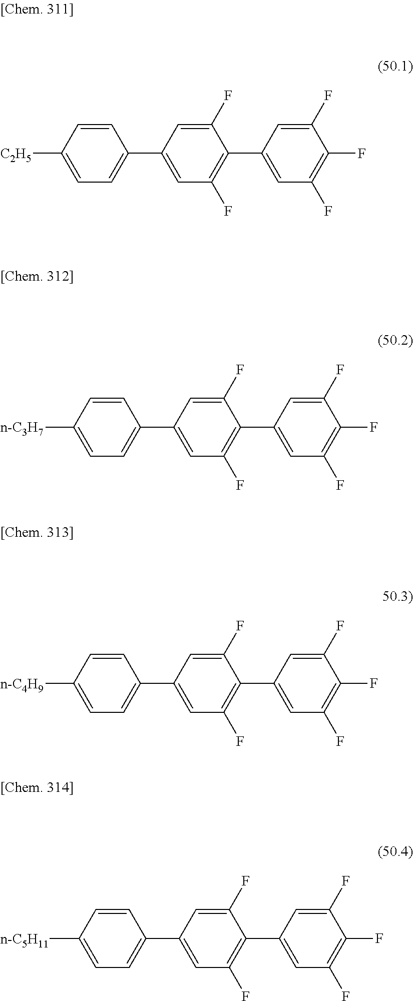

Further, the compound represented by General Formula (M) according to the present invention is preferably a compound selected from the compound group represented by General Formula (XIV).

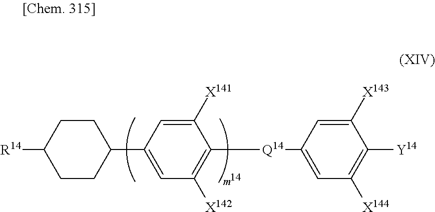

In General Formula (XIV), R¹⁴ represents an alkyl group having 1 to 7 carbon atoms, an alkenyl group having 2 to 7 carbon atoms, or an alkoxy group having 1 to 7 carbon atoms, X¹⁴¹ to X⁴⁴ each independently represent a fluorine atom or a hydrogen atom, Y¹⁴ represents a fluorine atom, a chlorine atom, or —OCF₃, Q¹⁴ represents a single bond, —COO—, or —CF₂O—, and m¹⁴ represents 0 or 1.

The compounds that can be combined are not particularly limited; however, the compounds are appropriately combined with each other for each embodiment in consideration of the solubility at low temperature, the transition temperature, the electrical reliability, and the birefringence. For example, the number of the types of the compound is one in one embodiment of the present invention. Further, the number of the types of the compound is two in another embodiment of the present invention. Further, the number of the types of the compound is three in another embodiment of the present invention. Further, the number of the types of the compound is four in still another embodiment of the present invention. Further, the number of the types of the compound is five in still another embodiment of the present invention. Further, the number of the types of the compound is six or more in still another embodiment of the present invention.

The content of the compound represented by General Formula (XIV) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content in one embodiment of the present invention is, for example, 3%, the lower limit of the content in another embodiment of the present invention is 7%, the lower limit of the content in still another embodiment of the present invention is 8%, the lower limit of the content in still another embodiment of the present invention is 11%, the lower limit of the content in still another embodiment of the present invention is 12%, the lower limit of the content in still another embodiment of the present invention is 16%, and the lower limit of the content in still another embodiment of the present invention is 18%. Further, the lower limit of the content in still another embodiment of the present invention is 19%. Further, the lower limit of the content in still another embodiment of the present invention is 22%. Further, the lower limit of the content in still another embodiment of the present invention is 25%.

In addition, the upper limit of the content in one embodiment of the present invention is, for example, 40%, the upper limit of the content in another embodiment of the present invention is 35%, the upper limit of the content in still another embodiment of the present invention is 30%, the upper limit of the content in still another embodiment of the present invention is 25%, the upper limit of the content in still another embodiment of the present invention is 20%, and the upper limit of the content in still another embodiment of the present invention is 15%.

In a case where the liquid crystal composition of the present invention is used as a liquid crystal display element having small driving voltage, it is suitable to set the content of the compound represented by General Formula (XIV) to be increased. In addition, in a case where the liquid crystal composition of the present invention is used as a liquid crystal display element having fast response speed, it is suitable to set the content of the compound represented by General Formula (XIV) to be decreased.

Further, the compound represented by General Formula (XIV) according to the present invention is preferably a compound represented by General Formula (XIV-1).

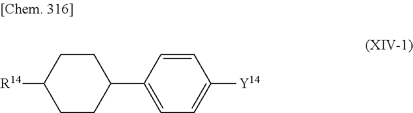

In General Formula (XIV-1), R¹⁴ represents an alkyl group having 1 to 7 carbon atoms, an alkenyl group having 2 to 7 carbon atoms, or an alkoxy group having 1 to 7 carbon atoms, and Y¹⁴ represents a fluorine atom, a chlorine atom, or —OCF₃.

The compounds that can be combined are not particularly limited; however, one to three types of compounds are preferably combined with each other in consideration of the solubility at low temperature, the transition temperature, the electrical reliability, and the birefringence.

Further, the compound represented by General Formula (XIV-1) is preferably a compound represented by General Formula (XIV-1-1).

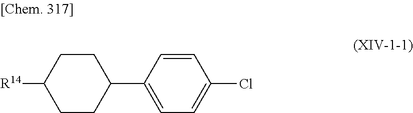

In General Formula (XIV-1), R¹⁴ represents an alkyl group having 1 to 7 carbon atoms, an alkenyl group having 2 to 7 carbon atoms, or an alkoxy group having 1 to 7 carbon atoms.

With respect to the total content of the liquid crystal compositions of the present invention, the content of the compound represented by General Formula (XIV-1) is preferably equal to or greater than 2% by mass, is further preferably equal to or greater than 4% by mass, is still further preferably equal to or greater than 7% by mass, is still further preferably equal to or greater than 10% by mass, and is particularly preferably equal to or greater than 18% by mass. In addition, the maximum ratio is preferably set to be equal to or less than 30% by mass, is further preferably equal to or less than 27% by mass, is still further preferably equal to or less than 24% by mass, and is particularly less than 21% by mass in consideration of the solubility at low temperature, the transition temperature, the electrical reliability, and the like.

Further, the compound represented by General Formula (XIV-1-1) is preferably compounds represented by formula (51.1) to formula (51.4), and is further preferably the compound represented by formula (51.1).

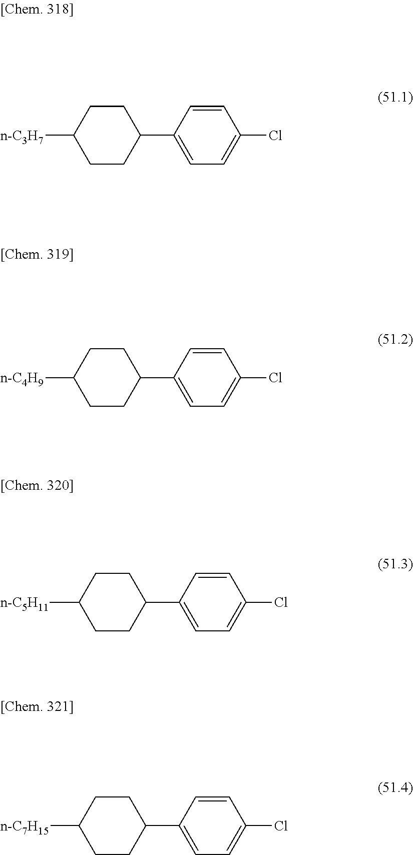

Further, the compound represented by General Formula (XIV-1) is preferably a compound represented by General Formula (XIV-1-2).

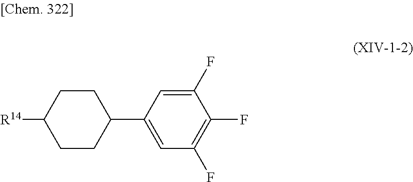

In General Formula (XIV-1-2), R¹⁴ represents an alkyl group having 1 to 7 carbon atoms, an alkenyl group having 2 to 7 carbon atoms, or an alkoxy group having 1 to 7 carbon atoms.

With respect to the total content of the liquid crystal compositions of the present invention, the content of the compound represented by General Formula (XIV-1-2) is preferably equal to or greater than 1% by mass, is further preferably equal to or greater than 3% by mass, is still further preferably equal to or greater than 5% by mass, and is particularly preferably equal to or greater than 7% by mass. In addition, the maximum ratio is preferably set to be equal to or less than 15% by mass, is further preferably equal to or less than 13% by mass, is still further preferably equal to or less than 11% by mass, and is particularly preferably less than 9% by mass in consideration of the solubility at low temperature, the transition temperature, the electrical reliability, and the like.

Further, the compound represented by General Formula (XIV-1-2) is preferably compounds specifically represented by formula (52.1) to formula (52.4), and among them, the compound represented by formula (52.4) is preferably contained.

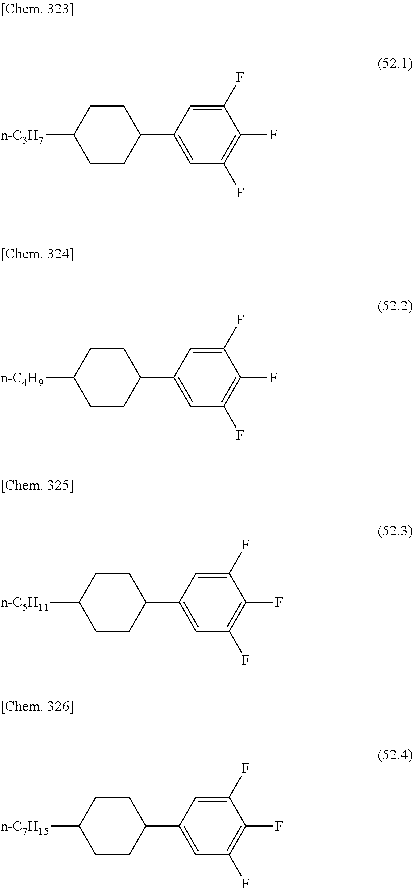

Further, the compound represented by General Formula (XIV) according to the present invention is preferably a compound represented by General Formula (XIV-2).

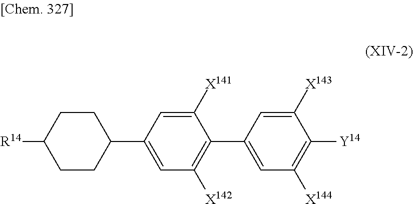

In General Formula (XIV-2), R¹⁴ represents an alkyl group having 1 to 5 carbon atoms, an alkenyl group having 2 to 5 carbon atoms, or an alkoxy group having 1 to 4 carbon atoms, X¹⁴¹ to X¹⁴⁴ each independently represent a fluorine atom or a hydrogen atom, and Y¹⁴ represents a fluorine atom, a chlorine atom, or —OCF₃.

The compounds that can be combined are not particularly limited; however, the compounds are appropriately combined with each other for each embodiment in consideration of the solubility at low temperature, the transition temperature, the electrical reliability, and the birefringence. For example, the number of the types of the compounds is one in one embodiment of the present invention. Further, the number of the types of the compounds is two in another embodiment of the present invention. Further, the number of the types of the compounds is three in still another embodiment of the present invention. Further, the number of the types of the compounds is four in still another embodiment of the present invention. Further, the number of the types of the compounds is five or more in still another embodiment of the present invention.

The content of the compound represented by General Formula (XIV-2) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content in one embodiment of the present invention is, for example, 3%, the lower limit of the content in another embodiment of the present invention is 7%, the lower limit of the content in still another embodiment of the present invention is 8%, the lower limit of the content in still another embodiment of the present invention is 10%, the lower limit of the content in still another embodiment of the present invention is 11%, the lower limit of the content in still another embodiment of the present invention is 12%, and the lower limit of the content in still another embodiment of the present invention is 18%. Further, the lower limit of the content in still another embodiment of the present invention is 19%. Further, the lower limit of the content in still another embodiment of the present invention is 21%. Further the lower limit of the content in still another embodiment of the present invention is 22%.

In addition, the upper limit of the content in one embodiment of the present invention is, for example, 40%, the upper limit of the content in another embodiment of the present invention is 35%, the upper limit of the content in still another embodiment of the present invention is 25%, the upper limit of the content in still another embodiment of the present invention is 20%, the upper limit of the content in still another embodiment of the present invention is 15%, and the upper limit of the content in still another embodiment of the present invention is 10%.

In a case where the liquid crystal composition of the present invention is used as a liquid crystal display element having small driving voltage, it is suitable to set the content of the compound represented by General Formula (XIV-2) to be increased. In a case where the liquid crystal composition of the present invention is used as a liquid crystal display element having fast response speed, it is suitable to set the content of the compound represented by General Formula (XIV-2) to be decreased.

Further, the compound represented by General Formula (XIV-2) according to the present invention is preferably a compound represented by General Formula (XIV-2-1).

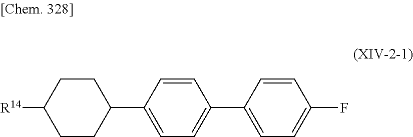

In General Formula (XIV-2-1), R¹⁴ represents an alkyl group having 1 to 5 carbon atoms, an alkenyl group having 2 to 5 carbon atoms, or an alkoxy group having 1 to 4 carbon atoms.

With respect to the total content of the liquid crystal compositions of the present invention, the content of the compound represented by General Formula (XIV-2-1) is preferably equal to or greater than 1% by mass, is further preferably equal to or greater than 3% by mass, is still further preferably equal to or greater than 5% by mass, and is particularly preferably equal to or greater than 7% by mass. Further, the maximum ratio is preferably set to be equal to or less than 15% by mass, is further preferably equal to or less than 13% by mass, is still further preferably equal to or less than 11% by mass, and is particularly less than 9% by mass in consideration of the solubility at low temperature, the transition temperature, the electrical reliability, and the like.

Further, the compound represented by General Formula (XIV-2-1) is preferably compounds specifically represented by formula (53.1) to formula (53.4), and among them, the compound represented by formula (53.4) is preferably contained.

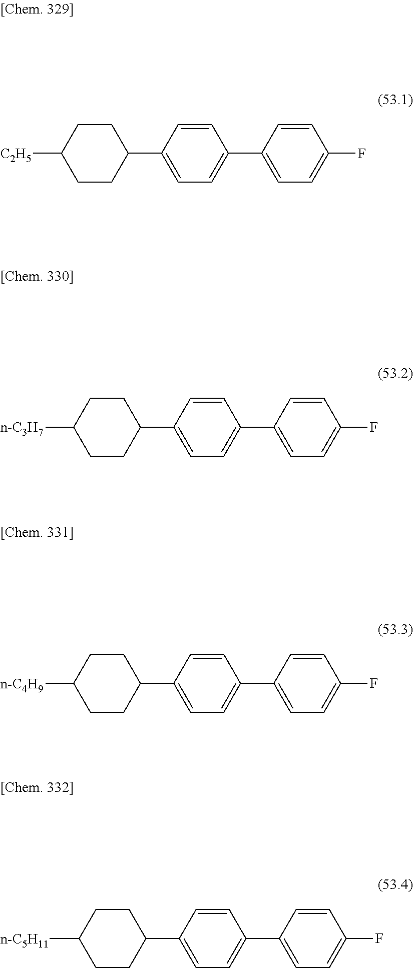

Further, the compound represented by General Formula (XIV-2) is preferably a compound represented by General Formula (XIV-2-2).

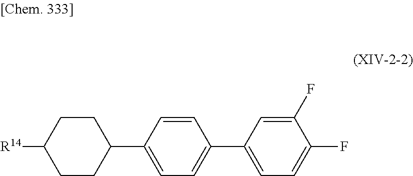

In General Formula (XIV-2-2), R¹⁴ represents an alkyl group having 1 to 5 carbon atoms, an alkenyl group having 2 to 5 carbon atoms, or an alkoxy group having 1 to 4 carbon atoms.

With respect to the total content of the liquid crystal compositions of the present invention, the content of the compound represented by General Formula (XIV-2-2) is preferably equal to or greater than 3% by mass, is further preferably equal to or greater than 6% by mass, is still further preferably equal to or greater than 9% by mass, and is particularly preferably equal to or greater than 12% by mass. In addition, the maximum ratio is preferably set to be equal to or less than 20% by mass, is further preferably equal to or less than 17% by mass, is still further preferably equal to or less than 15% by mass, and is particularly equal to or less than 14% by mass in consideration of the solubility at low temperature, the transition temperature, the electrical reliability, and the like.

Further, the compound represented by General Formula (XIV-2-2) is preferably compounds specifically represented by formula (54.1) to formula (54.4), and among them, the compounds represented by formula (54.2) and/or formula (54.4) are preferably contained.

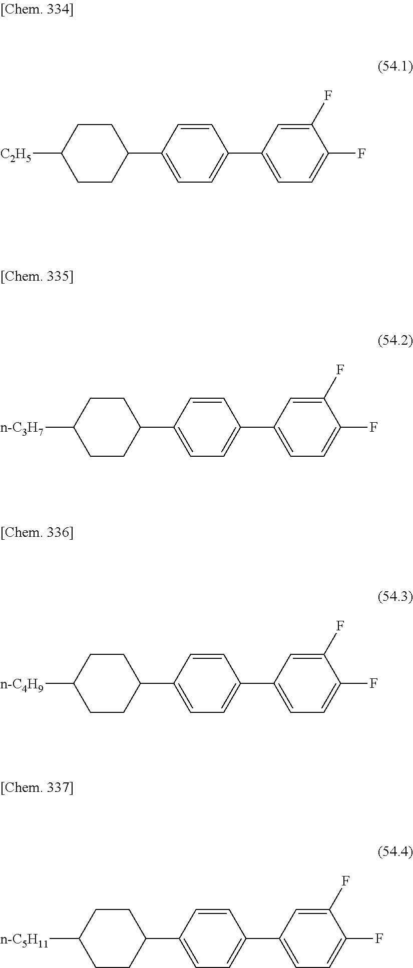

Further, the compound represented by General Formula (XIV-2) is preferably a compound represented by General Formula

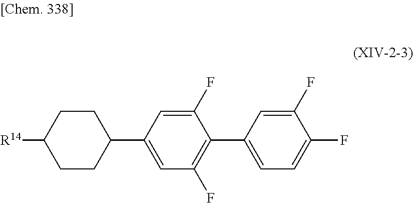

In General Formula (XIV-2-3), R¹⁴ represents an alkyl group having 1 to 5 carbon atoms, an alkenyl group having 2 to 5 carbon atoms, or an alkoxy group having 1 to 4 carbon atoms.

With respect to the total content of the liquid crystal compositions of the present invention, the content of the compound represented by General Formula (XIV-2-3) is preferably equal to or greater than 5% by mass, is further preferably equal to or greater than 9% by mass, is particularly preferably equal to or greater than 12% by mass. In addition, the maximum ratio is preferably set to be equal to or less than 30% by mass, is further preferably less than 27% by mass, is still further preferably equal to or less than 24% by mass, and is preferably less than 20% by mass in consideration of the solubility at low temperature, the transition temperature, the electrical reliability, and the like.

Further, the compound represented by General Formula (XIV-2-3) is preferably compounds specifically represented by formula (55.1) to formula (55.4), among them, the compounds represented by formula (55.2) and/or formula (55.4) are preferably contained.

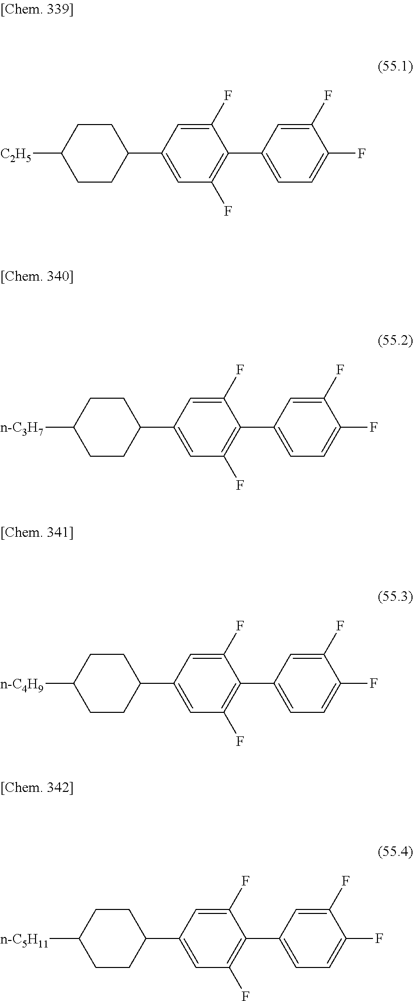

Further, the compound represented by General Formula (XIV-2) is preferably a compound represented by General Formula (XIV-2-4).

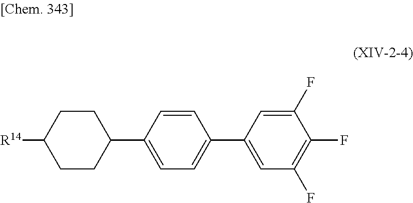

In General Formula (XIV-2-4), R¹⁴ represents an alkyl group having 1 to 5 carbon atoms, an alkenyl group having 2 to 5 carbon atoms, or an alkoxy group having 1 to 4 carbon atoms.

The compounds that can be combined are not particularly limited; however, the compounds are appropriately combined with each other for each embodiment in consideration of the solubility at low temperature, the transition temperature, the electrical reliability, and the birefringence. For example, the number of the types of the compounds is one in one embodiment of the present invention. Further, the number of the types of the compounds is two in another embodiment of the present invention. Further, the number of the types of the compounds is three or more in still another embodiment of the present invention.

The content of the compound represented by General Formula (XIV-2-4) has the upper limit and the lower limit for each embodiment in consideration of the properties such as the solubility at low temperature, the transition temperature, the electrical reliability, and the birefringence. With respect to the total content of the liquid crystal compositions of the present invention, the lower limit of the content in one embodiment of the present invention is, for example, 2%, the lower limit of the content in another embodiment of the present invention is 5%, the lower limit of the content in still another embodiment of the present invention is 8%, the lower limit of the content in still another embodiment of the present invention is 9%, the lower limit of the content in still another embodiment of the present invention is 10%, the lower limit of the content in still another embodiment of the present invention is 18%, and the lower limit of the content in still another embodiment of the present invention is 21%. Further, the lower limit of the content in still another embodiment of the present invention is 22%. Further, the lower limit of the content in still another embodiment of the present invention is 24%.

In addition, the upper limit of the content in one embodiment of the present invention is, for example, 35%, the upper limit of the content in another embodiment of the present invention is 30%, the upper limit of the content in still another embodiment of the present invention is 25%, the upper limit of the content in still another embodiment of the present invention is 20%, the upper limit of the content in still another embodiment of the present invention is 15%, and the upper limit of the content in still another embodiment of the present invention is 10%.

In a case where the liquid crystal composition of the present invention is used as a liquid crystal display element having small driving voltage, it is suitable to set the content of the compound represented by General Formula (XIV-2-4) to be increased. In addition, in a case where the liquid crystal composition of the present invention is used as a liquid crystal display element having fast response speed, it is suitable to set the content of the compound represented by General Formula (XIV-2-4) to be decreased.

Further, the compound represented by General Formula (XIV-2-4) is preferably compounds represented by formula (56.1) to formula (56.4), and among them, the compounds represented by formula (56.1), formula (56.2), and formula (56.4) are preferably contained.

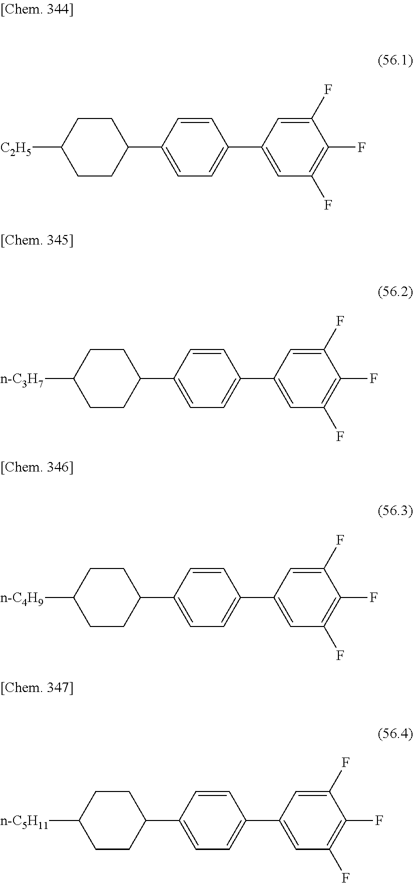

Further, the compound represented by General Formula (XIV-2) is preferably a compound represented by General Formula (XIV-2-5).

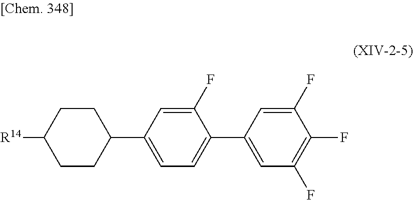

In General Formula (XIV-2-5), R¹⁴ represents an alkyl group having 1 to 5 carbon atoms, an alkenyl group having 2 to 5 carbon atoms, or an alkoxy group having 1 to 4 carbon atoms.

With respect to the total content of the liquid crystal compositions of the present invention, the content of the compound represented by General Formula (XIV-2-5) is preferably equal to or greater than 5% by mass, is further preferably equal to or greater than 10% by mass, and is particularly preferably equal to or greater than 13% by mass. In addition, the maximum ratio is preferably set to be equal to or less than 25% by mass, is further preferably less than 22% by mass, is still further preferably equal to or less than 18% by mass, and is particularly less than 15% by mass in consideration of the solubility at low temperature, the transition temperature, the electrical reliability, and the like.

Further, specific examples of the compound represented by General Formula (XIV-2-5) include compounds represented by formulas (57.1) to (57.4). Among them, the compound represented by formula (57.1) is preferably contained.

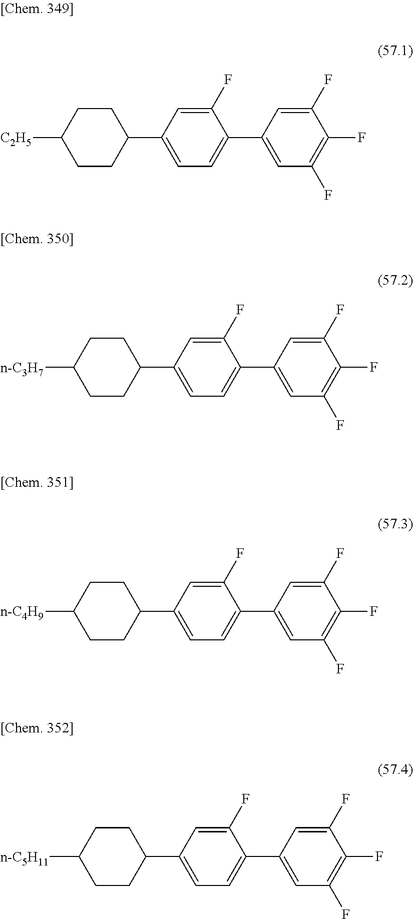

Further, the compound represented by General Formula (XIV-2) is preferably a compound represented by General Formula (XIV-2-6).

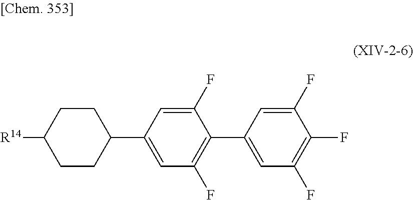

In the formula, R¹⁴ represents an alkyl group having 1 to 5 carbon atoms, an alkenyl group having 2 to 5 carbon atoms, or an alkoxy group having 1 to 4 carbon atoms.

With respect to the total content of the liquid crystal compositions of the present invention, the content of the compound represented by General Formula (XIV-2-6) is preferably equal to or greater than 5% by mass, is further preferably equal to or greater than 10% by mass, and is particularly preferably equal to or greater than 15% by mass. In addition, the maximum ratio is preferably set to be equal to or less than 25% by mass, is further preferably equal to or less than 22% by mass, is still further preferably equal to or less than 20% by mass, and is particularly less than 17% by mass in consideration of the solubility at low temperature, the transition temperature, the electrical reliability, and the like.

Further, the compound represented by General Formula (XIV-2-6) is preferably compounds represented by formula (58.1) to formula (58.4), and among them, the compound represented by formula (58.2) is preferably contained.

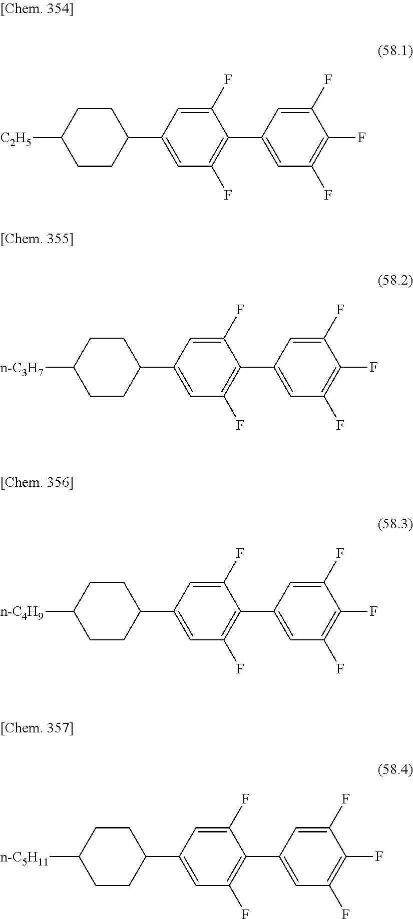

The compound used in the invention of the present application does not contain a peracid (—CO—OO—) structure in the molecule. Further, in a case where emphasis is placed on the reliability and long-term stability of the liquid crystal composition, it is preferable that the compound having a carbonyl group is not used. In addition, in a case where emphasis is placed on the stability by UV irradiation, it is preferable to use a compound which is substituted with a chlorine atom. It is also preferable to use a compound in which all the ring structures in the molecule are 6-membered rings.

As a preferred embodiment of the liquid crystal composition according to the present invention, as the first component, at least two types of compounds are preferably selected, and three types of compounds are further preferably selected from the compound group represented by the following General Formula (I-1) and General Formula (I-0):

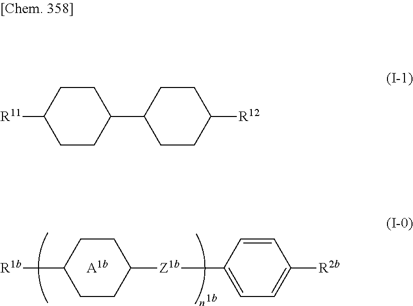

In General Formula (Ia) and (Ib), R^{1a} and R^{2a} each independently represent the same meaning as that of R¹ and R² in General Formula (I), R^{1b} and R^{2b} each independently represent the same meaning as that of R¹ and R² in General Formula (I), n^{1b} represents 1 or 2, A^{1b} represents the same meaning as that of A¹ in General Formula (I), and Z^{1b} represents the same meaning as that of Z¹ in General Formula (I).

In addition, with respect to the total contents of the liquid crystal composition, the content of at least two compounds selected the compound group represented by General Formula (I-1) and General Formula (I-0) is preferably in a range of 30 to 99% by mass, is further preferably in a range of 35 to 98% by mass, is still further preferably in a range of 40 to 97% by mass, is still further preferably equal to or less than 96% by mass, and is particularly preferably in a range of 89 to 95% by mass.

When the combination of General Formula (I-1) and General Formula (I-0) occupies 85% to 99% with respect to the entire liquid crystal composition, an effect of the high-speed responsiveness is exhibited, and when the aforementioned combination is used together with the combination of the second components described later, the compatibility is improved in terms of the chemical structure or specificity, and it is possible to suppress/prevent the problem of deposition of the liquid crystal compound so as to improve storage stability.

The second component according to the present invention is preferably formed of the 4-ring compound represented by General Formula (X), and the stability at low temperature is more improved as compared with a case where the 3-ring compound as represented by General Formula (VIII), General Formula (IX), General Formula (XIII), and General Formula (XIV) is contained in the composition.

As a preferred embodiment of the liquid crystal composition according to the present invention, as the second component, at least two types of the compounds from the compound group represented by the following General Formula (IIa) and General Formula (IIb):

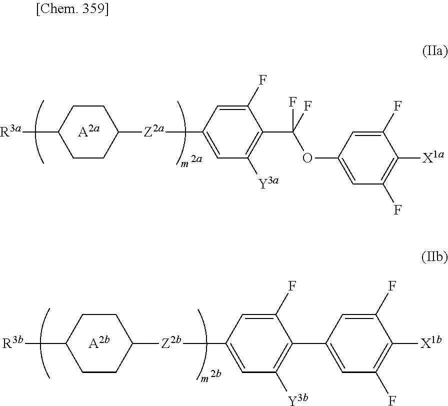

are preferably selected.

In addition, with respect to the entire content of the liquid crystal composition, the total content of at least two compounds selected from the compound group represented by General Formula (IIa) and General Formula (IIb) is preferably in a range of 2 to 60% by mass, is further preferably in a range of 4 to 50% by mass, is still further preferably in a range of 5 to 35% by mass, is still further preferably in a range of 6 to 30% by mass, and is particularly preferably in a range of 7 to 28% by mass.

When the combination of General Formula (IIa) and General Formula (IIb) occupies 2 to 60% with respect to the entire liquid crystal composition, an effect of improving Δn and securing drivable Δ∈ is exhibited, and when the aforementioned combination is used together with the suitable combination of the first component, it is possible to maintain the high-speed responsiveness from the aspect that the total content of the first component of equal to or greater than 40% by mass is contained. Further, the combination of General Formula (IIa) or General Formula (IIb) with General Formula (I-1) or General Formula (I-0) specifically improves the compatibility between the compounds of the components of the liquid crystal composition, and thus the storage stability of the liquid crystal composition is improved, thereby suppressing/preventing the problem of the deposition of the liquid crystal compound.

That is, in the liquid crystal composition according to the present invention, if at least two types of the compounds are selected from the compound group represented by General Formula (I-1) and General Formula (I-0) as the first component, and at least two types of the compounds are selected from the compound group represented by General Formula (IIa) and General Formula (IIb) as the second component, it is possible to solve the problem relating to the stability at low temperature in that a liquid crystal compound precipitates, and the problem of the drip mark. In addition, it is possible to achieve the effect of maintaining the high-speed responsiveness.

The liquid crystal composition according to the present invention may contain a polymerizable compound, in order to manufacture a PSA mode or a transverse electric field type PSA mode liquid crystal display element. Examples of the available polymerizable compound include a photopolymerizable monomer which performs polymerization by energy rays such as light, such as a polymerizable compound having a structure of a liquid crystal skeleton in which a plurality of six-membered rings such as a biphenyl derivative and a terphenyl derivative are linked. More specifically, a bifunctional monomer represented by General Formula (XX) is preferably used.

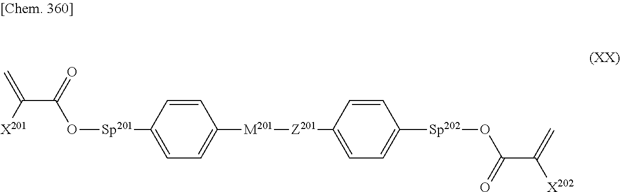

In General Formula (XX), X²⁰¹ and X²⁰² each independently represent a hydrogen atom or an alkyl group 1 to 3 carbon atoms (a methyl group, an ethyl group, and a propyl group),

Sp²⁰¹ and Sp²⁰² each independently represent a single bond, an alkylene group having 1 to 8 carbon atoms, or —O—(CH₂)ₛ— (in the formula, s represents an integer in a range of 2 to 7, and an oxygen atom is bonded to an aromatic ring),
Z²⁰¹ represents —OCH₂—, —CH₂O—, —COO—, —OCO—, —CF₂O—, —OCF₂—, —CH₂CH₂—, —CF₂CF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CY¹═CY²— (in the formula, Y¹ and Y² each independently represent a fluorine atom or a hydrogen atom), —C≡C—, or a single bond,
M²⁰¹ represents a trans-1,4-cyclohexylene group, a single bond or a 1,4-phenylene group in which an optional hydrogen atom may be substituted with a fluorine atom, and
in all of the 1,4-phenylene groups in General Formula (XX), an optional hydrogen atom may be substituted with a fluorine atom.

A form of the polymerizable compound according to the present invention is preferably a diacrylate derivative in which all of X²⁰¹ and X²⁰² represent a hydrogen atom or a dimethacrylate derivative in which all of X²⁰¹ and X²⁰² have a methyl group, or is preferably compounds in which one represents a hydrogen atom and the other one represents a methyl group. Regarding the polymerization rate of the compounds, the diacrylate derivative is the fastest, the diacrylate derivative is slow, the asymmetric compound is intermediate, and the preferred embodiment can be used depending on its use. As the PSA display element, the dimethacrylate derivative is particularly preferable.

Sp²⁰¹ and Sp²⁰² each independently represent a single bond, an alkylene group having 1 to 8 carbon atoms or —O—(CH₂)ₛ—; however, in the PSA display element, at least one is preferably a single bond, and a compound in which Sp²⁰¹ and Sp²⁰² represent a single bond, or the compounds in which one represents a single bond and the other one represents an alkylene group having 1 to 8 carbon atoms or —O—(CH₂)ₛ— is preferable. In this case, an alkylene group having 1 to 4 carbon atoms is further preferable, and s is preferably in a range of 1 to 4.

Z²⁰¹ is preferably —OCH₂—, —CH₂O—, —COO—, —OCO—, —CF₂O—, —OCF₂—, —CH₂CH₂—, —CF₂CF₂—, or a single bond, is further preferably —COO—, —OCO—, or a single bond, and is particularly preferably a single bond.

M²⁰¹ represents a 1,4-phenylene group in which an optional hydrogen atom may be substituted with a fluorine atom, a trans-1,4-cyclohexylene group, or a single bond; however, a 1,4-phenylene group in which any hydrogen atom may be substituted with a fluorine atom, or a single bond is preferable. In a case where M²⁰¹ represents a ring structure other than a single bond, Z²⁰¹ is preferably a linking group other than a single bond, and in a case where M²⁰¹ represents a single bond, Z²⁰¹ is preferably a single bond.

From this aspect, in General Formula (XX), a ring structure between Sp²⁰¹ and Sp²⁰² is preferably a structure of formula (XXa-1) to formula (XXa-5) which are specifically described below.

In General Formula (XX), in a case where M²⁰¹ represents a single bond, and a ring structure is formed of two rings, it is preferable to represent the following formula (XXa-1) to formula (XXa-5), and further preferable to represent formula (XXa-1) to formula (XXa-3), and particularly preferable to represent formula (XXa-1).

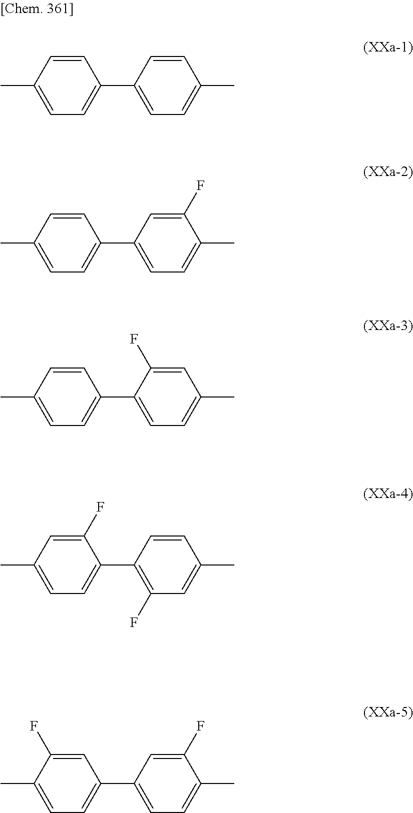

In the above-described formula (XXa-1) to formula (XXa-5), both ends of the bond are set to be bonded to Sp²⁰¹ or Sp²⁰².

From the aspect that the alignment regulating force after polymerization of the polymerizable compound having such skeletons is optimal for a PSA type liquid crystal display element, and thus a good alignment state can be obtained, the display unevenness is suppressed, or no display unevenness occurs at all.

As described above, the polymerizable compound is preferably at least one compound selected from the compound group represented by General Formula (XX-1) to General Formula (XX-4), and among them, the compound represented by General Formula (XX-2) is further preferable.

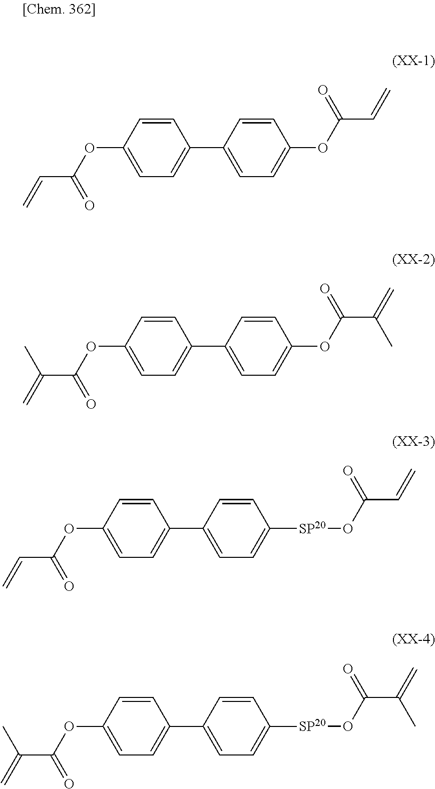

In General Formula (XX-3) and General Formula (XX-4), Sp²⁰ represents an alkylene group having 2 to 5 carbon atoms.

In a case where the polymerizable compound is added to the liquid crystal composition according to the present invention, the polymerization is performed even in a case of a polymerization initiator is not present; however, in order to promote the polymerization, the polymerization initiator may be contained. Examples of the polymerization initiator include benzoin ethers, benzophenones, acetophenones, benzil ketals, and acylphosphine oxides.

The liquid crystal composition according to the present invention can further contain the compound represented by General Formula (Q) as an antioxidant.

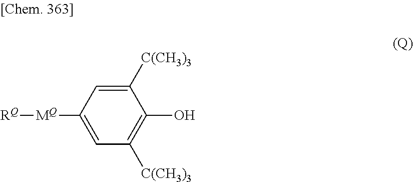

In General Formula (Q), R^{Q} represents an alkyl group having 1 to 22 carbon atoms or an alkoxy group, one or more CH₂ groups in the alkyl group may be substituted with —O—, —CH═CH—, —CO—, —OCO—, —COO—, —C≡C—, —CF₂O—, or —OCF₂— so as not to directly adjacent to the oxygen atom, and M^{Q} represents a trans-1,4-cyclohexylene group, a 1,4-phenylene group, or a single bond.

In General Formula (Q), R^{Q} is preferably an alkyl group having 1 to 22 carbon atoms or an alkoxy group having 1 to 22 carbon atoms, and the alkyl group (containing an alkyl group in the alkoxy group) may be a linear or branched chain. In addition, the R^{Q} represents a linear or branched chain alkyl group having 1 to 22 carbon atoms or a linear or branched chain alkoxy group having 1 to 22 carbon atoms, and one or more CH₂ groups among the alkyl groups (containing an alkyl group in the alkoxy group) may be substituted with —O—, —CH═CH—, —CO—, —OCO—, —COO—, —C≡C—, —CF₂O—, or —OCF₂— so as not to directly adjacent to the oxygen atom. In General Formula (Q), R^{Q} is preferably at least one having 1 to 20 carbon atoms, which is selected from the group consisting of a linear alkyl group, a linear alkoxy group, a linear alkyl group in which one CH₂ group is substituted with —OCO— or —COO—, a branched chain alkyl group, a branched chain alkoxy group, and a branched chain alkyl group in which one CH₂ group is substituted with —OCO— or —COO—, and is further preferably at least one selected from the group consisting of a linear alkyl group, a linear alkyl group in which one CH₂ group is substituted with —OCO— or —COO—, a branched chain alkyl group, a branched chain alkoxy group, and a branched chain alkyl group in which one CH₂ group is substituted with —OCO— or —COO—, each having 1 to 10 carbon atoms.

M^{Q} represents a trans-1,4-cyclohexylene group, a 1,4-phenylene group, or a single bond; however, the trans-1,4-cyclohexylene group or the 1,4-phenylene group is preferable.

The compound represented by General Formula (Q) is preferably at least one compound selected from the compound group represented by General Formula (Q-a) to General Formula (Q-d) described as follows, and is further preferably the compounds represented by General Formula (Q-a) and/or (Q-c)

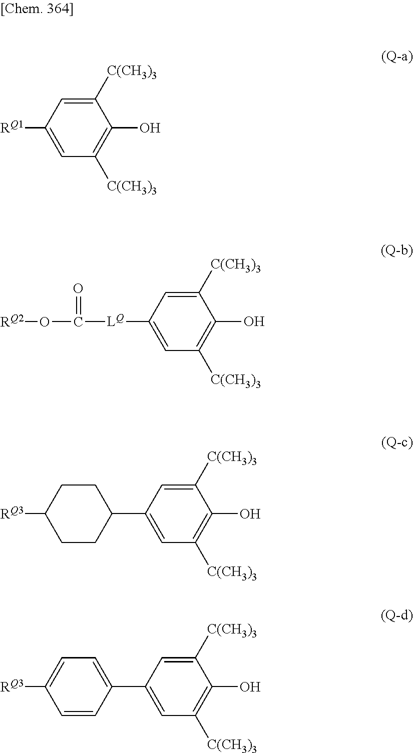

In General Formula (Q-a) to formula (Q-d), R^{Q1} is preferably a linear alkyl group or a branched chain alkyl group, each having 1 to 10 carbon atoms, R^{Q2} is preferably a linear alkyl group or a branched chain alkyl group, each having 1 to 20 carbon atoms, R^{Q3} is preferably a linear alkyl group, a branched chain alkyl group, a linear alkoxy group, or a branched chain alkoxy group, each having 1 to 8 carbon atoms, and L^{Q} is preferably a linear alkylene group or a branched chain alkylene group, each having 1 to 8 carbon atoms. Among them, the compound represented by General Formula (Q) is preferably compounds represented by formula (Q-a-1) and/or (Q-c-1) described as follows.

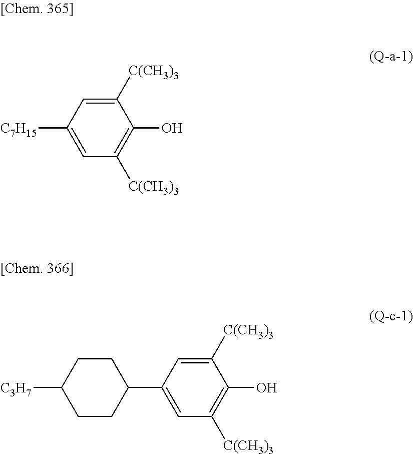

The liquid crystal composition of the invention of the present application preferably contains one or two types of the compounds represented by General Formula (Q), and further preferably contains one to five types of the compounds. The content thereof is preferably in a range of 0.001 to 1% by mass, in a range of 0.001 to 0.1% by mass, and in a range of 0.001 to 0.05% by mass with respect to the total content of the liquid crystal composition of the present invention.

(Liquid Crystal Display Element)

The above-described liquid crystal composition of the present invention is applied to the FFS mode liquid crystal display element. Hereinafter, an example of the FFS mode liquid crystal display element according to the present invention will be described with reference to FIG. 1 to FIG. 8.

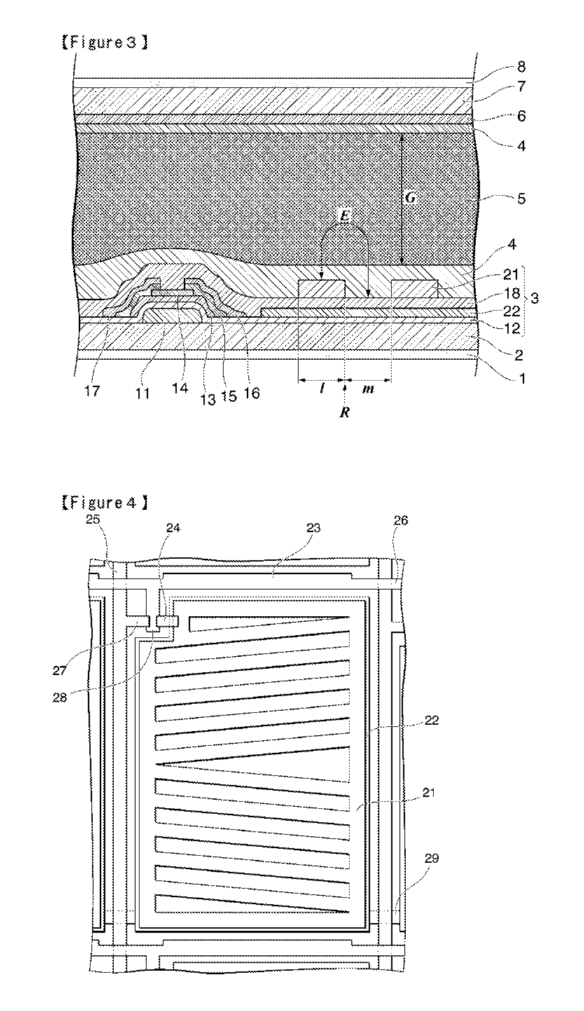

FIG. 1 is a diagram schematically showing an example of a configuration of the liquid crystal display element of the present invention. For the sake of convenience, FIG. 1 illustrates the constituent elements which are separately disposed from each other. As illustrated in FIG. 1, the liquid crystal display element 10 according to the present invention is configured such that an FFS mode liquid crystal display element includes a liquid crystal composition (or liquid crystal layer 5) which is interposed between a first transparent insulating substrate 2 and a second transparent insulating substrate 7 disposed so as to face each other, and has a feature of using the liquid crystal composition of the present invention as the p-type liquid crystal composition. The first transparent insulating substrate 2 includes an electrode layer 3 which is formed on the surface on the liquid crystal layer 5 side. In addition, the liquid crystal display element 10 also includes a pair of alignment films 4 for inducing homogeneous alignment in direct contact with the liquid crystal composition forming the liquid crystal layer 5 between the liquid crystal layer 5 and each of the first transparent insulating substrate 2 and the second transparent insulating substrate 7, and the liquid crystal molecules in the liquid crystal composition are aligned to be substantially parallel with respect to the substrates 2 and 7 when no voltage is applied. As shown in FIG. 1 and FIG. 3, the second substrate 2 and the first substrate 7 may be interposed between a pair of polarizing plates 1 and 8. Furthermore, in FIG. 1, a color filter 6 is provided between the second substrate 7 and the alignment film 4.

That is, the liquid crystal display element 10 according to the present invention is formed by sequentially laminating the first polarizing plate 1, the first substrate 2, the electrode layer 3 including a thin film transistor, the alignment film 4, the liquid crystal layer 5 including a liquid crystal composition, the alignment film 4, the color filter 6, the second substrate 7 and the second polarizing plate 8. As the first substrate 2 and the second substrate 7, it is possible to use a transparent material having flexibility such as glass or plastic, and one substrate may be an opaque material such as silicon. The two substrates 2 and 7 are bonded together by a sealing material and a sealant such as an epoxy type thermosetting composition or the like disposed in the peripheral region and, in order to maintain the distance between the substrates, for example, a granular spacer such as glass particles, plastic particles, alumina particles or the like or a spacer column made of a resin formed by a photolithography method may be disposed therebetween.

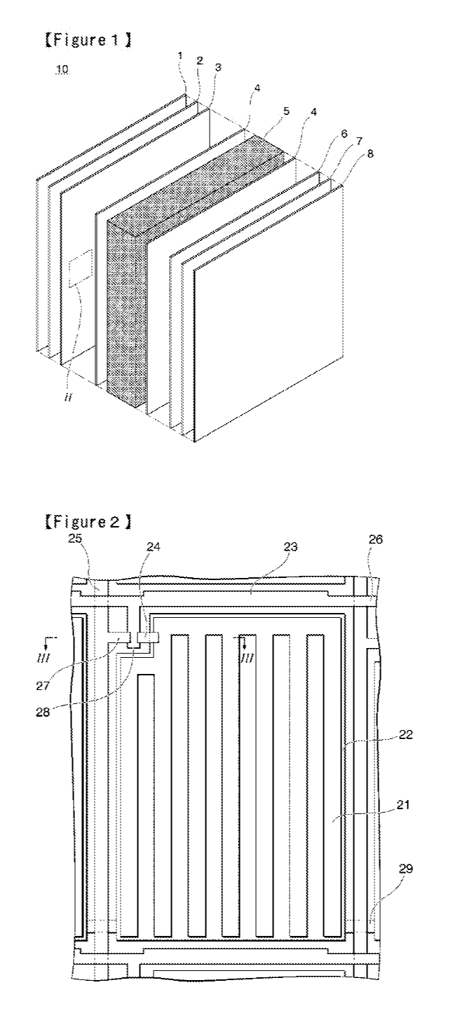

FIG. 2 is an enlarged plan view of a region surrounded by the II line of the electrode layer 3 formed on the substrate 2 in FIG. 1. FIG. 3 is a cross-sectional view of the liquid crystal display element shown in FIG. 1 taken along the line III-III in FIG. 2. As shown in FIG. 2, the electrode layer 3 including the thin film transistor formed on the surface of the first substrate 2 includes a plurality of gate bus lines 26 for supplying scanning signals and a plurality of data bus lines 25 for supplying display signals, which are disposed in a matrix shape to cross each other. Note that, in FIG. 2, only a pair of gate bus lines 26 and a pair of data bus lines 25 are shown.

A region surrounded by the plurality of gate bus lines 26 and the plurality of data bus lines 25 forms a unit pixel of the liquid crystal display device, and the pixel electrode 21 and the common electrode 22 are formed in the unit pixel. Thin film transistors including a source electrode 27, a drain electrode 24, and a gate electrode 28 are provided in the vicinity of the intersections where the gate bus lines 26 and the data bus lines 25 intersect each other. This thin film transistor is connected to the pixel electrode 21 as a switch element for supplying a display signal to the pixel electrode 21. In addition, a common line 29 is provided in parallel with the gate bus line 26. This common line 29 is connected to the common electrode 22 in order to supply a common signal to the common electrode 22.

As shown in FIG. 3, a preferable aspect of the structure of the thin film transistor has, for example, a gate electrode 11 formed on the surface of the substrate 2, a gate insulating layer 12 provided so as to cover the gate electrode 11 and to cover substantially the entire surface of the substrate 2, a semiconductor layer 13 formed on the surface of the gate insulating layer 12 so as to oppose the gate electrode 11, a protective film 14 provided so as to cover a part of the surface of the semiconductor layer 17, a drain electrode 16 provided so as to cover one side end section of the protective layer 14 and the semiconductor layer 13 and to come into contact with the gate insulating layer 12 formed on the substrate 2 surface, a source electrode 17 provided so as to cover the other side end portion of the protective film 14 and the semiconductor layer 13 and to come into contact with the gate insulating layer 12 formed on the substrate 2 surface, and an insulating protective layer 18 provided so as to cover the drain electrode 16 and the source electrode 17. An anodic oxide coating (not shown) may be formed on the surface of the gate electrode 11 for a reason such as eliminating a difference in level from the gate electrode.

For the semiconductor layer 13, it is possible to use amorphous silicon, polycrystalline polysilicon or the like and when a transparent semiconductor film such as ZnO, IGZO (In—Ga—Zn—O), ITO or the like is used, it is possible to suppress adverse effects on the light carrier caused by light absorption, which is preferable from the viewpoint of increasing the opening ratio of the element.

Furthermore, for the purpose of reducing the width and the height of the Schottky barrier, an ohmic contact layer 15 may be provided between the semiconductor layer 13 and the drain electrode 16 or the source electrode 17. For the ohmic contact layer, it is possible to use a material such as n-type amorphous silicon or n-type polycrystalline silicon having an impurity such as phosphorus added thereto at a high concentration.

The gate bus lines 26, the data bus lines 25 and the common lines 29 are preferably metal films, more preferably Al, Cu, Au, Ag, Cr, Ta, Ti, Mo, W, Ni or an alloy thereof, and a wiring of Al or an alloy thereof is particularly preferably used. In addition, the insulating protective layer 18 is a layer having an insulating function, and is formed of silicon nitride, silicon dioxide, a silicon oxynitride film, or the like.

In the embodiment shown in FIGS. 2 and 3, the common electrode 22 is a flat, plate-shaped electrode formed on the gate insulating layer 12, while the pixel electrode 21 is a comb shaped electrode formed on the insulating protective layer 18 covering the common electrode 22. That is, the common electrode 22 is disposed at a position closer to the first substrate 2 than the pixel electrode 21, and these electrodes are disposed to overlap each other with the insulating protective layer 18 interposed therebetween. The pixel electrode 21 and the common electrode 22 are formed of a transparent conductive material such as indium tin oxide (ITO), indium zinc oxide (IZO), indium zinc tin oxide (IZTO), or the like. Since the pixel electrode 21 and the common electrode 22 are formed of a transparent conductive material, the area to be opened in the unit pixel area is increased, and the opening ratio and the transmittance are increased.

In order to form a fringe electric field between the electrodes, the pixel electrode 21 and the common electrode 22 are formed such that an inter-electrode distance R between the pixel electrode 21 and the common electrode 22 is smaller than the distance G between the first substrate 2 and the second substrate 7. Note that, the inter-electrode distance R represents the horizontal direction distance between the electrodes along the substrate. FIG. 3 shows an example in which, since the flat, plate-shaped common electrode 22 and the comb-shaped pixel electrode 21 are overlapped with each other, the inter-electrode distance R=0, and since the inter-electrode distance R is smaller than the distance (that is, cell gap) G between the first substrate 2 and the second substrate 7, the electric field E of the fringe is formed. Accordingly, in the FFS type liquid crystal display element, it is possible to use a horizontal electric field formed in a direction perpendicular with respect to a line forming the comb shape of the pixel electrode 21 and a parabolic electric field. The electrode width 1 of the comb-shaped portion of the pixel electrode 21 and the width m of the gap of the comb-shaped portion of the pixel electrode 21 are preferably formed at a width such that all the liquid crystal molecules in the liquid crystal layer 5 are able to be driven by the generated electric field.

From the viewpoint of preventing the leakage of light, it is preferable that the color filter 6 form a black matrix (not shown) in a portion corresponding to the thin film transistor and the storage capacitor 23.

On the first electrode layer 3 and the color filter 6, a pair of alignment films 4 inducing homogeneous alignment are provided in direct contact with the liquid crystal composition forming the liquid crystal layer 5. The alignment film 4 is, for example, a polyimide film subjected to a rubbing treatment, and the alignment directions of each alignment film are in parallel.

In addition, the polarizing plate 1 and the polarizing plate 8 are able to be adjusted such that the viewing angle and contrast are favorable by adjusting the polarizing axes of the respective polarizing plates, and it is preferable to have transmission axes orthogonal to each other such that these transmission axes are operated in a normally black mode. In particular, it is preferable that any one of the polarizing plate 1 and the polarizing plate 8 be disposed so as to have a transmission axis parallel to the alignment direction of the liquid crystal molecules 30. In addition, it is preferable to adjust the product of the refractive index anisotropy Δn of the liquid crystal and the cell thickness d so that the contrast is maximized. Furthermore, it is also possible to use a retardation film for widening the viewing angle.

In the FFS type liquid crystal display device 10 formed as described above, by supplying an image signal (voltage) to the pixel electrode 21 via the thin film TFT, a fringe electric field is formed between the pixel electrode 21 and the common electrode 22 and the liquid crystal is driven by this electric field. That is, in a state in which no voltage is applied, the liquid crystal molecules 30 are disposed such that the major axis direction thereof is parallel to the alignment direction of the alignment film 4. When a voltage is applied, an equipotential line of a parabolic electric field is formed between the pixel electrode 21 and the common electrode 22 up to the upper portion of the pixel electrode 21 and the common electrode 22, and the liquid crystal molecules 30 in the liquid crystal layer 5 are alinged in the liquid crystal layer 5 along the formed electric field. In the present invention, since the liquid crystal molecules 30 having negative dielectric anisotropy are used, the major axis direction of the liquid crystal molecules 30 are alinged along the generated electric field direction. The liquid crystal molecules 30 positioned near the pixel electrode 21 are susceptible to the influence of the fringe electric field, but the liquid crystal molecules 30 having the positive dielectric anisotropy have a polarization direction on the major axis of the molecule, the major axis direction does not rotate in the direction orthogonal with respect to the alignment direction of the alignment film 4 and the major axis direction of the liquid crystal molecules 30 in the liquid crystal layer 5 is able to be maintained in a parallel direction with respect to the alignment film 4.

Accordingly, in the FFS type liquid crystal display element, it is possible to use a horizontal electric field formed in a direction perpendicular with respect to a line forming the comb shape of the pixel electrode 21 and a parabolic electric field. If the shortest separation distance between a common electrode and a pixel electrode is shorter than the shortest separation distance between alignment layers 4 (distance between substrates), a fringe electric field is formed between the common electrode and the pixel electrode and the horizontal and vertical alignments of the liquid crystal molecules can be efficiently utilized.

In a case of the FFS mode liquid crystal display element which is a preferred form of the present invention, when a voltage is applied to the liquid crystal molecules which are disposed such that the major axis direction thereof is parallel to the alignment direction of the alignment layer, an equipotential line of a parabolic electric field is formed between the pixel electrode and the common electrode up to the upper portion of the pixel electrode and the common electrode, and the major axis of the liquid crystal molecules in the liquid crystal layer is arranged along the formed electric field. Particularly, the liquid crystal composition according to the present invention uses the liquid crystal molecules having the positive dielectric anisotropy, and thus the major axis direction of the liquid crystal molecules is arranged along the formed electric field direction.

The FFS type liquid crystal display element described with reference to FIG. 1 to FIG. 8 is merely an example and various other embodiments are possible as long as these embodiments do not depart from the technical idea of the present invention. For example, FIG. 4 is another example of an enlarged plan view of a region surrounded by the II line of the electrode layer 3 formed on the substrate 2 in FIG. 1. As illustrated in FIG. 4, the pixel electrode 21 may be formed to have a slit. In addition, the slit pattern may be formed so as to have an inclination angle with respect to the gate bus lines 26 or the data bus lines 25.

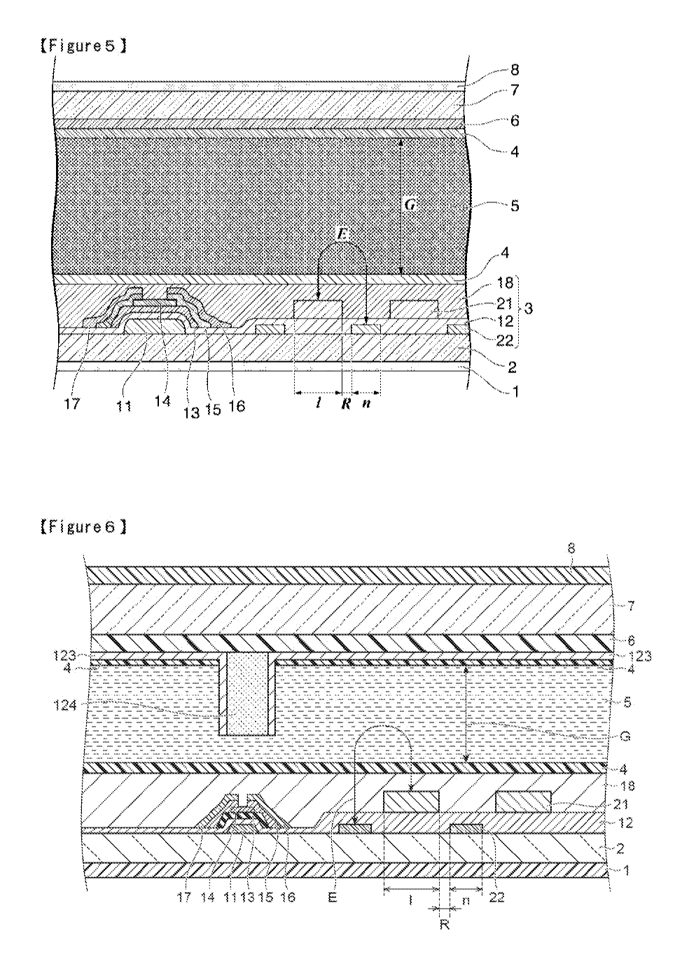

In addition, FIG. 5 is another example of a cross-sectional view of the liquid crystal display element shown in FIG. 1 taken along the line III-III in FIG. 2. In the example shown in FIG. 5, a common electrode 22 having a comb shape or a slit is used, and the inter-electrode distance between the pixel electrode 21 and the common electrode 22 is R=α. Furthermore, an example is given in FIG. 3 in which the common electrode 22 is formed on the gate insulating film 12; however, as shown in FIG. 6, the common electrode 22 may be formed on the first substrate 2 and the pixel electrode 21 may be provided via the gate insulating film 12. The electrode width 1 of the pixel electrode 21, the electrode width n of the common electrode 22, and the inter-electrode distance R are preferably appropriately adjusted to a width such that all the liquid crystal molecules in the liquid crystal layer 5 can be driven by the generated electric field.

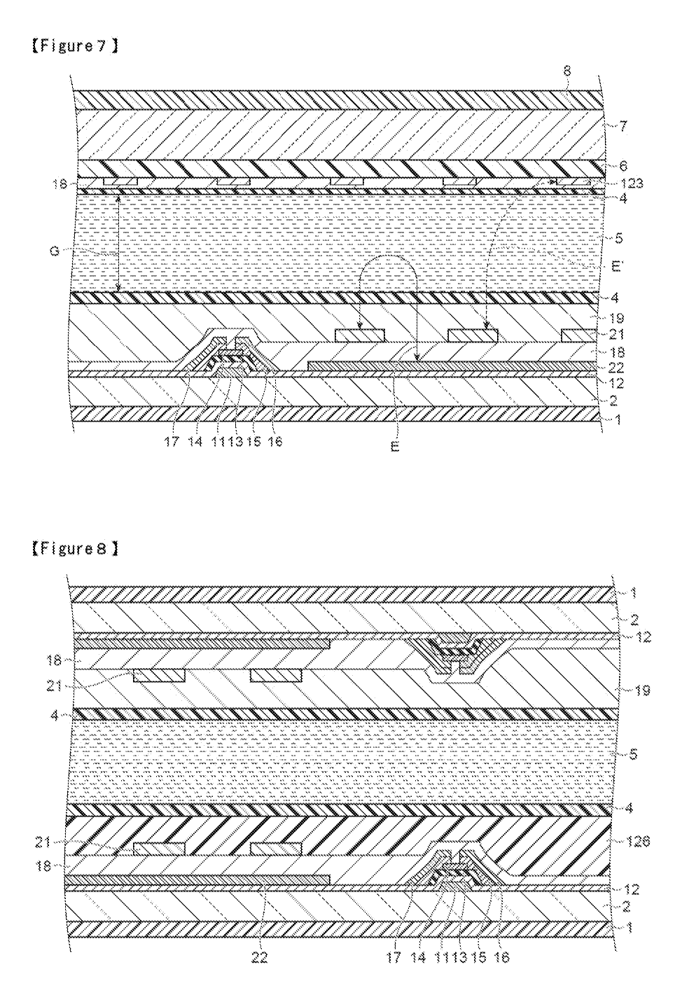

FIG. 6 is a cross-sectional view of another example of the liquid crystal display element shown in FIG. 1 taken along line III-III in FIG. 2. As compared with the configuration of FIG. 5, FIG. 7 has a different configuration in that a projection 124 and the third electrode 123 are provided on the second substrate 7 side. The projection 124 may be a spacer and is formed of an organic material or an inorganic material. In addition, in FIG. 6, the projection 124 is provided on the second substrate 7 side, but may be provided on the first substrate 2 so as to protrude in the direction of the second substrate 7. Further, the end of the projection 124 is present in the liquid crystal layer 5, but the end of the projection 124 may be in contact with the alignment film 4 and the insulating film 18. In addition, here, the third electrode 123 is preferably a common electrode. Further, in FIG. 6, the projection 124 is formed above the TFT at a position corresponding to a black matrix position, but the projection 124 may be not formed immediately above the TFT.

As illustrated in FIG. 6, it is considered that when the common electrode is formed on the second substrate side as the third electrode 123, an electric flux line is formed in the thickness direction, and thus alignment unevenness of the thickness direction in the liquid crystal layer 5 can be reduced.

In the example as illustrated in FIG. 6, the common electrode 22 having a comb shape or having a slit is used, and the inter-electrode distance between the pixel electrode 21 and the common electrode 22 is R=α. Furthermore, an example is given in FIG. 3 in which the common electrode 22 is formed on the gate insulating film 12; however, as shown in FIG. 5, the common electrode 22 may be formed on the first substrate 2 and the pixel electrode 21 may be provided via the gate insulating film 12. The electrode width 1 of the pixel electrode 21, the electrode width n of the common electrode 22, and the inter-electrode distance R are preferably appropriately adjusted to a width such that all the liquid crystal molecules in the liquid crystal layer 5 can be driven by the generated electric field.

FIG. 7 is a cross-sectional view of another example of the liquid crystal display element shown in FIG. 1 taken along line III-III in FIG. 2. As compared with the configuration of FIG. 3, FIG. 7 has a different configuration in that the third electrode 123 is provided on the second substrate 7 side. The aforementioned third electrode 123 has a structure including a comb shape as illustrated in FIG. 2 or a notch portion as illustrated in FIG. 4. In addition, here, the third electrode 123 is preferably a common electrode. It is considered that when the common electrode is formed on the second substrate side as the third electrode 123, an electric flux line E′ is formed in the thickness direction, and thus alignment unevenness of the thickness direction in the liquid crystal layer 5 can be reduced.

FIG. 8 is a cross-sectional view of another example of the liquid crystal display element shown in FIG. 1 taken along line III-III in FIG. 2. As compared with the configuration of FIG. 3, FIG. 8 has a different configuration in that an electrode substrate including the TFT similar to the first substrate is bonded to the substrate side facing the first substrate 2, a protective layer 126 including a color filter and a protective layer 19 are additionally provided. In other words, FIG. 8 illustrates a structure in which a pair of laminates in each of which a polarizing layer 1, a first substrate 2, an electrode layer 3, a protective layer 19, and an alignment film 4 are sequentially laminated, which are illustrated in FIG. 3, are bonded such that the TFTs overlap each other, and the protective layer 19 on one side is a resin containing a color filter.

In this configuration, there are four electrodes. That is, the upper and lower common electrodes 22 are present, and the upper and lower pixel electrodes 21 are present. The liquid crystal of the liquid crystal layer can be efficiently utilized as compared with an element in which electrodes are formed only on one side.

Since the FFS mode liquid crystal display element according to the present invention uses a specific liquid crystal composition, it is possible to achieve both a high-speed response and suppression of display failure.

In addition, in the FFS mode liquid crystal display element, when injecting the liquid crystal layer 5 between the first substrate 2 and the second substrate 7, for example, a vacuum injection method, a one drop fill (ODF) method, or the like is performed; however, in the present invention, in the ODF method, it is possible to suppress the occurrence of drip marks when the liquid crystal composition is dropped onto the substrate. Note that, a drip mark is defined as a phenomenon in which a white mark appears where the liquid crystal composition is dropped when black is displayed.

Although the occurrence of drip marks is greatly affected by the liquid crystal material to be injected, it is not possible to avoid the influence thereof even through the configuration of the display element. In the FFS mode liquid crystal display element, for the thin film transistor formed in the display element, since there is no member separating the pixel electrode 21 having a comb shape or a slit, and the like from the liquid crystal composition except for the thin alignment film 4, the thin alignment film 4 and the thin insulating protective layer 18, and the like, there is a high possibility that the ionic substance can not be completely blocked, and it is not possible to avoid the generation of drip marks due to the interaction between the metal material forming the electrode and the liquid crystal composition; however, by using the liquid crystal composition of the present invention combined in an FFS type liquid crystal display element, the occurrence of drip marks is able to be effectively suppressed.

In addition, in the manufacturing steps of the liquid crystal display element using the ODF method, it is necessary to drop an optimum amount of injected liquid crystal according to the size of the liquid crystal display element; however, for example, with the liquid crystal composition of the present invention, since sudden pressure changes or influence of impacts in the dripping apparatus caused when dripping the liquid crystal is small and it is possible to continue stably dripping the liquid crystal over a long period, it is also possible to keep the yield of the liquid crystal display element high. In particular, for small liquid crystal display elements frequently used in smartphones which have recently come into wide use, control of the deviations from an optimum value within a certain range is itself difficult due to the optimum amount of injected liquid crystal being small; however, by using the liquid crystal composition of the present invention, it is possible to realize a stable discharging amount of the liquid crystal material even in small liquid crystal display elements.

### EXAMPLES

Hereinafter, the present invention will be described in more detail with examples, and the present invention is not limited to the examples. In addition, “%” in the compositions of the following examples and comparative examples means “% by mass”.

In the examples, the measured characteristics are as follows.
T_{NI}: nematic phase-isotropic liquid phase transition temperature (° C.)
Δn: refractive index anisotropy at 295K (also referred to as birefringence)
Δ∈: dielectric anisotropy at 295K
η: viscosity (mPa·s) at 295K
γ₁: rotational viscosity (mPa·s) at 295K
VHR: voltage holding ratio (%) at 313K under the conditions of a frequency of 60 Hz and an applied voltage of 5 V.

Burn-in:

After displaying a predetermined fixed pattern in the display area for 1,440 hours, by visually inspecting the residual image level of the fixed pattern at the time when full screen was uniformly displayed, the evaluation of the burn-in on a liquid crystal display element was performed on a scale of four stages described below.
A: Residual image was not observed
B: Residual image was very slightly observed, however it was an acceptable level
C: Residual image was observed, and it was an unacceptable level
D: Residual image was observed, and it was a very severe level

Volatility/Contamination of Manufacturing Apparatus:

The volatility of the liquid crystal material was evaluated by observing an operation state of a vacuum stirring defoaming mixer while illuminating it with a stroboscope, and visually observing foaming of the liquid crystal material. Specifically, 0.8 kg of the liquid crystal composition was put in a special container of the vacuum stirring defoaming mixer having a capacity of 2.0 L, and the vacuum stirring defoaming mixer was operated at a revolution speed of 15 S⁻¹ and a rotation speed of 7.5 S⁻¹ under degassing of 4 kPa, and the evaluation was made according to the following four-stage evaluation depending on the time until the foaming began.
A: At least 3 minutes until foaming, low possibility of contamination of apparatus due to volatilization
B: 1 minute or more and less than 3 minutes until foaming, there is concern of minor contamination of apparatus due to volatilization
C: 30 seconds or more and less than 1 minute until foaming, contamination of apparatus occurs due to volatilization
D: 30 seconds or less until foaming, there is concern about serious contamination of apparatus due to volatilization

Process Adaptability:

In ODF process, dropping the liquid crystal by 40 pL at one time was performed 100,000 times using a constant volume measuring pump, and the change in amount of liquid crystal dropped by each 200 times of the following “0 to 200 times, 201 to 400 times, 401 to 600 times, . . . , 99,801 to 100,000 times” was evaluated on a scale of four stages described below.
A: Change was extremely small (liquid crystal display element could be stably prepared)
B: Change was slightly observed, but it was an acceptable level
C: Change was observed, and it was an unacceptable level (yield was deteriorated by generation of spots)
D: Change was observed, and it was a very severe level (liquid crystal leakage or vacuum bubbles were generated)

Solubility at Low Temperatures:

After preparing a liquid crystal composition, 0.5 g of the liquid crystal composition was weighed and placed in a sample bottle of 1 mL, the temperature change having one cycle of “−20° C. (maintained for 1 hour)→heating (0.2° C./min)→0° C. (maintained for 1 hour)→heating (0.2° C./min)→20° C. (maintained for 1 hour)→cooling (−0.2° C./min)→0° C. (maintained for 1 hour)→cooling (−0.2° C./min)→−20° C.” was continuously given thereto in a temperature controlled test chamber, the generation of precipitates from the liquid crystal composition was visually observed, and the solubility evaluation at low temperatures was performed on a scale of four stages described below.
A: Precipitates were not observed for equal to or longer than 600 hours.
B: Precipitates were not observed for equal to or longer than 300 hours.
C: Precipitates were observed within 150 hours.
D Precipitates were observed within 75 hours

(Alignment Unevenness)

As a method other than the observation with a polarizing microscope, alignment unevenness can be measured by whether or not the transmittance contrast ratio in the electrooptical characteristic measurement is improved.

In the examples, the following abbreviations are used for describing the compounds.

(Side Chain)
-n —CₙH₂ₙ₊₁ linear alkyl group having n carbon atoms
—On —OCₙH₂ₙ₊₁ linear alkoxy group having n carbon atoms
—V —CH═CH₂ vinyl group
-Vn —CH═C—CₙH₂ₙ₊₁-alkene having (n+1) carbon atoms

(Linking Group)
—CF2O— —CF₂—O—
—OCF2- —O—CF₂—
-1O— —CH₂—O—
—O1- —O—CH₂—
—COO— —COO—

(Ring Structure)

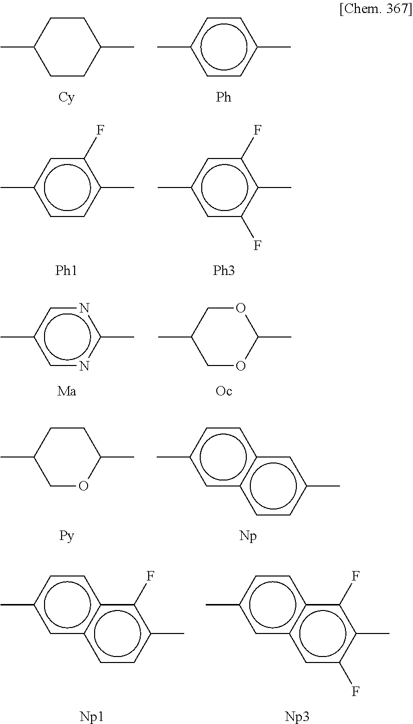

### Examples 1 to 5

The liquid crystal composition (liquid crystal composition 1) having the compositional ratio described below was prepared, and the physical properties thereof were measured. The results are shown in the following Table.

Using the liquid crystal composition 1 of Examples 1 to 5, an FFS mode liquid crystal display element was produced having a cell thickness of 3.0 μm, which is common for TVs, and having electrode layers on the first substrate and the second substrate (the structure in FIG. 3). The injection of the liquid crystal composition was carried out by a dropping method and observation with the polarizing microscope while driving the liquid crystal cell, and as a result of the observation, it was confirmed that the alignment unevenness was reduced as compared with the liquid crystal cell in the related art.

TABLE 1

| | Ratio (%) | | |
|---|---|---|---|
| Chemical structure | Example-1 | Example-2 | Example-3 |
| 3-Cy-Cy-V | 44 | 44 | 44 |
| 3-Cy-Cy-V1 | 8 | 8 | 8 |
| 1-Ph—Ph—2V1 | 3 | 3 | 3 |
| 2-Ph—Ph1—Ph3—F | 4 | 4 | |
| 3-Ph—Ph1—Ph3—F | 7 | | |
| 2-Py-Ph—Ph3—CF2O—Ph3—F | 6 | 6 | 6 |
| 3-Py-Ph—Ph3—CF2O—Ph3—F | 5 | 5 | 5 |
| V-Cy-Cy-Ph-1 | 15 | 15 | 15 |
| 3-Cy-Ph—Ph-2 | 4 | 4 | 4 |
| 2-Ph—Ph1—Ph-4 | 4 | 4 | 4 |
| 3-Ph—Ph3—CF2O—Ph3—F | | 7 | 11 |
| T_{NI}/° C. | 76.0 | 76.8 | 75.4 |
| Δn | 0.103 | 0.102 | 0.102 |
| Δε | 4.7 | 4.9 | 5.3 |
| η/mPa · S | 13 | 15 | 16 |
| γ₁/mPa · S | 50 | 39 | 37 |

TABLE 2

Ratio (%)

| Chemical structure | Example-4 | Example-5 |
|---|---|---|
| 3-Cy-Cy-V | 53 | 49 |
| 3-Cy-Cy-V1 | 8 | 6 |
| V2—Ph—Ph1—Ph-1 | 6 | 3 |
| V2—Ph—Ph1—Ph-2 | 8 | 5 |
| V2—Ph—Ph1—Ph-3 | 12 | 2 |
| 3-Ph—Ph1—Ph3—F | 10 | |
| 3-Cy-Ph—Ph—CF2O—Ph3—F | 3 | |
| 4-Ph—Ph1—Ph3—CF2O—Ph3—F | | 5 |
| V-Cy-Cy-Ph-1 | | |
| 2-Cy-Cy-Ph—F | | 4 |
| 2-Cy-Cy-Ph—F | | 5 |
| 5-Ph1—Ph3—CF2O—Ph3—F | | 9 |
| 3-Cy-Ph—Ph3—CF2O—Ph3—F | | 4 |
| 3-Ph—Ph3—CF2O—Ph3—F | | 8 |
| T_{NI}/° C. | 75.3 | 80.8 |
| Δn | 0.123 | 0.113 |
| Δε | 2.5 | 7.4 |
| η/mPa · S | 20 | 11 |
| γ₁/mPa · S | 70 | 62 |

### REFERENCE SIGNS LIST

1,8 POLARIZING PLATE
2 FIRST SUBSTRATE
3 SECOND ELECTRODE LAYER
4 ALIGNMENT FILM
5 LIQUID-CRYSTAL LAYER
6 COLOR FILTER
7 SECOND SUBSTRATE (INCLUDING CASE OF FORMING ELECTRODE ON SURFACE)
10 LIQUID-CRYSTAL DISPLAY ELEMENT
11 GATE ELECTRODE
12 GATE INSULATING FILM
13 SEMICONDUCTOR LAYER
14 INSULATING LAYER
15 OHMIC CONTACT LAYER
16 DRAIN ELECTRODE
17 SOURCE ELECTRODE
18 INSULATING PROTECTIVE LAYER
19 (INSULATING) PROTECTIVE FILM
21 PIXEL ELECTRODE AS AN EXAMPLE OF FIRST ELECTRODE
22 COMMON ELECTRODE AS AN EXAMPLE OF SECOND ELECTRODE
23 STORAGE CAPACITOR
25 DATA BUS LINE
27 SOURCE BUS LINE
29 COMMON LINE
123 THIRD ELECTRODE
124 PROJECTION
126 RESIN LAYER INCLUDING COLOR FILTER

1. A liquid crystal display element comprising:
a first substrate and a second substrate, which are disposed so as to face each other;
a liquid crystal layer containing a liquid crystal composition, which is interposed between the first substrate and the second substrate;
an electrode layer that is provided on the first substrate and includes, for each pixel, a plurality of gate bus lines and data bus lines disposed in a matrix shape on the first substrate, a thin film transistor which is provided in an intersection between the gate bus line and the data bus line, and a pixel electrode which includes a transparent conductive material and is driven by the thin film transistor;
a common electrode that includes a transparent conductive material and is formed on the first substrate or the second substrate; and
alignment film layers that are formed between the liquid crystal layer and the first substrate and between the liquid crystal layer and the second substrate,
wherein the liquid crystal composition has positive dielectric anisotropy and a transition temperature of a nematic phase-isotropic liquid of 60° (or more, and contains at least one compound selected from the compound group represented by the following General Formula (I) and at least one compound selected from the compound group represented by the following General Formula (II): 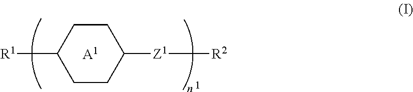
wherein R¹ and R² each independently represent an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and a methylene group in the alkyl group, the alkenyl group, the alkoxy group, and the alkenyloxy group may be substituted with an oxygen atom as long as the oxygen atoms are not bonded consecutively, and may be substituted with a carbonyl group as long as the carbonyl groups are not bonded consecutively,
A¹ each independently represents a 1,4-cyclohexylene cyclohexylene group, a 1,4-phenylene group or a tetrahydropyran-2,5-diyl group, and in a case where A¹ represents a 1,4-phenylene group, one hydrogen atom in the 1,4-phenylene group may be substituted with a fluorine atom;
Z¹ each independently represents a single bond, —OCH₂—, —OCF₂—, —CH₂O—, or CF₂O—; and
n¹ represents 1, 2, 3, or 4: 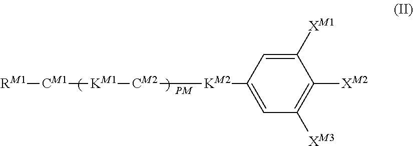
wherein R^{M1} represents an alkyl group having 1 to 8 carbon atoms, an alkenyl group having 2 to 8 carbon atoms, an alkoxy group having 1 to 8 carbon atoms, or an alkenyloxy group having 2 to 8 carbon atoms, one or more hydrogen atoms in the alkyl group, the alkenyl group, the alkoxy group, and the alkenyloxy group may be substituted with a fluorine atom, and one or two or more non-adjacent —CH₂— in the alkyl group, the alkenyl group, the alkoxy group, and the alkenyloxy group may be independently substituted with —CH═CH—, —C≡C—, —O—, —CO—, —COO—, or —OCO—;
PM represents 0, 1, 2, 3, or 4;
C^{M1} and C^{M2} each independently represent a group selected from the group consisting of:
(d) a 1,4-cyclohexylene group (one —CH₂— or two or more non-adjacent —CH₂— present in this group may be substituted with —O— or —S—), and
(e) a 1,4-phenylene group (one —CH═ or two or more non-adjacent —CH═ present in this group may be substituted with —N═), and the group (d) and the group (e) may be independently substituted with a cyano group, a fluorine atom, or a chlorine atom;
K^{M1} and K^{M2} each independently represent a single bond, —CH₂CH₂—, —(CH₂)₄—, —OCH₂—, —CH₂O—, —OCF₂—, —CF₂O—, —COO—, —OCO—, or —C≡C—;
in a case where PM is 2, 3, or 4 and plural K^{M1}'s are present, these may be the same as or different from each other, and in a case where PM is 2, 3, or 4 and plural C^{M2}'s are present, these may be the same as or different from each other;
X^{M1} and X^{M3} each independently represent a hydrogen atom, a chlorine atom, or a fluorine atom; and
X^{M2} represents a hydrogen atom, a fluorine atom, a chlorine atom, a cyano group, a trifluoromethyl group, a fluoromethoxy group, a difluoromethoxy group, a trifluoromethoxy group, or a 2,2,2-trifluoroethyl group.

2. The liquid crystal display element according to claim 1,
wherein the pixel electrode is formed into a comb shape or has a slit.

3. The liquid crystal display element according to claim 1,
wherein an inter-electrode distance (R) is zero, and the common electrode is disposed on substantially the entire surface of the first substrate at a position closer to the first substrate than the pixel electrode.
